(19) United States
(12) Patent Application Publication
(10) Pub. No.: US 2009/0227563 A1
(43) Pub. Date: Sep. 10, 2009

(54) HERBICIDAL COMPOSITIONS HAVING IMPROVED EFFECT

(75) Inventors: Reiner Fischer, Monheim (DE); Stefan Lehr, Liederbach (DE); Dieter Feucht, Eschborn (DE); Udo Bickers, Kelkheim (DE); Hans Philipp Huff, Eppstein (DE); Erwin Hacker, Hochheim (DE); Rainer Süssmann, Limburg (DE)

Correspondence Address: Baker Donelson Bearman, Caldwell & Berkowitz, PC, 555 Eleventh Street, NW, Sixth Floor, Washington, DC, 20004, US

(73) Assignee: Bayer CropScience AG, Monheim Am Rhein (DE)

(21) Appl. No.: 12/096,907

(22) PCT Filed: Dec. 11, 2006
(86) PCT No.: PCT/EP2006/011910

§ 371 Date: Nov. 24, 2008

(30) Foreign Application Priority Data
Dec. 13, 2005 (DE) 10 2005 059 471.9

(51) Int. Cl. A01N 43/72; A01N 43/90; A01N 43/54; A01N 43/40; A01N 43/38; A01N 43/36; A01N 43/08; A01N 43/16; A01N 35/06; A01N 43/58; A01N 43/86

(52) U.S. Cl. 514/211.08; 514/259.3; 514/274; 514/355; 514/409; 514/425; 514/413; 514/462; 514/460; 514/684; 514/248; 514/227.2

(57) ABSTRACT

The present invention concerns boosting the activity of crop protection materials comprising active ingredients from the class of the phenyl-substituted cyclic ketoenols through the addition of ammonium salts and/or phosphonium salts or through the addition of ammonium salts and/or phosphonium salts and penetrants, the corresponding materials, processes for preparing them, and their use in crop protection.

The present invention concerns boosting the activity of crop protection materials comprising inhibitors of fatty acid biosynthesis, especially phenyl-substituted cyclic ketoenols, through the addition of ammonium salts or phosphonium salts and, if desired, penetrants, the corresponding materials, processes for preparing them, and their use in crop protection for preventing unwanted plant growth.

For 3-acylpyrrolidine-2,4-diones pharmaceutical properties have already been described (S. Suzuki et al. Chem. Pharm. Bull. 15 1120 (1967)). Additionally N-phenylpyrrolidine-2,4-diones have been synthesized, by R. Schmierer and H. Mildenberger (Liebigs Ann. Chem. 1985, 1095). No biological activity has been described for these compounds.

EP-A-0 262 399 and GB-A-2 266 888 disclose similarly structured compounds (3-arylpyrrolidine-2,4-diones) for which, however, no herbicidal, insecticidal or acaricidal activity has been made known. Compounds known with a herbicidal, insecticidal or acaricidal activity include unsubstituted, bicyclic 3-arylpyrrolidine-2,4-dione derivatives (EP-A-355 599, EP-A-415 211 and JP-A-12-053 670) and also substituted monocyclic 3-arylpyrrolidine-2,4-dione derivatives (EP-A-377 893 and EP-A-442 077).

Additionally known are polycyclic 3-arylpyrrolidine-2,4-dione derivatives (EP-A-442 073) and also 1H-arylpyrrolidinedione derivatives (EP-A-456 063, EP-A-521 334, EP-A-596 298, EP-A-613 884, EP-A-613 885, WO 95/01 997, WO 95/26 954, WO 95/20 572, EP-A-0 668 267, WO 96/25 395, WO 96/35 664, WO 97/01 535, WO 97/02 243, WO 97/36 868, WO 97/43275, WO 98/05638, WO 98/06721, WO 98/25928, WO 99/16748, WO 99/24437, WO 99/43649, WO 99/48869 and WO 99/55673, WO 01/17972, WO 01/23354, WO 01/74770, WO 03/013249, WO 04/007448, WO 04/024688, WO 04/065366, WO 04/080962, WO 04/111042, WO 05/044791, WO 05/044796, WO 05/048710, WO 05/049569, WO 05/066125, WO 05/092897, WO 06/000355, WO 06/029799, WO 06/056281, WO 06/056282, WO 06/089633).

It is known that certain substituted Δ³-dihydrofuran-2-one derivatives possess herbicidal properties (cf. DE-A-4 014 420). The synthesis of the tetronic acid derivatives used as starting compounds (such as 3-(2-methylphenyl)-4-hydroxy-5-(4-fluorophenyl)-Δ³-dihydrofuran-2-one) is likewise described in DE-A-4 014 420. Similarly structured compounds, without a report of an insecticidal and/or acaricidal activity, are known from the publication by Campbell et al., J. Chem. Soc., Perkin Trans. 1, 1985, (8) 1567-76. Moreover, 3-aryl-Δ³-dihydrofuranone derivatives having herbicidal, acaricidal and insecticidal properties are known from EP-A-528 156, EP-A-0 647 637, WO 95/26 345, WO 96/20 196, WO 96/25 395, WO 96/35 664, WO 97/01 535, WO 97/02 243, WO 97/36 868, WO 98/05638, WO 98/25928, WO 99/16748, WO 99/43649, WO 99/48869, WO 99/55673, WO 01/17972, WO 01/23354 and WO 01/74770, WO 03/013 249, WO 04/024 688, WO 04/080 962, WO 04/111 042, WO 05/092897, WO 06/000355, WO 06/029799 and WO 06/089633. As well 3-aryl-Δ³-dihydrothiophene-one derivatives are known (WO 95/26 345, 96/25 395, WO 97/01 535, WO 97/02 243, WO 97/36 868, WO 98/05638, WO 98/25928, WO 99/16748, WO 99/43649, WO 99/48869, WO 99/55673, WO 01/17972, WO 01/23354, WO 01/74770, WO 03/013249, WO 04/080 962, WO 04/111 042, WO 05/092897, WO 06/029799).

Certain phenylpyrone derivatives unsubstituted in the phenyl ring have already been disclosed (cf. A. M. Chirazi, T. Kappe and E. Ziegler, Arch. Pharm. 309, 558 (1976) and K.-H. Boltze and K. Heidenbluth, Chem. Ber. 91, 2849), no possible usefulness as pesticides being reported for these compounds. Phenylpyrone derivatives substituted in the phenyl ring and having herbicidal, acaricidal and insecticidal properties are described in EP-A-588 137, WO 96/25 395, WO 96/35 664, WO 97/01 535, WO 97/02 243, WO 97/16 436, WO 97/19 941, WO 97/36 868, WO 98/05638, WO 99/43649, WO 99/48869, WO 99/55673, WO 01/17972, WO 01/74770, WO 03/013249, WO 04/080 962, WO 04/111 042, WO 05/092897 and WO 06/029799.

Certain 5-phenyl-1,3-thiazine derivatives unsubstituted in the phenyl ring have already been disclosed (cf. E. Ziegler and E. Steiner, Monatsh. 95, 147 (1964), R. Ketcham, T. Kappe and E. Ziegler, J. Heterocycl. Chem. 10, 223 (1973)), no possible application as pesticides being reported for these compounds. 5-Phenyl-1,3-thiazine derivatives substituted in the phenyl ring and having a herbicidal, acaricidal and insecticidal activity are described in WO 94/14 785, WO 96/02 539, WO 96/35 664, WO 97/01 535, WO 97/02 243, WO 97/02 243, WO 97/36 868, WO 99/05638, WO 99/43649, WO 99/48869, WO 99/55673, WO 01/17972, WO 01/74770, WO 03/013249, WO 04/080 962, WO 04/111 042, WO 05/092897 and WO 06/029799.

It is known that certain substituted 2-arylcyclopentanediones have herbicidal, insecticidal and acaricidal properties (cf. e.g. U.S. Pat. Nos. 4,283,348; 4,338,122; 4,436,666; 4,526,723; 4,551,547; 4,632,698; WO 96/01 798; WO 96/03 366, WO 97/14 667 and also WO 98/39281, WO 99/43649, WO 99/48869, WO 99/55673, WO 01/17972, WO 01/74770, WO 03/013249, WO 04/080 962, WO 04/111 042, WO 05/092897 and WO 06/029799). Moreover, similarly substituted compounds are known: 3-hydroxy-5,5-dimethyl-2-phenylcyclopent-2-en-1-one, from the publication by Micklefield et al., Tetrahedron, (1992), 7519-26, and the natural substance Involutin, (−)-cis-5-(3,4-dihydroxyphenyl)-3,4-dihydroxy-2-(4-hydroxyphenyl)cyclopent-2-en-one, from the publication by Edwards et al., J. Chem. Soc. S, (1967), 405-9. No insecticidal or acaricidal activity is described. Furthermore, 2-(2,4,6-trimethylphenyl)-1,3-indanedione is known from the publication J. Economic Entomology, 66, (1973), 584 and from the laid-open specification DE-A 2 361 084, with reports of herbicidal and acaricidal activities.

It is known that certain substituted 2-arylcyclohexanediones possess herbicidal, insecticidal and acaricidal properties (U.S. Pat. Nos. 4,175,135, 4,209,432, 4,256,657, 4,256,658, 4,256,659, 4,257,858, 4,283,348, 4,303,669, 4,351,666, 4,409,153, 4,436,666, 4,526,723, 4,613,617, 4,659,372, DE-A 2 813 341, and also Wheeler, T. N., J. Org. Chem. 44, 4906 (1979)), WO 99/43649, WO 99/48869, WO 99/55673, WO 01/17972, WO 01/74770, WO 03/013249, WO 04/080 962, WO 04/111 042, WO 05/092897 and WO 06/029799).

It is known that certain substituted 4-arylpyrazolidine-3,5-diones possess acaricidal, insecticidal and herbicidal properties (cf. e.g. WO 92/16 510, EP-A-508 126, WO 96/11 574, WO 96/21 652, WO 99/47525, WO 01/17351, WO 01/17352, WO 01/17353, WO 01/17972, WO 01/17973, WO 03/028 466, WO 03/062 244, WO 04/080 962, WO 04/111 042, WO 05/005428, WO 05/016873, WO 05/092897 and WO 06/029799).

It is known that certain tetrahydropyridones possess herbicidal properties (JP 0832530). Moreover, specific 4-hydroxytetrahydropyridones with acaricidal, insecticidal and herbicidal properties are known (JP 11152273). Furthermore, 4-hydroxytetrahydropyridones have become known as pesticides and herbicides, in WO 01/79204.

It is known that certain 5,6-dihydropyrone derivatives have antiviral properties as protease inhibitors (WO 95/14012). Moreover, 4-phenyl-6-(2-phenethyl)-5,6-dihydropyrone is known from the synthesis of kavalactone derivatives (Kappe et al., Arch. Pharm. 309, 558-564 (1976)). Moreover, 5,6-dihydropyrone derivatives are known as intermediates (White, J. D., Brenner, J. B., Deinsdale, M. J., J. Amer. Chem. Soc. 93, 281-282 (1971)). 3-Phenyl-5,6-dihydropyrone derivatives with applications in crop protection are described in WO 01/98288.

All of the active ingredients present in the materials of the invention are already known and can be prepared by methods described in the prior art (see references cited above). Their activity is good, but not always entirely satisfactory, particularly at low application rates and concentrations. Moreover, the plant tolerance of these compounds is not always sufficient. There is therefore a need for a boost in activity of the crop protection materials comprising the compounds.

Descriptions have already been given in the literature to the effect that the activity of various active ingredients can be boosted through addition of ammonium salts. The salts in question, however, are salts with a detergent effect (e.g. WO 95/017817) and/or salts having relatively long alkyl and/or aryl substituents, which have a permeabilizing effect or which increase the solubility of the active ingredient (e.g. EP-A 0 453 086, EP-A 0 664 081, FR-A 2 600 494, U.S. Pat. No. 4,844,734, U.S. Pat. No. 5,462,912, U.S. Pat. No. 5,538,937, US-A 03/0224939, US-A 05/0009880, US-A 05/0096386). Furthermore, the prior art describes the activity only for certain active ingredients and/or certain applications of the materials in question. A boost in activity through ammonium sulphate, for example, is described for the herbicides glyphosate and phosphinothricin, for example (U.S. Pat. No. 6,645,914, EP-A2 0 036 106).

As well, the use of ammonium sulphate as a formulating assistant has been described for certain active ingredients and applications (WO 92/16108), but it is used there for the purpose of stabilizing the formulation, not for boosting activity.

It has now been found, entirely surprisingly, that the activity of herbicides from the class of the phenyl-substituted cyclic ketoenols can be boosted significantly through the addition of ammonium salts or phosphonium salts to the as-used solution or through the incorporation of these salts into a formulation comprising phenyl-substituted cyclic ketoenols. The present invention provides, therefore, for the use of ammonium salts or phosphonium salts to boost the activity of crop protection materials which comprise herbicidally active phenyl-substituted cyclic ketoenols as active ingredient. The invention likewise provides materials which comprise herbicidally active phenyl-substituted cyclic ketoenols and activity-boosting ammonium salts or phosphonium salts, specifically including not only formulated active ingredients but also application-ready materials (spray liquors). The invention further provides, finally, for the use of these materials for controlling unwanted plant growth.

Active ingredients of the invention from the class of the phenyl-substituted cyclic ketoenols whose activity can be boosted through the addition of ammonium salts or phosphonium salts to the formulated or application-ready active-ingredient preparations are defined by formula (I)

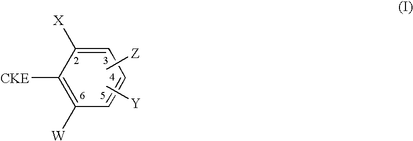

in which
W is hydrogen, alkyl, alkenyl, alkynyl, halogen, alkoxy, haloalkyl, haloalkoxy or cyano,
X is halogen, alkyl, alkenyl, alkynyl, alkoxy, alkoxy-alkoxy, haloalkyl, haloalkoxy or cyano,
Y is hydrogen, halogen, alkyl, alkenyl, alkynyl, alkoxy, cyano, haloalkyl, haloalkoxy or in each case optionally substituted phenyl or hetaryl,
Z is hydrogen, halogen, alkyl, haloalkyl, cyano, alkoxy or haloalkoxy,
CKE is one of the groups

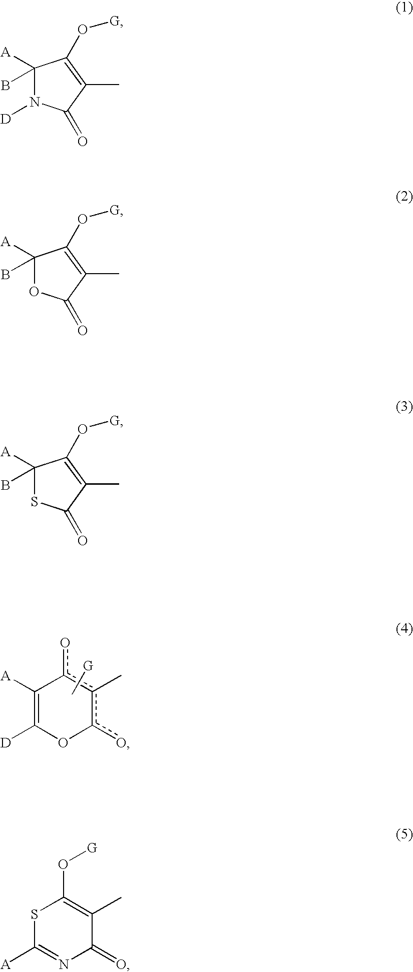

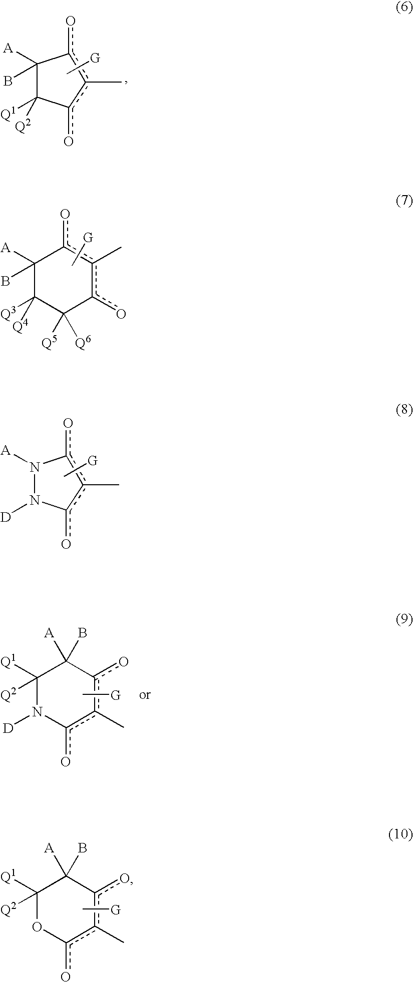

in which
A is hydrogen, in each case optionally halogen-substituted alkyl, alkenyl, alkoxyalkyl, alkylthioalkyl, saturated or unsaturated, optionally substituted cycloalkyl in which optionally at least one ring atom is replaced by a heteroatom, or in each case optionally halogen-, alkyl-, haloalkyl-, alkoxy-, haloalkoxy-, cyano- or nitro-substituted aryl, arylalkyl or hetaryl,
B is hydrogen, alkyl or alkoxyalkyl, or
A and B, together with the carbon atom to which they are attached, are a saturated or unsaturated, unsubstituted or substituted ring optionally containing at least one heteroatom,
D is hydrogen or an optionally substituted radical from the series alkyl, alkenyl, alkynyl, alkoxyalkyl, saturated or unsaturated cycloalkyl in which optionally one or more ring members are replaced by heteroatoms, or is arylalkyl, aryl, hetarylalkyl or hetaryl, or
A and D, together with the atoms to which they are attached, are a saturated or unsaturated ring which optionally contains at least one (in the case of CKE=8 one further) heteroatom and is substituted or unsubstituted in the A,D moiety, or
A and Q¹ together are alkenediyl or alkanediyl optionally substituted by hydroxyl or by in each case optionally substituted alkyl, alkoxy, alkylthio, cycloalkyl, benzyloxy or aryl, or
D and Q¹, together with the atoms to which they are attached, are a saturated or unsaturated ring which optionally contains at least one heteroatom and is substituted or unsubstituted in the D, Q¹ moiety,
Q¹ is hydrogen, alkyl, alkoxyalkyl, optionally substituted cycloalkyl (in which optionally one methylene group is replaced by oxygen or sulphur) or optionally substituted phenyl,
Q², Q⁴, Q⁵ and Q⁶ independently of one another are hydrogen or alkyl,
Q³ is hydrogen, is optionally substituted alkyl, alkoxyalkyl, alkylthioalkyl, optionally substituted cycloalkyl (in which optionally one methylene group is replaced by oxygen or sulphur) or optionally substituted phenyl, or
Q¹ and Q², together with the carbon atom to which they are attached, are a substituted or unsubstituted ring optionally containing a heteroatom, or
Q³ and Q⁴, together with the carbon atom to which they are attached, are a saturated or unsaturated, unsubstituted or substituted ring optionally containing a heteroatom,
G is hydrogen (a) or is one of the groups

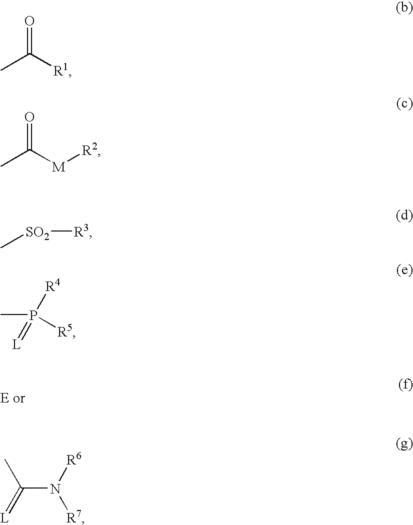

in which
E is one metal ion equivalent or an ammonium ion,
L is oxygen or sulphur,
M is oxygen or sulphur,
R¹ is in each case optionally halogen-substituted alkyl, alkenyl, alkoxyalkyl, alkylthioalkyl, polyalkoxyalkyl or optionally halogen-, alkyl- or alkoxy-substituted cycloalkyl, which may be interrupted by at least one heteroatom, or is in each case optionally substituted phenyl, phenylalkyl, hetaryl, phenoxyalkyl or hetaryloxyalkyl,
R² is in each case optionally halogen-substituted alkyl, alkenyl, alkoxyalkyl, polyalkoxyalkyl or is in each case optionally substituted cycloalkyl, phenyl or benzyl,
R³, R⁴ and R⁵ independently of one another are in each case optionally halogen-substituted alkyl, alkoxy, alkylamino, dialkylamino, alkylthio, alkenylthio, cycloalkylthio or are in each case optionally substituted phenyl, benzyl, phenoxy or phenylthio,
R⁶ and R⁷ independently of one another are hydrogen, in each case optionally halogen-substituted alkyl, cycloalkyl, alkenyl, alkoxy, alkoxyalkyl, are optionally substituted phenyl, are optionally substituted benzyl, or, together with the N atom to which they are attached, are a ring which is optionally interrupted by oxygen or sulphur.

Depending on factors including the nature of the substituents, the compounds of formula (I) may be present in the form of geometrical and/or optical isomers or isomer mixtures, in different compositions, which can optionally be separated in a customary way. Not only the pure isomers but also the isomer mixtures can be used in materials of the invention and can be boosted in their activity through ammonium salts or phosphonium salts of the invention. Reference below is always, for the sake of simplicity to compounds of the formula (I), although what are meant are not only the pure compounds but also, where appropriate, mixtures containing different fractions of isomeric compounds.

Including the definitions (1) to (10) of the group CKE produces the following principal structures (I-1) to (I-10):

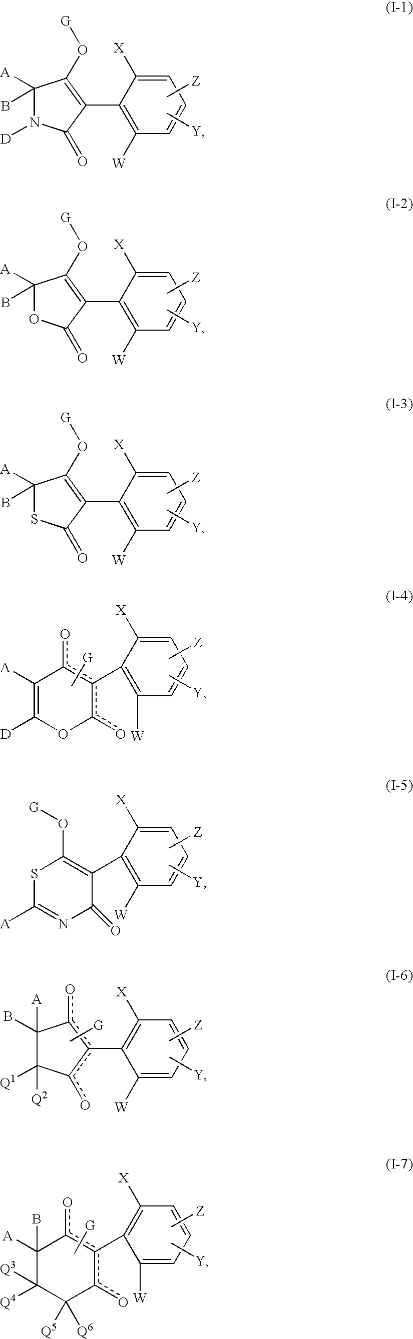

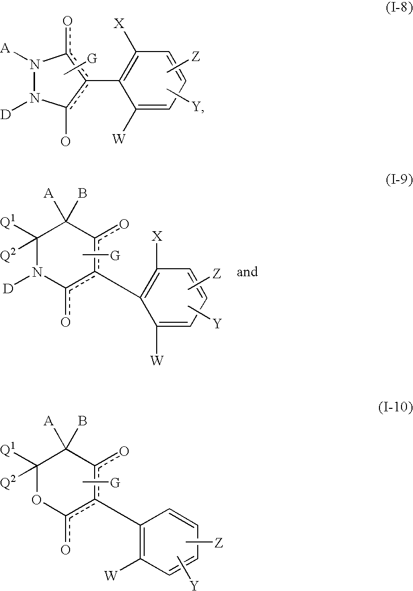

in which
A, B, D, G, Q¹, Q², Q³, Q⁴, Q⁵, Q⁶, W, X, Y and Z are as defined above.

Including the various definitions (a), (b), (c), (d), (e), (f) and (g) of the group G produces the following principal structures (I-1-a) to (I-1-g) if CKE is the group (1):

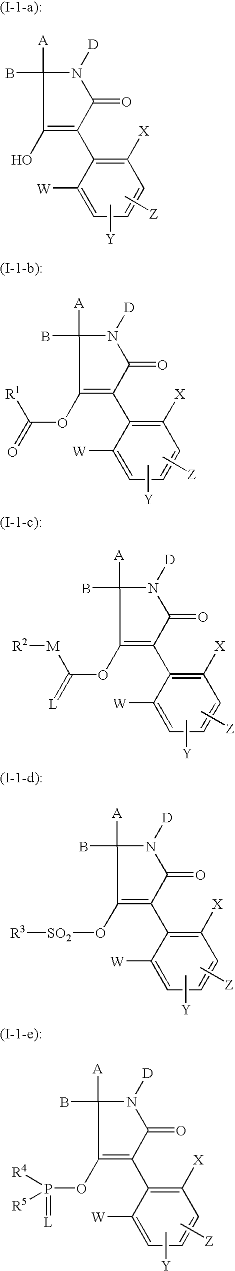

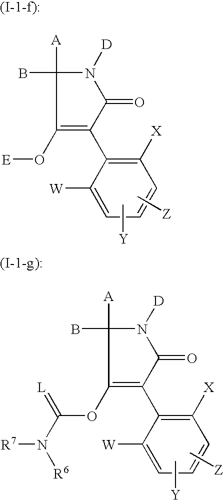

in which
A, B, D, E, L, M, W, X, Y, Z, R¹, R², R³, R⁴, R⁵, R⁶ and R⁷ are as defined above.

Including the various definitions (a), (b), (c), (d), (e), (f) and (g) of the group G produces the following principal structures (I-2-a) to (I-2-g) if CKE is the group (2):

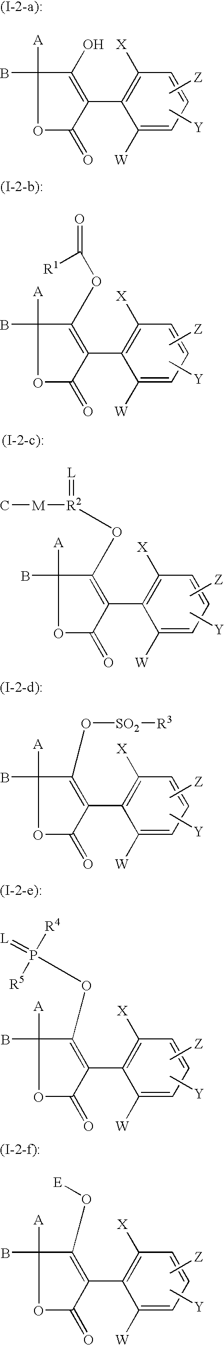

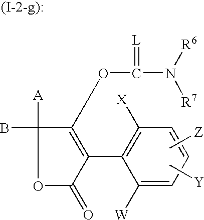

in which
A, B, E, L, M, W, X, Y, Z, R¹, R², R³, R⁴, R⁵, R⁶ and R⁷ are as defined above.

Including the various definitions (a), (b), (c), (d), (e), (f) and (g) of the group G produces the following principal structures (I-3-a) to (I-3-g) if CKE is the group (3):

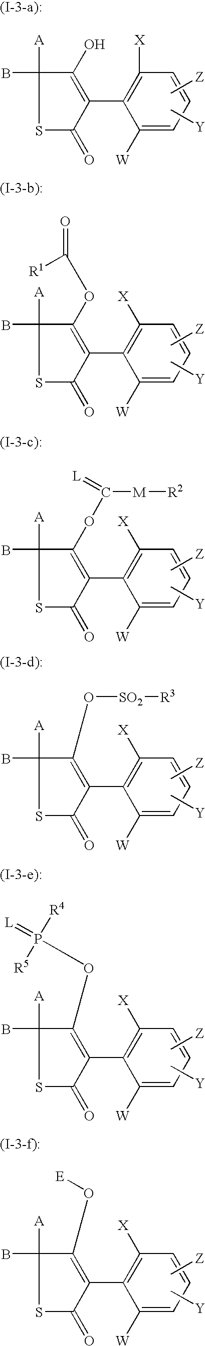

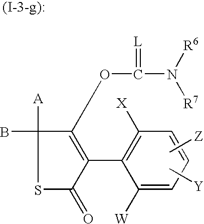

in which
A, B, E, L, M, W, X, Y, Z, R¹, R², R³, R⁴, R⁵, R⁶ and R⁷ are as defined above.

Depending on the position of the substituent G the compounds of the formula (I-4) may be present in the two isomeric forms of the formulae (I-4-A) and (I-4-B)

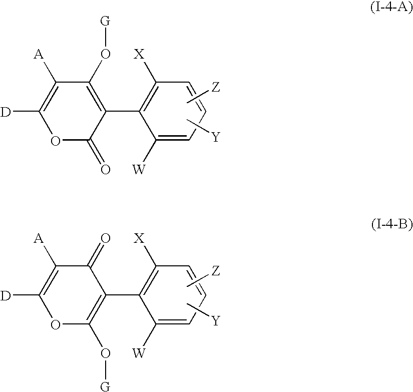

which the dashed line in the formula (I-4) is intended to express.

The compounds of the formula (I-4-A) and (I-4-B) may be present both as mixtures and in the form of their pure isomers. Mixtures of the compounds of the formulae (I-4-A) and (I-4-B) can be separated where appropriate in conventional manner by means of physical methods, such as by chromatographic methods, for example.

For reasons of greater clarity in each case only one of the possible isomers is set out below. This does not rule out the possibility of the compounds being present where appropriate in the form of the isomer mixtures or in the respective other isomeric form.

Including the various definitions (a), (b), (c), (d), (e), (f) and (g) of the group G produces the following principal structures (I-4-a) to (I-4-g) if CKE is the group (4):

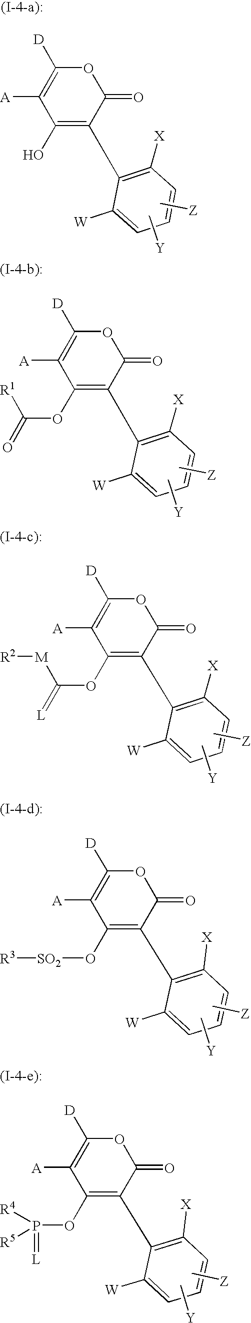

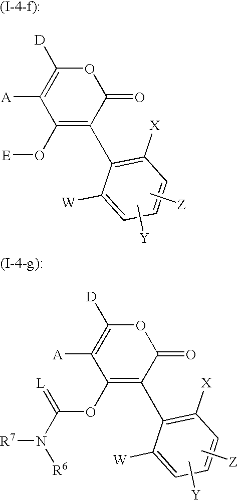

in which
A, D, E, L, M, W, X, Y, Z, R¹, R², R³, R⁴, R⁵, R⁶ and R⁷ are as defined above.

Including the various definitions (a), (b), (c), (d), (e), (f) and (g) of the group G produces the following principal structures (I-5-a) to (I-5-g) if CKE is the group (5):

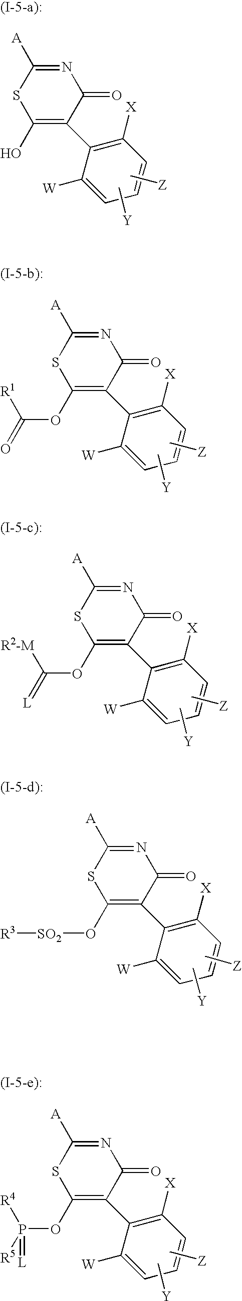

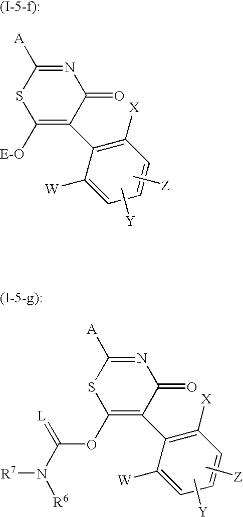

in which
A, E, L, M, W, X, Y, Z, R¹, R², R³, R⁴, R⁵, R⁶ and R⁷ are as defined above.

Depending on the position of the substituent G the compounds of the formula (I-6) may be present in the two isomeric forms of the formulae (I-6-A) and (I-6-B)

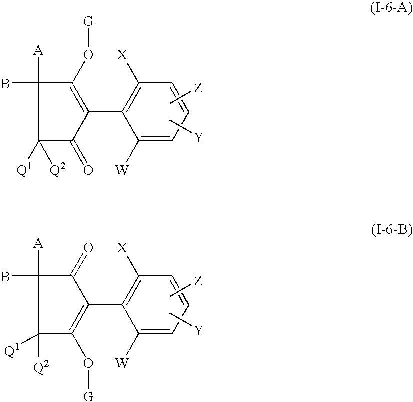

which the dashed line in the formula (I) is intended to express.

The compounds of the formulae (I-6-A) and (I-6-B) may be present both as mixtures and in the form of their pure isomers. Mixtures of the compounds of the formulae (I-6-A) and (I-6-B) can be separated where appropriate by means of physical methods, such as by chromatographic methods, for example.

For reasons of greater clarity in each case only one of the possible isomers is set out below. This does not rule out the possibility of the compounds being present where appropriate in the form of the isomer mixtures or in the respective other isomeric form.

Including the various definitions (a), (b), (c), (d), (e), (f) and (g) of the group G produces the following principal structures (I-6-a) to (I-6-g):

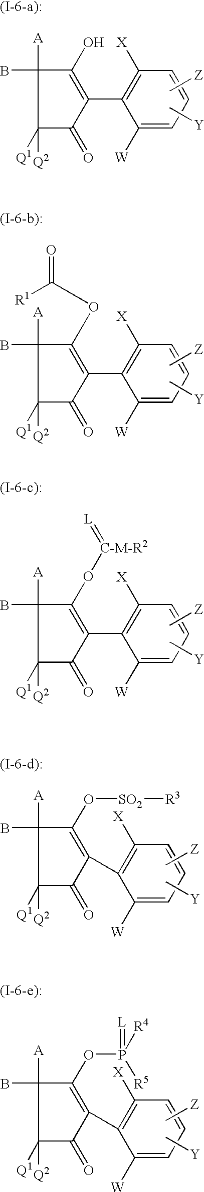

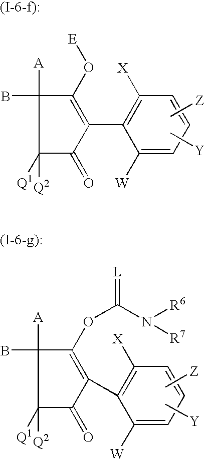

in which
A, B, Q¹, Q², E, L, M, W, X, Y, Z, R¹, R², R³, R⁴, R⁵, R⁶ and R⁷ are as defined above.

Depending on the position of the substituent G the compounds of the formula (I-7) may be present in the two isomeric forms of the formulae (I-7-A) and (I-7-B) which the dashed line in the formula (I-7) is intended to express:

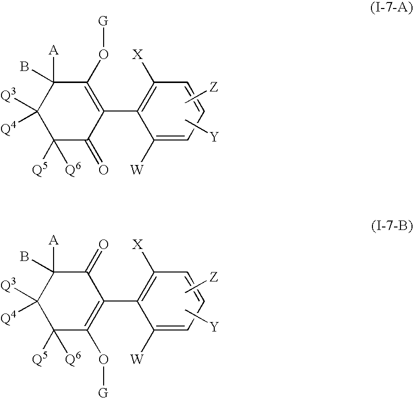

The compounds of the formulae (I-7-A) and (I-7-B) may be present both as mixtures and in the form of their pure isomers. Mixtures of the compounds of the formulae (I-7-A) and (I-7-B) can be separated where appropriate by means of physical methods, such as by chromatographic methods, for example.

For reasons of greater clarity in each case only one of the possible isomers is set out below. This does not rule out the possibility of the relevant compound being present where appropriate as isomer mixtures or in the respective other isomeric form.

Including the various definitions (a), (b), (c), (d), (e), (f) and (g) of the group G produces the following principal structures (I-7-a) to (I-7-g):

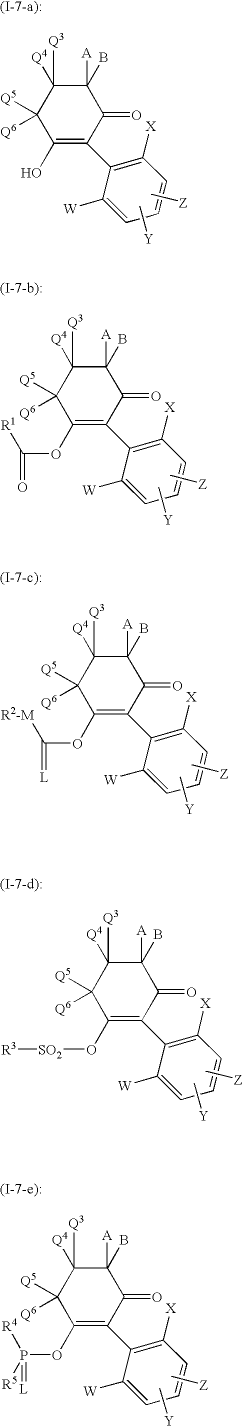

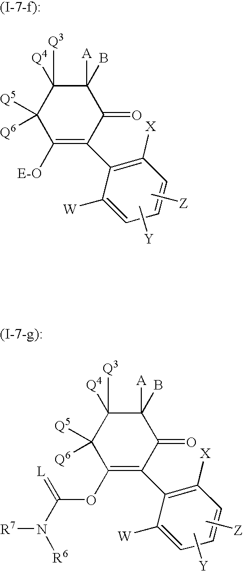

in which
A, B, E, L, M, Q³, Q⁴, Q⁵, Q⁶, W, X, Y, Z, R¹, R², R³, R⁴, R⁵, R⁶ and R⁷ are as defined above.

Depending on the position of the substituent G the compounds of the formula (I-8) can be present in the two isomeric formulae (I-8-A) and (I-8-B)

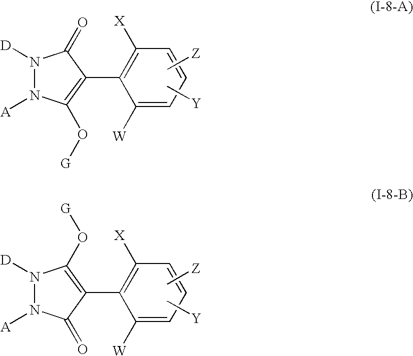

which the dashed line in the formulae (I-8) is intended to express.

The compounds of the formulae (I-8-A) and (I-8-B) may be present both as mixtures and in the form of their pure isomers. Mixtures of the compounds of the formulae (I-8-A) and (I-8-B) can be separated where appropriate in conventional manner by means of physical methods, such as by chromatographic methods, for example.

For reasons of greater clarity in each case only one of the possible isomers is set out below. This does not rule out the possibility of the compounds being present where appropriate in the form of the isomer mixtures or in the respective other isomeric form.

Including the various definitions (a), (b), (c), (d), (e), (f) and (g) of the group G produces the following principal structures (I-8-a) to (I-8-g) if Het is the group (8):

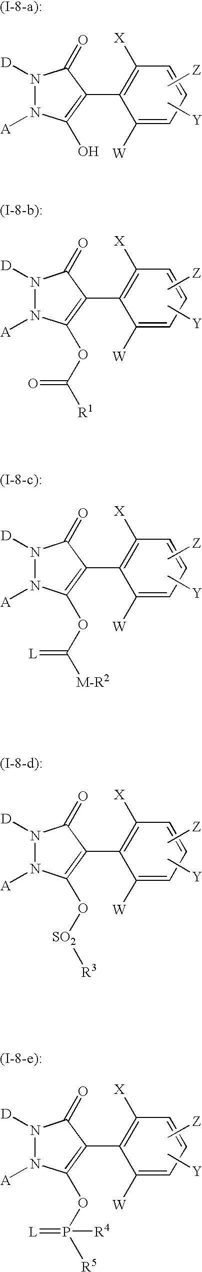

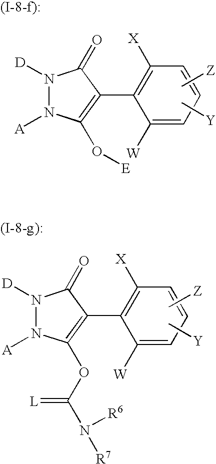

in which
A, D, E, L, M, W, X, Y, Z, R¹, R², R³, R⁴, R⁵, R⁶ and R⁷ are as defined above.

Depending on the position of the substituent G the compounds of the formulae (I-9) may be present in the two isomeric forms of the formulae (I-9-A) and (I-9-B) which the dashed line in the formula (I-9) is intended to express.

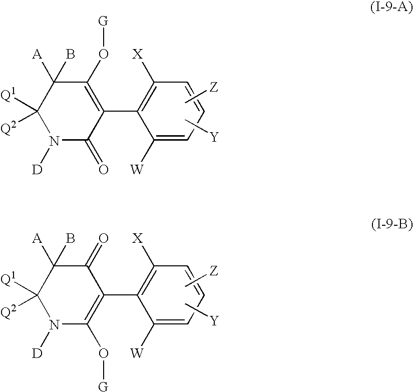

The compounds of the formula (I-9-A) and (I-9-B) may be present both as mixtures and in the form of their pure isomers. Mixtures of the compounds of the formulae (I-9-A) and (I-9-B) can be separated where appropriate in conventional manner by means of physical methods, such as by chromatographic methods, for example.

For reasons of greater clarity in each case only one of the possible isomers is set out below. This does not rule out the possibility of the compounds being present where appropriate in the form of the isomer mixtures or in the respective other isomeric form.

Including the various definitions (a), (b), (c), (d), (e), (f) and (g) of the group G produces the following principal structures (I-9-a) to (I-9-g) if CKE is the group (9):

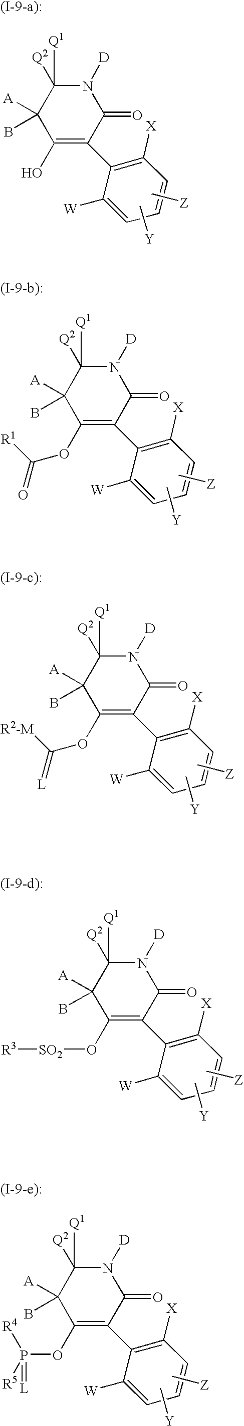

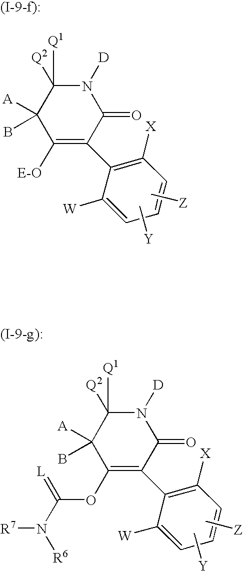

in which
A, B, D, E, L, M, Q¹, Q², W, X, Y, Z, R¹, R², R³, R⁴, R⁵, R⁶ and R⁷ are as defined above.

Depending on the position of the substituent G the compounds of the formula (I-10) may be present in the two isomeric forms of the formulae (I-10-A) and (I-10-B)

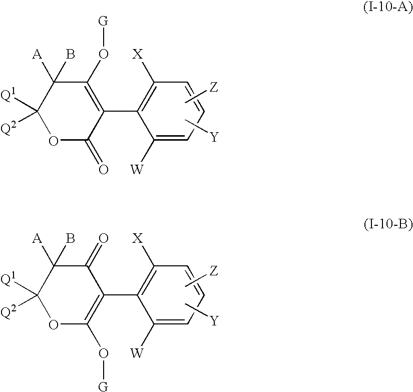

which the dashed line in the formula (I-10) is intended to express.

The compounds of the formulae (I-10-A) and (I-10-B) may be present both as mixtures and in the form of their pure isomers. Mixtures of the compounds of the formulae (I-10-A) and (I-10-B) can be separated where appropriate in conventional manner by means of physical methods, such as by chromatographic methods, for example.

For reasons of greater clarity in each case only one of the possible isomers is set out below. This does not rule out the possibility of the compounds being present where appropriate in the form of the isomer mixtures or in the respective other isomeric form.

Including the various definitions (a), (b), (c), (d), (e), (f) and (g) of the group G produces the following principal structures (I-10-a) to (I-10-g) if CKE is the group (10):

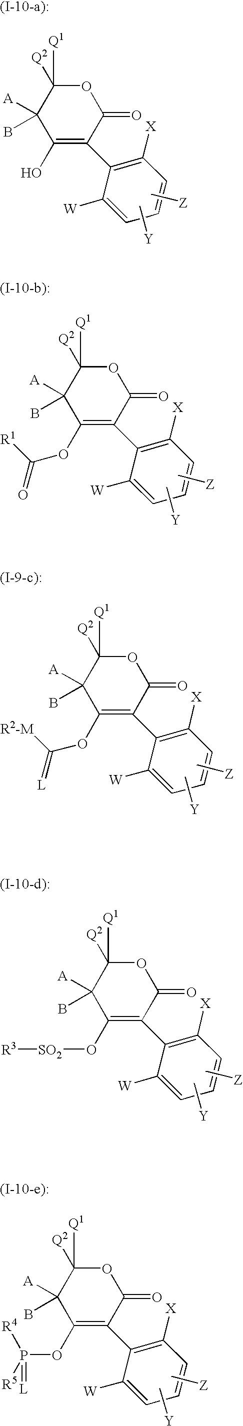

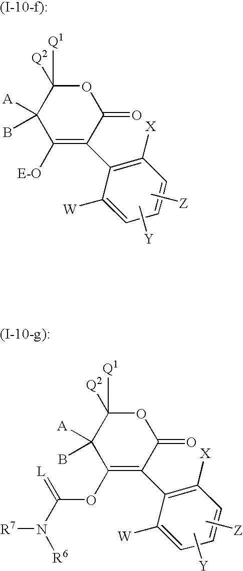

in which
A, B, D, E, L, M, Q¹, Q², W, X, Y, Z, R¹, R², R³, R⁴, R⁵, R⁶ and R⁷ are as defined above.

A general definition of the compounds of the invention is given by the formula (I). Preferred substituents and/or ranges of the radicals listed in the formulae mentioned above and below are elucidated in the following text:
W is preferably hydrogen, C₁-C₆-alkyl, C₂-C₆-alkenyl, C₂-C₆-alkynyl, halogen, C₁-C₆-alkoxy, C₁-C₄-haloalkyl, C₁-C₄-haloalkoxy or cyano,
X is preferably halogen, C₁-C₆-alkyl, C₂-C₆-alkenyl, C₂-C₆-alkynyl, C₁-C₆-alkoxy, C₁-C₆-alkoxy-C₁-C₄-alkoxy, C₁-C₄-haloalkyl, C₁-C₄-haloalkoxy or cyano,
Y is preferably hydrogen, halogen, C₁-C₆-alkyl, C₂-C₆-alkenyl, C₂-C₆-alkynyl, C₁-C₆-alkoxy, cyano, C₁-C₄-haloalkyl, haloalkoxy, or is V¹- and V²-substituted phenyl or pyridyl,
V¹ is preferably halogen, C₁-C₁₂-alkyl, C₁-C₆-alkoxy, C₁-C₄-haloalkyl, C₁-C₄-haloalkoxy, cyano or nitro.
V² is preferably hydrogen, halogen, C₁-C₆-alkyl, C₁-C₆-alkoxy or C₁-C₄-haloalkyl,
V¹ and V² are preferably together C₃-C₄-alkanediyl which optionally can be substituted by halogen and/or C₁-C₂-alkyl and which optionally can be interrupted by one or two oxygen atoms.
Z is preferably hydrogen, halogen, C₁-C₆-alkyl, C₁-C₄-haloalkyl, cyano, C₁-C₆-alkoxy or C₁-C₄-haloalkoxy.
CKE is preferably one of the groups

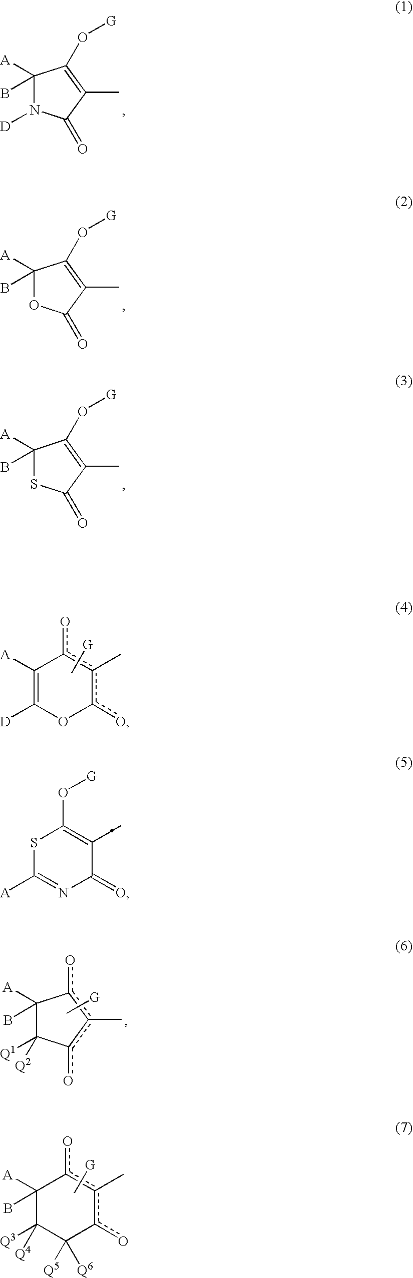

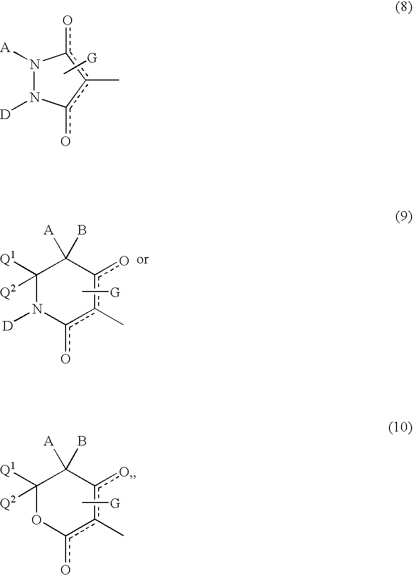

A is preferably hydrogen or in each case optionally halogen-substituted C₁-C₁₂-alkyl, C₃-C₈-alkenyl, C₁-C₁₀-alkoxy-C₁-C₈-alkyl, C₁-C₁₀-alkylthio-C₁-C₆-alkyl, optionally halogen-, C₁-C₆-alkyl- or C₁-C₆-alkoxy-substituted C₃-C₈-cycloalkyl in which optionally one or two ring members not directly adjacent are replaced by oxygen and/or sulphur, or is in each case optionally halogen-, C₁-C₆-alkyl-, C₁-C₆-haloalkyl-, C₁-C₆-alkoxy-, C₁-C₆-haloalkoxy-, cyano- or nitro-substituted phenyl, naphthyl, hetaryl having 5 to 6 ring atoms (for example furanyl, pyridyl, imidazolyl, triazolyl, pyrazolyl, pyrimidyl, thiazolyl or thienyl), phenyl-C₁-C₆-alkyl or naphthyl-C₁-C₆-alkyl,
B is preferably hydrogen, C₁-C₁₂-alkyl or C₁-C₈-alkoxy-C₁-C₆-alkyl or
A, B and the carbon atom to which they are attached are preferably saturated C₃-C₁₀-cycloalkyl or unsaturated C₅-C₁₀-cycloalkyl, in which optionally one ring member is replaced by oxygen or sulphur and which optionally are singly or doubly substituted by C₁-C₈-alkyl, C₁-C₆-alkoxy-C₁-C₆-alkyl, C₃-C₆-cycloalkyl-C₁-C₂-alkoxy, C₃-C₁₀-cycloalkyl, C₁-C₈-haloalkyl, C₁-C₈-alkoxy, C₁-C₆-alkoxy-C₁-C₄-alkoxy, C₁-C₈-alkylthio, halogen or phenyl, or
A, B and the carbon atom to which they are attached are preferably C₃-C₆-cycloalkyl which is substituted by an alkylenediyl group which is optionally substituted by C₁-C₄-alkyl and optionally contains one or two oxygen and/or sulphur atoms not directly adjacent, or by an alkylenedioxyl group or by an alkylenedithioyl group, which with the carbon atom to which it is attached forms a further five- to eight-membered ring, or
A, B and the carbon atom to which they are attached are preferably C₃-C₈-cycloalkyl or C₅-C₈-cycloalkenyl in which two substituents, together with the carbon atoms to which they are attached, are in each case optionally C₁-C₆-alkyl-, C₁-C₆-alkoxy- or halogen-substituted C₂-C₆-alkanediyl, C₂-C₆-alkenediyl or C₄-C₆-alkanedienediyl, in which optionally one methylene group is replaced by oxygen or sulphur,
D is preferably hydrogen, in each case optionally halogen-substituted C₁-C₁₂-alkyl, C₃-C₈-alkenyl, C₃-C₈-alkynyl, C₁-C₁₀-alkoxy-C₂-C₈-alkyl, optionally halogen-, C₁-C₄-alkyl-, C₁-C₄-alkoxy- or C₁-C₄-haloalkyl-substituted C₃-C₈-cycloalkyl in which optionally one ring member is replaced by oxygen or sulphur, or is in each case optionally halogen-, C₁-C₆-alkyl-, C₁-C₆-haloalkyl-, C₁-C₆-alkoxy-, C₁-C₆-haloalkoxy-, cyano- or nitro-substituted phenyl, hetaryl having 5 or 6 ring atoms (for example furanyl, imidazolyl, pyridyl, thiazolyl, pyrazolyl, pyrimidyl, pyrrolyl, thienyl or triazolyl), phenyl-C₁-C₆-alkyl or hetaryl-C₁-C₆-alkyl having 5 or 6 ring atoms (for example furanyl, imidazolyl, pyridyl, thiazolyl, pyrazolyl, pyrimidyl, pyrrolyl, thienyl or triazolyl) or
A and D are preferably together in each case optionally substituted C₃-C₆-alkanediyl or C₃-C₆-alkenediyl, in which optionally one methylene group is replaced by a carbonyl group, oxygen or sulphur, and
   suitable substituents are in each case as follows:
   halogen, hydroxyl, mercapto or in each case optionally halogen-substituted C₁-C₁₀-alkyl, C₁-C₆-alkoxy, C₁-C₆-alkylthio, C₃-C₇-cycloalkyl, phenyl or benzyloxy, or a further C₃-C₆-alkanediyl moiety, C₃-C₆-alkenediyl moiety or a butadienyl moiety, which is optionally substituted by C₁-C₆-alkyl or in which optionally two adjacent substituents, with the carbon atoms to which they are attached, form a further saturated or unsaturated ring having 5 or 6 ring atoms (in the case of the compound of the formula (I-1) A and D, together with the atoms to which they are attached, then are, for example, the groups AD-1 to AD-10 specified later on below), which can contain oxygen or sulphur, or in which optionally one of the following groups

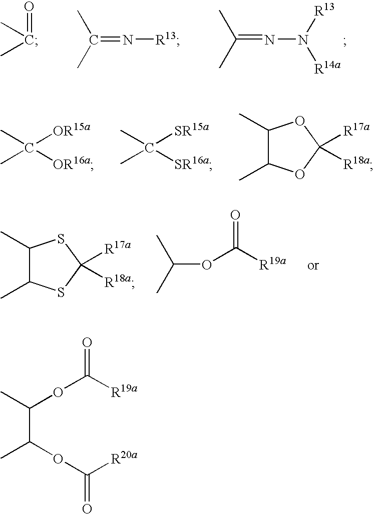

is present, or
A and Q¹ are together preferably C₄-C₆-alkenediyl or C₃-C₆-alkanediyl which are in each case optionally substituted one or two times by identical or different substituents selected from halogen, hydroxyl, C₃-C₇-cycloalkyl, C₁-C₆-alkylthio, C₁-C₆-alkoxy or C₁-C₁₀-alkyl in each case optionally substituted one to three times by identical or different halogen substituents, and phenyl or benzyloxy in each case optionally substituted one to three times by identical or different halogen, C₁-C₆-alkyl or C₁-C₆-alkoxy substituents, and which, moreover, optionally contains one of the following groups

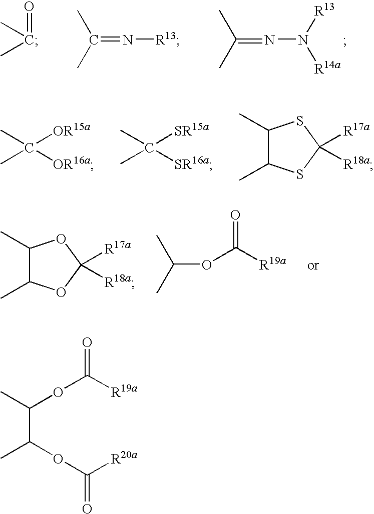

or is bridged by a C₁-C₂-alkanediyl group or by an oxygen atom, or
D and Q¹ are preferably together C₃-C₆-alkanediyl which is in each case optionally substituted one or two times by identical or different substituents selected from C₁-C₄-alkyl and C₁-C₄-alkoxy.
Q¹ is preferably hydrogen, C₁-C₆-alkyl, C₁-C₆-alkoxy-C₁-C₂-alkyl, optionally fluorine-, chlorine-, C₁-C₄-alkyl-, C₁-C₂-haloalkyl- or C₁-C₄-alkoxy-substituted C₃-C₈-cycloalkyl, in which optionally one methylene group is replaced by oxygen or sulphur, or is optionally halogen-, C₁-C₄-alkyl-, C₁-C₄-alkoxy-, C₁-C₂-haloalkyl-, C₁-C₂-haloalkoxy-, cyano- or nitro-substituted phenyl, or
Q², Q⁴, Q⁵ and Q⁶ independently of one another are preferably hydrogen or C₁-C₄-alkyl,
Q³ is preferably hydrogen, C₁-C₆-alkyl, C₁-C₆-alkoxy-C₁-C₂-alkyl, C₁-C₆-alkylthio-C₁-C₂-alkyl, optionally C₁-C₄-alkyl- or C₁-C₄-alkoxy-substituted C₃-C₈-cycloalkyl, in which optionally one methylene group is replaced by oxygen or sulphur, or is optionally halogen-, C₁-C₄-alkyl-, C₁-C₄-alkoxy-, C₁-C₂-haloalkyl-, C₁-C₂-haloalkoxy-, cyano- or nitro-substituted phenyl.
Q1 and Q2, with the carbon atom to which they are attached, are preferably optionally C₁-C₆-alkyl-, C₁-C₆-alkoxy- or C₁-C₂-haloalkyl-substituted C₃-C₇ ring in which optionally one ring member is replaced by oxygen or sulphur,
Q³ and Q⁴, together with the carbon atom to which they are attached, are preferably an optionally C₁-C₄-alkyl-, C₁-C₄-alkoxy- or C₁-C₂-haloalkyl-substituted C₃-C₇ ring in which optionally one ring member is replaced by oxygen or sulphur,
G is preferably hydrogen (a) or is one of the groups

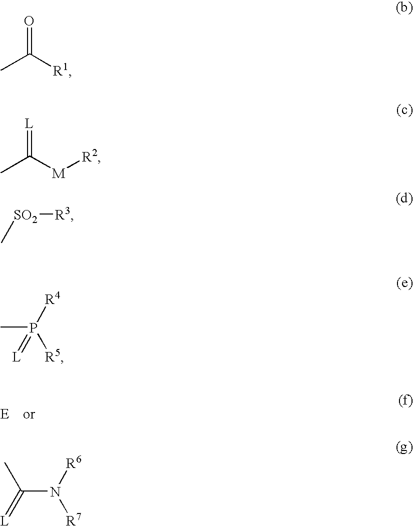

in particular is (a), (b), (c) or (g)
in which
E is one metal ion equivalent or ammonium ion,
L is oxygen or sulphur and
M is oxygen or sulphur.
R¹ is preferably in each case optionally halogen-substituted C₁-C₂₀-alkyl, C₂-C₂₀-alkenyl, C₁-C₈-alkoxy-C₁-C₈-alkyl, C₁-C₈-alkylthio-C₁-C₈-alkyl, poly-C₁-C₈-alkoxy-C₁-C₈-alkyl or optionally halogen-, C₁-C₆-alkyl- or C₁-C₆-alkoxy-substituted C₃-C₈-cycloalkyl in which optionally one or more (preferably not more than two) ring members not directly adjacent are replaced by oxygen and/or sulphur,
   is optionally halogen-, cyano-, nitro-, C₁-C₆-alkyl-, C₁-C₆-alkoxy-, C₁-C₆-haloalkyl-, C₁-C₆-haloalkoxy-, C₁-C₆-alkylthio- or C₁-C₆-alkylsulphonyl-substituted phenyl,
   is optionally halogen-, nitro-, cyano-, C₁-C₆-alkyl-, C₁-C₆-alkoxy-, C₁-C₆-haloalkyl- or C₁-C₆-haloalkoxy-substituted phenyl-C₁-C₆-alkyl,
   is optionally halogen- or C₁-C₆-alkyl-substituted 5- or 6-membered hetaryl (for example pyrazolyl, thiazolyl, pyridyl, pyrimidyl, furanyl or thienyl),
   is optionally halogen- or C₁-C₆-alkyl-substituted phenoxy-C₁-C₆-alkyl or
   is optionally halogen-, amino- or C₁-C₆-alkyl-substituted 5- or 6-membered hetaryloxy-C₁-C₆-alkyl (for example pyridyloxy-C₁-C₆-alkyl, pyrimidyloxy-C₁-C₆-alkyl or thiazolyloxy-C₁-C₆-alkyl),
R² is preferably in each case optionally halogen-substituted C₁-C₂₀-alkyl, C₂-C₂₀-alkenyl, C₁-C₈-alkoxy-C₂-C₈-alkyl, poly-C₁-C₈-alkoxy-C₂-C₈-alkyl,
   is optionally halogen-, C₁-C₆-alkyl- or C₁-C₆-alkoxy-substituted C₃-C₈-cycloalkyl or
   is in each case optionally halogen-, cyano-, nitro-, C₁-C₆-alkyl-, C₁-C₆-alkoxy-, C₁-C₆-haloalkyl- or C₁-C₆-haloalkoxy-substituted phenyl or benzyl,
R³ is preferably optionally halogen-substituted C₁-C₈-alkyl or is in each case optionally halogen-, C₁-C₆-alkyl-, C₁-C₆-alkoxy-, C₁-C₄-haloalkyl-, C₁-C₄-haloalkoxy-, cyano- or nitro-substituted phenyl or benzyl,
R⁴ and R⁵ independently of one another are preferably in each case optionally halogen-substituted C₁-C₈-alkyl, C₁-C₈-alkoxy, C₁-C₈-alkylamino, di-(C₁-C₈-alkyl)amino, C₁-C₈-alkylthio, C₂-C₈-alkenylthio, C₃-C₇-cycloalkylthio or are in each case optionally halogen-, nitro-, cyano-, C₁-C₄-alkoxy-, C₁-C₄-haloalkoxy-, C₁-C₄-alkylthio-, C₁-C₄-haloalkylthio-, C₁-C₄-alkyl- or C₁-C₄-haloalkyl-substituted phenyl, phenoxy or phenylthio,
R⁶ and R⁷ are preferably independently of one another hydrogen, are in each case optionally halogen-substituted C₁-C₈-alkyl, C₃-C₈-cycloalkyl, C₁-C₈-alkoxy, C₃-C₈-alkenyl, C₁-C₈-alkoxy-C₁-C₈-alkyl, are optionally halogen-, C₁-C₈-haloalkyl-, C₁-C₈-alkyl- or C₁-C₈-alkoxy-substituted phenyl, optionally halogen-, C₁-C₈-alkyl-, C₁-C₈-haloalkyl- or C₁-C₈-alkoxy-substituted benzyl or together are an optionally C₁-C₄-alkyl-substituted C₃-C₆-alkylene radical in which optionally one carbon atom is replaced by oxygen or sulphur,
R¹³ is preferably hydrogen, is in each case optionally halogen-substituted C₁-C₈-alkyl or C₁-C₈-alkoxy, is optionally halogen-, C₁-C₄-alkyl- or C₁-C₄-alkoxy-substituted C₃-C₈-cycloalkyl in which optionally one methylene group is replaced by oxygen or sulphur, or is in each case optionally halogen-, C₁-C₆-alkyl-, C₁-C₆-alkoxy-, C₁-C₄-haloalkyl-, C₁-C₄-haloalkoxy-, nitro- or cyano-substituted phenyl, phenyl-C₁-C₄-alkyl or phenyl-C₁-C₄-alkoxy,
R^{14a} is preferably hydrogen or C₁-C₈-alkyl or
R¹³ and R^{14a} are preferably together C₄-C₆-alkanediyl,
R^{15a} and R^{16a} are alike or different and are preferably C₁-C₆-alkyl or
R^{15a} and R^{16a} are preferably together a C₂-C₄-alkanediyl radical which is optionally substituted by C₁-C₆-alkyl, C₁-C₆-haloalkyl or by optionally halogen-, C₁-C₆-alkyl-, C₁-C₄-haloalkyl-, C₁-C₆-alkoxy-, C₁-C₄-haloalkoxy-, nitro- or cyano-substituted phenyl,
R^{17a} and R^{18a} are preferably independently of one another hydrogen, are optionally halogen-substituted C₁-C₈-alkyl or are optionally halogen-, C₁-C₆-alkyl-, C₁-C₆-alkoxy-, C₁-C₄-haloalkyl-, C₁-C₄-haloalkoxy-, nitro- or cyano-substituted phenyl or
R^{17a} and R^{18a}, together with the carbon atom to which they are attached, are preferably a carbonyl group or are optionally halogen-, C₁-C₄-alkyl- or C₁-C₄-alkoxy-substituted C₅-C₇-cycloalkyl in which optionally one methylene group is replaced by oxygen or sulphur,
R^{19a} and R^{20a} are preferably independently of one another C₁-C₁₀-alkyl, C₂-C₁₀-alkenyl, C₁-C₁₀-alkoxy, C₁-C₁₀-alkylamino, C₃-C₁₀-alkenylamino, di-(C₁-C₁₀-alkyl)amino or di-(C₃-C₁₀-alkenyl)amino.

In the radical definitions qualified by “preferably” halogen or halo is fluorine, chlorine, bromine and iodine, in particular fluorine, chlorine and bromine.
W is with particular preference hydrogen, fluorine, chlorine, bromine, C₁-C₄-alkyl, C₂-C₄-alkenyl, C₂-C₄-alkynyl, C₁-C₄-alkoxy, C₁-C₂-haloalkyl or C₁-C₂-haloalkoxy,
X is with particular preference chlorine, bromine, iodine, C₁-C₄-alkyl, C₂-C₄-alkenyl, C₂-C₄-alkynyl, C₁-C₄-alkoxy, C₁-C₄-alkoxy-C₁-C₃-alkoxy, C₁-C₂-haloalkyl, C₁-C₂-haloalkoxy or cyano,
Y is with particular preference in position 4 hydrogen, fluorine, chlorine, bromine, iodine, methoxy, ethoxy, cyano, trifluoromethyl, difluoromethoxy or trifluoromethoxy,
Z is with particular preference hydrogen.
W is with particular preference also hydrogen, fluorine, chlorine, bromine or C₁-C₄-alkyl,
X is with particular preference also chlorine, bromine, C₁-C₄-alkyl, C₁-C₄-alkoxy, C₁-C₂-haloalkyl, C₁-C₂-haloalkoxy or cyano,
Y is with particular preference also in position 4 C₂-C₄-alkenyl, C₂-C₄-alkynyl or the radical

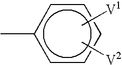

Z is with particular preference also hydrogen,
V¹ is with particular preference also fluorine, chlorine, C₁-C₄-alkyl, C₁-C₄-alkoxy, C₁-C₂-haloalkyl or C₁-C₂-haloalkoxy, cyano or nitro,
V² is with particular preference also hydrogen, fluorine, chlorine, C₁-C₄-alkyl, C₁-C₄-alkoxy or C₁-C₂-haloalkyl,
V¹ and V² together are with particular preference also —O—CH₂—O— and —O—CF₂—O—.
W is with particular preference likewise hydrogen, fluorine, chlorine, bromine or C₁-C₄-alkyl,
X is with particular preference likewise chlorine, bromine, C₁-C₄-alkyl, C₁-C₄-alkoxy, C₁-C₂-haloalkyl, C₁-C₂-haloalkoxy or cyano,
Y is with particular preference likewise in position 5 C₂-C₄-alkenyl, C₂-C₄-alkynyl or the radical

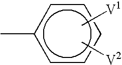

Z is with particular preference likewise in position 4 hydrogen, C₁-C₄-alkyl or chlorine,
V¹ is with particular preference likewise fluorine, chlorine, C₁-C₄-alkyl, C₁-C₄-alkoxy, C₁-C₂-haloalkyl or C₁-C₂-haloalkoxy, cyano or nitro,
V² is with particular preference likewise hydrogen, fluorine, chlorine, C₁-C₄-alkyl, C₁-C₄-alkoxy or C₁-C₂-haloalkyl,
V¹ and V² together are with particular preference likewise —O—CH₂—O— and —O—CF₂—O—.
W moreover is with particular preference hydrogen, C₁-C₄-alkyl, C₂-C₄-alkenyl, C₂-C₄-alkynyl, C₁-C₄-alkoxy, fluorine, chlorine, bromine or trifluoromethyl,
X moreover is with particular preference fluorine, chlorine, bromine, iodine, C₁-C₄-alkyl, C₂-C₄-alkenyl, C₂-C₄-alkynyl, C₁-C₄-alkoxy, C₁-C₄-alkoxy-C₁-C₃-alkoxy, C₁-C₂-haloalkyl, C₁-C₂-haloalkoxy or cyano,
Y moreover in position 4 is with particular preference C₁-C₄-alkyl,
Z moreover is with particular preference hydrogen.
W additionally is with particular preference hydrogen, fluorine, chlorine, bromine, C₁-C₄-alkyl or C₁-C₄-alkoxy,
X additionally is with particular preference chlorine, bromine, iodine, C₁-C₄-alkyl, C₁-C₄-alkoxy, C₁-C₂-haloalkyl, C₁-C₂-haloalkoxy or cyano,
Y additionally in position 4 is with particular preference hydrogen, chlorine, bromine, iodine, C₁-C₄-alkyl, C₁-C₂-haloalkyl or C₁-C₂-haloalkoxy,
Z additionally in position 3 or 5 is with particular preference fluorine, chlorine, bromine, iodine, C₁-C₄-alkyl, C₁-C₂-haloalkyl, C₁-C₄-alkoxy or C₁-C₂-haloalkoxy.
CKE stands with particular preference for one of the groups

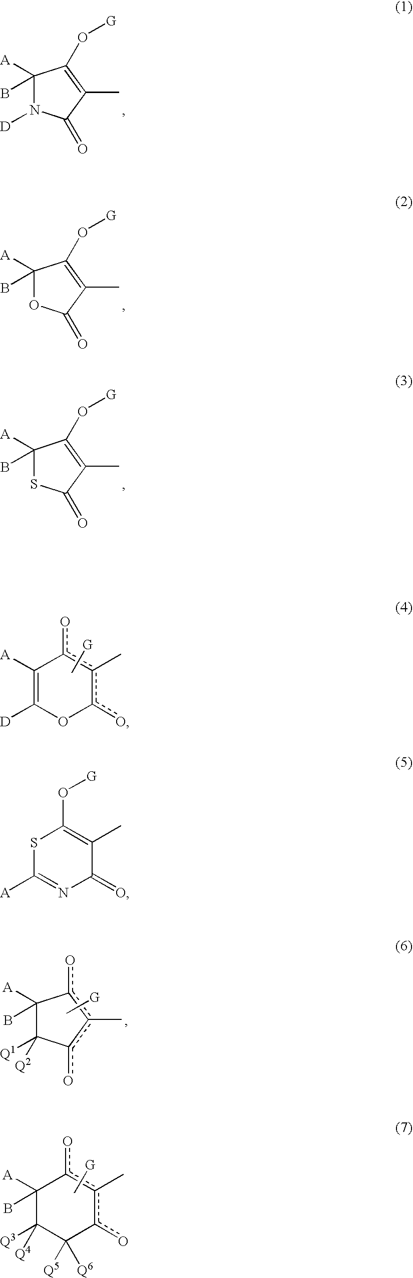

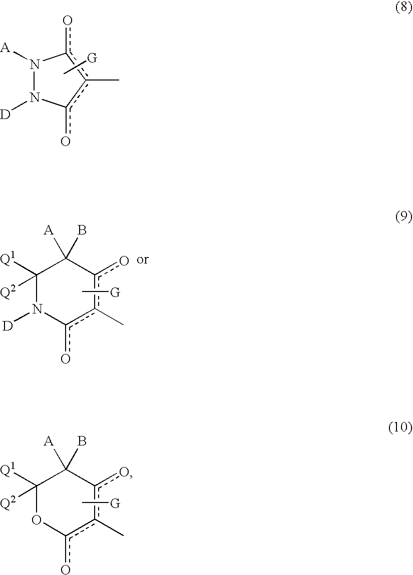

A is with particular preference hydrogen, in each case optionally mono- to tri-fluorine- or -chlorine-substituted C₁-C₆-alkyl, C₁-C₄-alkoxy-C₁-C₂-alkyl, optionally singly to doubly C₁-C₂-alkyl- or C₁-C₂-alkoxy-substituted C₃-C₆-cycloalkyl or (but not in the case of the compounds of the formulae (I-3), (I-4), (I-6) and (I-7)) in each case optionally singly to doubly fluorine-, chlorine-, bromine-, C₁-C₄-alkyl-, C₁-C₂-haloalkyl-, C₁-C₄-alkoxy-, C₁-C₂-haloalkoxy-, cyano- or nitro-substituted phenyl or benzyl,
B is with particular preference hydrogen, C₁-C₄-alkyl or C₁-C₂-alkoxy-C₁-C₂-alkyl, or
A, B and the carbon atoms to which they are attached are with particular preference saturated or unsaturated C₃-C₇-cycloalkyl in which optionally one ring member is replaced by oxygen or sulphur and which is optionally singly to doubly substituted by C₁-C₆-alkyl, C₁-C₄-alkoxy-C₁-C₂-alkyl, trifluoromethyl, C₁-C₆-alkoxy, C₁-C₃-alkoxy-C₁-C₃-alkoxy or C₃-C₆-cycloalkylmethoxy, with the proviso that in that case Q³ is with particular preference hydrogen or methyl, or
A, B and the carbon atom to which they are attached are with particular preference C₅-C₆-cycloalkyl which is substituted by an alkylenedithiol group or by an alkylenedioxyl group or by an alkylenediyl group which is optionally substituted by methyl or ethyl and optionally contains one or two oxygen or sulphur atoms not directly adjacent, and which, with the carbon atom to which it is attached, forms a further five- or six-membered ring, with the proviso that in that case Q³ is with particular preference hydrogen or methyl, or
A, B and the carbon atom to which they are attached are with particular preference C₃-C₆-cycloalkyl or C₅-C₆-cycloalkenyl in which two substituents, together with the carbon atoms to which they are attached, are in each case optionally C₁-C₂-alkyl- or C₁-C₂-alkoxy-substituted C₂-C₄-alkanediyl, C₂-C₄-alkenediyl or butadienediyl, with the proviso that in that case Q³ is with particular preference hydrogen or methyl,
D is with particular preference hydrogen, is in each case optionally mono- to tri-fluoro-substituted C₁-C₆-alkyl, C₃-C₆-alkenyl, C₁-C₄-alkoxy-C₂-C₃-alkyl, is optionally C₃-C₆-cycloalkyl which is singly to doubly substituted by C₁-C₄-alkyl, C₁-C₄-alkoxy or C₁-C₂-haloalkyl and in which optionally one methylene group is replaced by oxygen, or (but not in the case of the compounds of the formulae (I-1)) is pyridyl or phenyl in each case optionally substituted singly to doubly by fluorine, chlorine, bromine, C₁-C₄-alkyl, C₁-C₄-haloalkyl, C₁-C₄-alkoxy or C₁-C₄-haloalkoxy, or
A and D together are with particular preference optionally singly to doubly substituted C₃-C₅-alkanediyl in which one methylene group can be replaced by a carbonyl group (but not in the case of the compounds of the formula (I-1)), oxygen or sulphur, suitable substituents being C₁-C₂-alkyl or C₁-C₂-alkoxy, or
A and D (in the case of the compounds of the formula (I-1)), together with the atoms to which they are attached, are one of the groups AD-1 to AD-10:

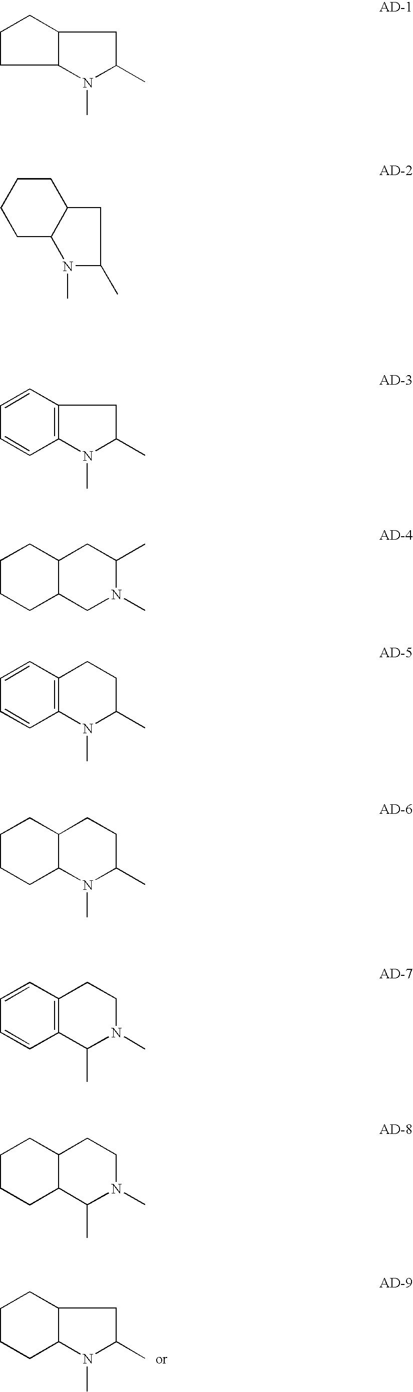

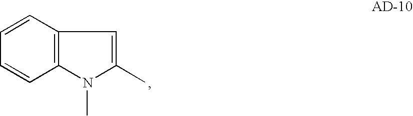

or
A and Q¹ together are with particular preference C₃-C₄-alkanediyl in each case optionally substituted singly or doubly by identical or different substituents selected from C₁-C₂-alkyl or C₁-C₂-alkoxy, or
D and Q¹ together are with particular preference C₃-C₄-alkanediyl, or
Q¹ is with particular preference hydrogen, C₁-C₄-alkyl, C₁-C₄-alkoxy-C₁-C₂-alkyl, or optionally methyl- or methoxy-substituted C₃-C₆-cycloalkyl in which optionally one methylene group is replaced by oxygen,
Q² is with particular preference hydrogen, methyl or ethyl,
Q⁴, Q⁵ and Q⁶ independently of one another are with particular preference hydrogen or C₁-C₃-alkyl,
Q³ is with particular preference hydrogen, C₁-C₄-alkyl, or optionally singly to doubly methyl- or methoxy-substituted C₃-C₆-cycloalkyl, or
Q¹ and Q² are with particular preference hydrogen, C₁-C₄-alkyl, C₁-C₄-alkoxy-C₁-C₂-alkyl, or optionally methyl- or methoxy-substituted C₃-C₆-cycloalkyl in which optionally one methylene group is replaced by oxygen, or
Q³ and Q⁴, together with the carbon to which they are attached, are with particular preference an optionally C₁-C₂-alkyl- or C₁-C₂-alkoxy-substituted saturated C₅-C₆ ring in which optionally one ring member is replaced by oxygen or sulphur, with the proviso that in that case A is with particular preference is hydrogen or methyl,
G is with particular preference hydrogen (a) or is one of the groups

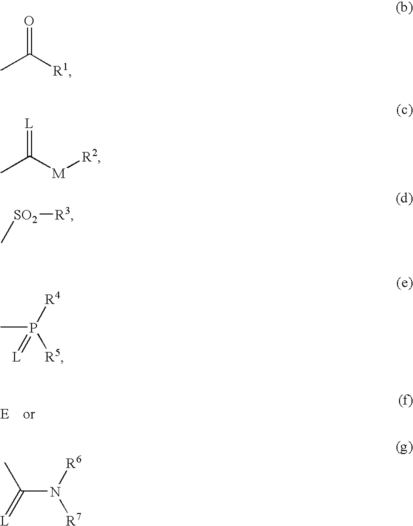

in particular is (a), (b) or (c),
in which
E is one metal ion equivalent or an ammonium ion,
L is oxygen or sulphur and
M is oxygen or sulphur,
R¹ is with particular preference in each case optionally mono- to tri-fluorine- or -chlorine-substituted C₁-C₈-alkyl, C₂-C₁₈-alkenyl, C₁-C₄-alkoxy-C₁-C₂-alkyl, C₁-C₄-alkylthio-C₁-C₂-alkyl or optionally singly- to doubly fluorine-, chlorine-, C₁-C₂-alkyl- or C₁-C₂-alkoxy-substituted C₃-C₆-cycloalkyl in which optionally one or two ring members not directly adjacent are replaced by oxygen,
   is phenyl optionally substituted by fluorine, chlorine, bromine, cyano, nitro, C₁-C₄-alkyl, C₁-C₄-alkoxy, C₁-C₂-haloalkyl or C₁-C₂-haloalkoxy,
R² is in each case optionally mono- to tri-fluorine-substituted C₁-C₈-alkyl, C₂-C₈-alkenyl or C₁-C₄-alkoxy-C₂-C₄-alkyl,
   is optionally mono-C₁-C₂-alkyl- or —C₁-C₂-alkoxy-substituted C₃-C₆-cycloalkyl or
   is benzyl or phenyl in each case optionally substituted singly to doubly by fluorine, chlorine, bromine, cyano, nitro, C₁-C₄-alkyl, C₁-C₃-alkoxy, trifluoromethyl or trifluoromethoxy,
R³ is with particular preference C₁-C₆-alkyl optionally substituted one to three times by fluorine or is phenyl optionally substituted once by fluorine, chlorine, bromine, C₁-C₄-alkyl, C₁-C₄-alkoxy, trifluoromethyl, trifluoromethoxy, cyano or nitro,
R⁴ is with particular preference C₁-C₆-alkyl, C₁-C₆-alkoxy, C₁-C₆-alkylamino, di-(C₁-C₆-alkyl)amino, C₁-C₆-alkylthio, C₃-C₄-alkenylthio, C₃-C₆-cycloalkylthio or is phenylthio, phenoxy or phenyl in each case optionally substituted once by fluorine, chlorine, bromine, nitro, cyano, C₁-C₃-alkoxy, C₁-C₃-haloalkoxy, C₁-C₃-alkylthio, C₁-C₃-haloalkylthio, C₁-C₃-alkyl or trifluoromethyl,
R⁵ is with particular preference C₁-C₆-alkoxy or C₁-C₆-alkylthio,
R⁶ is with particular preference hydrogen, C₁-C₆-alkyl, C₃-C₆-cycloalkyl, C₁-C₆-alkoxy, C₃-C₆-alkenyl, C₁-C₆-alkoxy-C₁-C₄-alkyl, is phenyl optionally substituted once by fluorine, chlorine, bromine, trifluoromethyl, C₁-C₄-alkyl or C₁-C₄-alkoxy, or is benzyl optionally substituted once by fluorine, chlorine, bromine, C₁-C₄-alkyl, trifluoromethyl or C₁-C₄-alkoxy,
R⁷ is with particular preference C₁-C₆-alkyl, C₃-C₆-alkenyl or C₁-C₆-alkoxy-C₁-C₄-alkyl,
R⁶ and R⁷ together are with particular preference an optionally methyl- or ethyl-substituted C₄-C₅-alkylene radical in which optionally one methylene group is replaced by oxygen or sulphur.

In the radical definitions qualified by “with particular preference” halogen or halo is fluorine, chlorine and bromine, especially fluorine and chlorine.
W is with very particular preference hydrogen, methyl, chlorine, bromine, ethyl, methoxy, ethoxy or trifluoromethyl,
X is with very particular preference chlorine, bromine, iodine, methyl, ethyl, propyl, methoxy, ethoxy, propoxy, methoxy-ethoxy, ethoxy-ethoxy, trifluoromethyl, difluoromethoxy, trifluoromethoxy or cyano,
Y is with very particular preference in position 4 hydrogen, chlorine, bromine, iodine, trifluoromethyl or trifluoromethoxy,
Z is with very particular preference hydrogen.
W is with very particular preference also hydrogen, chlorine, bromine, methyl or ethyl,
X is with very particular preference also chlorine, bromine, methyl, ethyl, propyl, methoxy, trifluoromethyl, difluoromethoxy, trifluoromethoxy or cyano,
Y is with very particular preference also in position 4 the radical

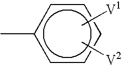

Z is with very particular preference also hydrogen,
V¹ is with very particular preference also fluorine, chlorine, methyl, methoxy, trifluoromethyl, trifluoromethoxy or cyano,
V² is with very particular preference also hydrogen, fluorine, chlorine, methyl, methoxy or trifluoromethyl.
W is with very particular preference likewise hydrogen, chlorine or methyl,
X is with very particular preference likewise chlorine, methyl, trifluoromethyl, methoxy, difluoromethoxy, trifluoromethoxy or cyano,
Y is with very particular preference likewise in position 5 the radical

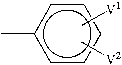

Z is with very particular preference likewise in position 4 hydrogen or methyl,
V¹ is with very particular preference likewise fluorine, chlorine, methyl, methoxy, trifluoromethyl, trifluoromethoxy or cyano,
V² is with very particular preference likewise hydrogen, fluorine, chlorine, methyl, methoxy or trifluoromethyl.
W is moreover with very particular preference hydrogen, methyl, ethyl, methoxy, ethoxy, chlorine or bromine,
X is moreover with very particular preference chlorine, bromine, iodine, methyl, ethyl, propyl, methoxy, ethoxy, propoxy, methoxy-ethoxy, ethoxy-ethoxy, trifluoromethyl, difluoromethoxy, trifluoromethoxy or cyano,
Y is moreover with very particular preference in position 4 methyl or ethyl,
Z is moreover with very particular preference hydrogen.
W is with very particular preference additionally hydrogen, chlorine, bromine, methyl or ethyl,
X is with very particular preference additionally chlorine, bromine, iodine, methyl, ethyl, methoxy, trifluoromethyl, difluoromethoxy or trifluoromethoxy,
Y is with very particular preference additionally in position 4 hydrogen, chlorine, bromine, methyl or ethyl,
Z is with very particular preference additionally in position 3 or 5 fluorine, chlorine, bromine, iodine, methyl, ethyl, trifluoromethyl or trifluoromethoxy.
CKE stands with very particular preference for one of the groups

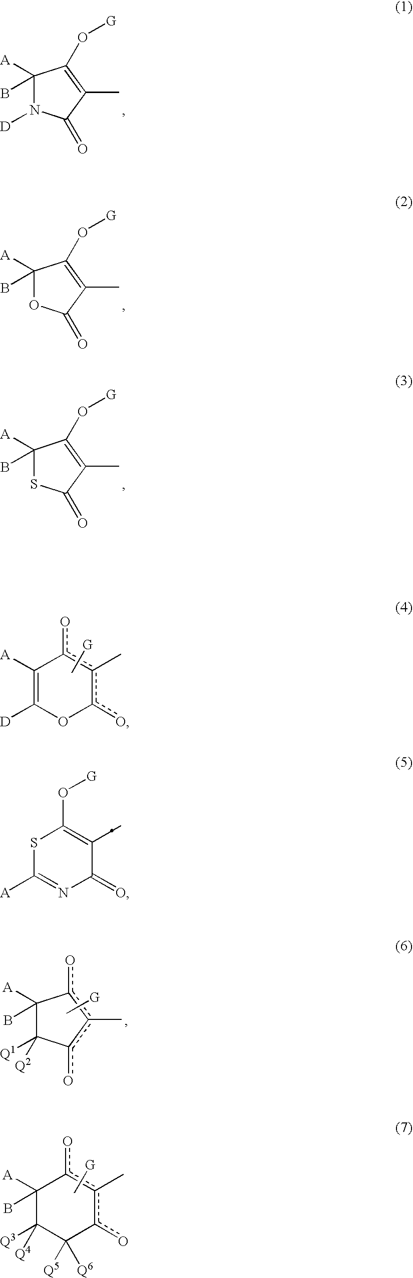

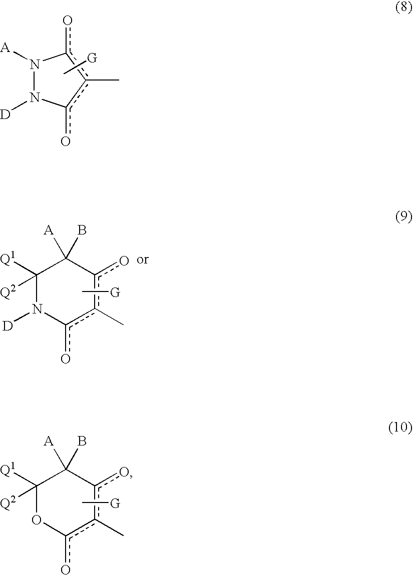

A is with very particular preference hydrogen, in each case optionally mono- to tri-fluorine-substituted C₁-C₄-alkyl, C₁-C₂-alkoxy-C₁-C₂-alkyl, is cyclopropyl, cyclopentyl or cyclohexyl and only in the case of the compounds of the formula (I-5) is phenyl optionally substituted singly to doubly by fluorine, chlorine, bromine, methyl, ethyl, n-propyl, isopropyl, methoxy, ethoxy, trifluoromethyl, trifluoromethoxy, cyano or nitro,
B is with very particular preference hydrogen, methyl or ethyl, or
A, B and the carbon atom to which they are attached are with very particular preference saturated C₅-C₆-cycloalkyl in which optionally one ring member is replaced by oxygen or sulphur and which is optionally substituted once by methyl, ethyl, propyl, isopropyl, methoxymethyl, ethoxymethyl, propoxymethyl, methoxyethyl, ethoxyethyl, trifluoromethyl, methoxy, ethoxy, propoxy, methoxyethoxy, butoxy, ethoxyethoxy or cyclopropylmethoxy, with the proviso that in that case Q³ is with very particular preference hydrogen, or
A, B and the carbon atom to which they are attached are with very particular preference C₆-cycloalkyl which is optionally substituted by an alkylenedioxyl group which contains two oxygen atoms not directly adjacent, with the proviso that in that case Q³ is with very particular preference hydrogen, or
A, B and the carbon atom to which they are attached are with very particular preference C₅-C₆-cycloalkyl or C₅-C₆-cycloalkenyl, in which two substituents, together with the carbon atoms to which they are attached, are C₂-C₄-alkanediyl or C₂-C₄-alkenediyl or butadienediyl, with the proviso that in that case Q³ is with very particular preference hydrogen,
D is with very particular preference hydrogen, is in each case optionally mono- to tri-fluoro-substituted C₁-C₄-alkyl, C₃-C₄-alkenyl, C₁-C₄-alkoxy-C₂-C₃-alkyl, is cyclopropyl, cyclopentyl or cyclohexyl or (but not in the case of the compounds of the formulae (I-1)) is pyridyl or phenyl in each case optionally substituted once by fluorine, chlorine, methyl, ethyl, n-propyl, isopropyl, methoxy, ethoxy or trifluoromethyl,
or
A and D together are with very particular preference C₃-C₅-alkanediyl which is optionally substituted once by methyl or methoxy and in which optionally one carbon atom is replaced by oxygen or sulphur, or is the group AD-1, or
A and Q¹ are together with very particular preference C₃-C₄-alkanediyl optionally substituted singly to doubly by methyl or methoxy, or
D and Q¹ are together with very particular preference C₃-C₄-alkanediyl, or
Q¹ is with very particular preference hydrogen, methyl, ethyl, propyl, isopropyl, cyclopropyl, cyclopentyl or cyclohexyl,
Q² is with very particular preference hydrogen, methyl or ethyl,
Q⁴, Q⁵ and Q⁶ are with very particular preference independently of one another hydrogen or methyl,
Q³ is with very particular preference hydrogen, methyl, ethyl or propyl, or
Q³ and Q⁴, are with very particular preference, together with the carbon to which they are attached, an optionally mono-methyl- or -methoxy-substituted saturated C₅-C₆ ring, with the proviso that in that case A is with very particular preference hydrogen,
G is with very particular preference hydrogen (a) or is one of the groups

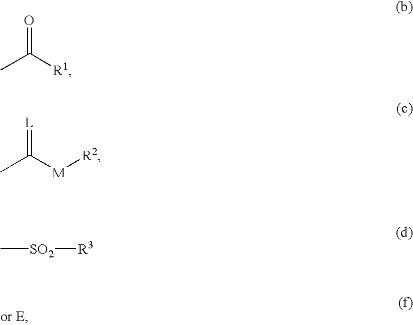

in which
L is oxygen or sulphur,
M is oxygen or sulphur and
E is an ammonium ion,
R¹ is with very particular preference in each case optionally mono-chloro-substituted C₁-C₆-alkyl, C₂-C₁₇-alkenyl, C₁-C₂-alkoxy-C₁-alkyl, C₁-C₂-alkylthio-C₁-alkyl or in each case optionally mono-fluorine-, -chlorine-, -methyl- or -methoxy-substituted cyclopropyl or cyclohexyl,
   is phenyl optionally substituted once by fluorine, chlorine, bromine, cyano, nitro, methyl, methoxy, trifluoromethyl or trifluoromethoxy,
R² is with very particular preference in each case optionally mono-fluoro-substituted C₁-C₈-alkyl, C₂-C₆-alkenyl or C₁-C₄-alkoxy-C₂-C₃-alkyl, phenyl or benzyl,
R³ is with very particular preference C₁-C₈-alkyl.

Specifically mention may be made, apart from the compounds specified in the examples, of the following compounds:

TABLE 1

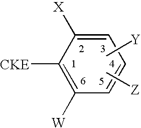

| X | W | Y | Z |
|---|---|---|---|
| CH₃ | H | H | H |
| Br | H | H | H |
| Cl | H | H | H |
| CF₃ | H | H | H |
| OCH₃ | H | H | H |
| Br | H | 4-Cl | H |
| Cl | H | 4-Br | H |
| Cl | H | 4-Cl | H |
| Cl | H | 4-CH₃ | H |
| CH₃ | H | 4-Cl | H |
| CH₃ | H | 4-CH₃ | H |
| Cl | Cl | H | H |
| Cl | OCH₃ | H | H |
| Cl | CH₃ | H | H |
| Cl | OC₂H₅ | H | H |
| OCH₃ | OCH₃ | H | H |
| CH₃ | CH₃ | H | H |
| Br | CH₃ | 4-Br | H |
| Cl | Cl | 4-CH₃ | H |
| CH₃ | Br | 4-CH₃ | H |
| CH₃ | Cl | 4-CH₃ | H |
| OCH₃ | CH₃ | 4-CH₃ | H |
| OC₂H₅ | CH₃ | 4-CH₃ | H |
| OC₃H₇ | CH₃ | 4-CH₃ | H |
| CH₃ | CH₃ | 4-CH₃ | H |
| Br | Br | 4-CH₃ | H |
| CH₃ | CH₃ | 4-Br | H |
| C₂H₅ | CH₃ | H | H |
| C₂H₅ | C₂H₅ | H | H |
| OCH₃ | C₂H₅ | 4-CH₃ | H |
| CH₃ | CH₃ | 4-OCH₃ | H |
| Br | Cl | 4-CH₃ | H |
| Br | CH₃ | 4-Cl | H |
| Cl | CH₃ | 4-Br | H |
| CH₃ | CH₃ | 4-Cl | H |
| C₂H₅ | CH₃ | 4-CH₃ | H |
| C₂H₅ | CH₃ | 4-C₂H₅ | H |
| C₂H₅ | C₂H₅ | 4-CH₃ | H |
| C₂H₅ | C₂H₅ | 4-C₂H₅ | H |
| C₂H₅ | CH₃ | 4-Cl | H |
| C₂H₅ | C₂H₅ | 4-Cl | H |
| C₂H₅ | CH₃ | 4-Br | H |
| C₂H₅ | C₂H₅ | 4-Br | H |
| C₂H₅ | Cl | 4-CH₃ | H |
| C₂H₅ | Br | 4-CH₃ | H |
| C₂H₅ | Cl | 4-Cl | H |
| C₂H₅ | Br | 4-Br | H |
| C₂H₅ | Cl | 4-Br | H |
| C₂H₅ | Br | 4-Cl | H |
| OCH₃ | CH₃ | 4-Cl | H |
| OCH₃ | C₂H₅ | 4-Cl | H |
| OC₂H₅ | CH₃ | 4-Cl | H |
| OC₂H₅ | C₂H₅ | 4-Cl | H |
| Cl | OCH₃ | 4-CH₃ | H |
| Cl | OC₂H₅ | 4-CH₃ | H |
| Cl | Cl | 4-Cl | H |
| Cl | H | 4-Cl | 5-Cl |
| CH₃ | H | 4-CH₃ | 5-CH₃ |
| CH₃ | H | 4-Cl | 5-CH₃ |
| Br | H | 4-Cl | 5-CH₃ |
| Br | H | 4-CH₃ | 5-CH₃ |
| Cl | H | 4-Br | 5-CH₃ |
| Cl | H | 4-Cl | 5-CH₃ |
| CH₃ | H | 4-Br | 5-CH₃ |
| Cl | H | 4-CH₃ | 5-Cl |
| CH₃ | H | H | 5-CH₃ |
| Cl | H | H | 5-CH₃ |
| Br | H | H | 5-CH₃ |
| CH₃ | H | H | 5-Cl |
| CH₃ | H | H | 5-Br |
| CH₃ | CH₃ | 4-CH₃ | 5-CH₃ |
| CH₃ | CH₃ | 4-CH₃ | 5-Cl |
| CH₃ | CH₃ | 4-CH₃ | 5-Br |
| CH₃ | CH₃ | H | 3-Cl |
| CH₃ | CH₃ | H | 3-Br |
| Cl | Cl | H | 3-Br |
| CH₃ | CH₃ | 4-(4-Cl—C₆H₄) | H |
| C₂H₅ | CH₃ | 4-(4-Cl—C₆H₄) | H |
| C₂H₅ | C₂H₅ | 4-(4-Cl—C₆H₄) | H |
| Cl | CH₃ | 4-(4-Cl—C₆H₄) | H |
| Cl | C₂H₅ | 4-(4-Cl—C₆H₄) | H |
| CH₃ | H | 5-(4-Cl—C₆H₄) | H |
| CH₃ | CH₃ | 5-(4-Cl—C₆H₄) | H |
| CH₃ | H | 5-(4-C1—C₆H₄) | 4-CH₃ |
| CH₃ | CH₃ | 5-(4-Cl—C₆H₄) | 4-CH₃ |
| Cl | H | 5-(4-Cl—C₆H₄) | H |
| I | H | H | H |
| I | H | 4-CH₃ | H |
| I | CH₃ | H | H |
| I | C₂H₅ | H | H |
| CH₃ | H | H | 5-I |
| CH₃ | H | 4-CH₃ | 5-I |
| I | CH₃ | 4-CH₃ | H |
| I | C₂H₅ | 4-CH₃ | H |
| I | CH₃ | 4-Cl | H |
| I | C₂H₅ | 4-Cl | H |
| I | Cl | 4-CH₃ | H |
| I | H | 4-CH₃ | 5-CH₃ |
| CH₃ | H | 4-I | H |
| C₂H₅ | H | 4-I | H |
| CH₃ | CH₃ | 4-I | H |
| C₂H₅ | CH₃ | 4-I | H |
| C₂H₅ | C₂H₅ | 4-I | H |
| Cl | CH₃ | 4-I | H |
| Cl | C₂H₅ | 4-I | H |
| CH₃ | H | 4-I | 5-CH₃ |
| CH₃ | CH₃ | H | 3-I |
| I | H | H | 5-CH₃ |

Compounds suitable with particular preference as active ingredients of the invention are compounds having the radical combinations specified in Table 1 for W, X, Y and Z and the radical combinations specified in Tables 2a and 2b for A, B and D.

TABLE 2a

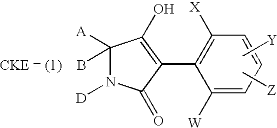

| A | B | D |
|---|---|---|
| CH₃ | H | H |
| C₂H₅ | H | H |
| C₃H₇ | H | H |
| i-C₃H₇ | H | H |
| C₄H₉ | H | H |
| i-C₄H₉ | H | H |
| s-C₄H₉ | H | H |
| t-C₄H₉ | H | H |
| CH₃ | CH₃ | H |
| C₂H₅ | CH₃ | H |
| C₃H₇ | CH₃ | H |
| i-C₃H₇ | CH₃ | H |
| C₄H₉ | CH₃ | H |
| i-C₄H₉ | CH₃ | H |
| s-C₄H₉ | CH₃ | H |
| t-C₄H₉ | CH₃ | H |
| C₂H₅ | C₂H₅ | H |
| C₃H₇ | C₃H₇ | H |
| 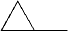 | CH₃ | H |
| 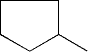 | CH₃ | H |
| 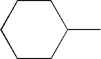 | CH₃ | H |

| | |
|---|---|
| —(CH₂)₂— | H |
| —(CH₂)₄— | H |
| —(CH₂)₅— | H |
| —(CH₂)₆— | H |
| —(CH₂)₇— | H |
| —(CH₂)₂—O—(CH₂)₂— | H |
| —CH₂—O—(CH₂)₃— | H |
| —(CH₂)₂—S—(CH₂)₂— | H |
| —CH₂—CHCH₃—(CH₂)₃— | H |
| —CH₂—CHOCH₃—(CH₂)₂— | H |
| —CH₂—CHOC₂H₅—(CH₂)₂— | H |
| —CH₂—CHOC₃H₇—(CH₂)₂— | H |
| —CH₂—CHOC₄H₉—(CH₂)₂— | H |
| —CH₂—CHO(CH₂)₂OCH₃—(CH₂)₂— | H |
| 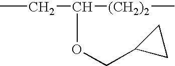 | H |
| —CH₂—CHOCH₃—(CH₂)₃— | H |
| —CH₂—CHOC₂H₅—(CH₂)₃— | H |
| —CH₂—CHOC₃H₇—(CH₂)₃— | H |
| —CH₂—CHOC₄H₉—(CH₂)₃— | H |
| —CH₂—CHO(CH₂)₂OCH₃—(CH₂)₃— | H |
| 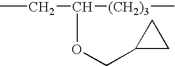 | H |
| —(CH₂)₂—CHCH₃—(CH₂)₂— | H |
| —(CH₂)₂—CHC₂H₅—(CH₂)₂— | H |
| —(CH₂)₂—CHC₃H₇—(CH₂)₂— | H |
| —(CH₂)₂—CHi-C₃H₇—(CH₂)₂— | H |
| —(CH₂)₂—CHOCH₃—(CH₂)₂— | H |
| —(CH₂)₂—CHOC₂H₅—(CH₂)₂— | H |
| —(CH₂)₂—CHOC₃H₇—(CH₂)₂— | H |
| —(CH₂)₂—CHO-i-C₃H₇—(CH₂)₂— | H |
| —(CH₂)₂—C(CH₃)₂—(CH₂)₂— | H |
| —CH₂—(CHCH₃)₂—(CH₂)₂— | H |
| 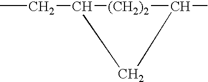 | H |
| 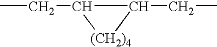 | H |
| 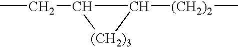 | H |
| 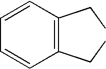 | H |
| 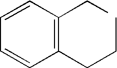 | H |
| 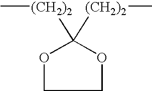 | H |
| 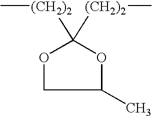 | H |
| 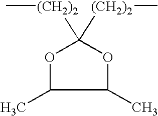 | H |
| 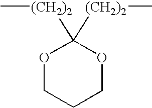 | H |
| 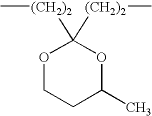 | H |
| 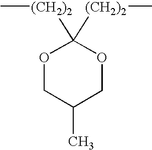 | H |
| 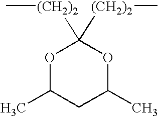 | H |
| 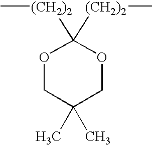 | H |
| 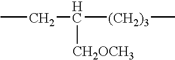 | H |
| 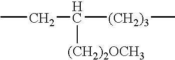 | H |
| 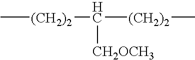 | H |
| 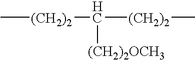 | H |
| 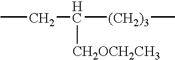 | H |
| 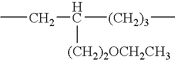 | H |
| 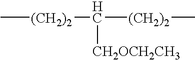 | H |
| 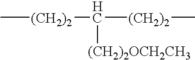 | H |

TABLE 2b

| A | D | B |
|---|---|---|
| —(CH₂)₃— | | H |
| —(CH₂)₄— | | H |
| —CH₂—CHCH₃—CH₂— | | H |
| —CH₂—CH₂—CHCH₃— | | H |
| —CH₂—CHCH₃—CHCH₃— | | H |
| —CH₂—CH(OCH₃)—CH₂— | | H |
| —CH₂—CH═CH—CH₂— | | H |
| 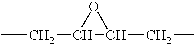 | | H |
| —CH₂—S—CH₂— | | H |
| —CH₂—S—(CH₂)₂— | | H |
| —(CH₂)₂—S—CH₂— | | H |
| 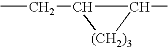 | | H |
| H | CH₃ | H |
| H | C₂H₅ | H |
| H | C₃H₇ | H |
| H | i-C₃H₇ | H |
| H | 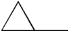 | H |
| H | 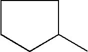 | H |
| H | 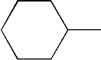 | H |
| CH₃ | CH₃ | H |
| CH₃ | C₂H₅ | H |
| CH₃ | C₃H₇ | H |
| CH₃ | i-C₃H₇ | H |
| CH₃ | 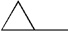 | H |
| CH₃ | 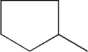 | H |
| CH₃ | 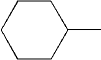 | H |
| C₂H₅ | CH₃ | H |
| C₂H₅ | C₂H₅ | H |

Compounds emphasized as active ingredients are, in particular, preferred compounds having the radical combinations specified in Table 1 for W, X and Y and the radical combinations specified in Tables 2a and 2b for A, B and D, in which W, X and Y represent a phenyl ring substituted in position 2, disubstituted in positions 2, 4 or 2,6, or trisubstituted in positions 2,4,6.

Compounds suitable as active ingredients of the invention are, with particular preference, compounds having the radical combinations specified in Table 1 for W, X, Y and Z and the radical combinations specified in Table 3 for A and B.

TABLE 3

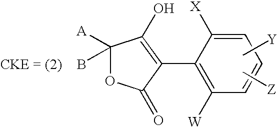

| A | B |
|---|---|
| CH₃ | H |
| C₂H₅ | H |
| C₃H₇ | H |
| i-C₃H₇ | H |
| C₄H₉ | H |
| i-C₄H₉ | H |
| s-C₄H₉ | H |
| t-C₄H₉ | H |
| CH₃ | CH₃ |
| C₂H₅ | CH₃ |
| C₃H₇ | CH₃ |
| i-C₃H₇ | CH₃ |
| C₄H₉ | CH₃ |
| i-C₄H₉ | CH₃ |
| s-C₄H₉ | CH₃ |
| t-C₄H₉ | CH₃ |
| C₂H₅ | C₂H₅ |
| C₃H₇ | C₃H₇ |
| 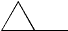 | CH₃ |
| 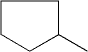 | CH₃ |
| 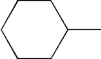 | CH₃ |

—(CH₂)₂—
—(CH₂)₄—
—(CH₂)₅—
—(CH₂)₆—
—(CH₂)₇—
—(CH₂)₂—O—(CH₂)₂—
—CH₂—O—(CH₂)₃—
—(CH₂)₂—S—(CH₂)₂—
—CH₂—CHCH₃—(CH₂)₃—
—CH₂—CHOCH₃—(CH₂)₃—
—CH₂—CHOC₂H₅—(CH₂)₃—
—CH₂—CHOC₃H₇—(CH₂)₃—
—CH₂—CHOC₄H₉—(CH₂)₃—
—CH₂—CHO(CH₂)₂OCH₃—(CH₂)₃—
—(CH₂)₂—CHCH₃—(CH₂)₂—
—(CH₂)₂—CHC₂H₅—(CH₂)₂—
—(CH₂)₂—CHC₃H₇—(CH₂)₂—
—(CH₂)₂—CHi-C₃H₇—(CH₂)₂—
—(CH₂)₂—CHOCH₃—(CH₂)₂—
—(CH₂)₂—CHOC₂H₅—(CH₂)₂—
—(CH₂)₂—CHOC₃H₇—(CH₂)₂—
—(CH₂)₂—CHO-i-C₃H₇—(CH₂)₂—
—(CH₂)₂—C(CH₃)₂—(CH₂)₂—
—CH₂—(CHCH₃)₂—(CH₂)₂—

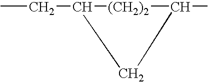

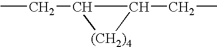

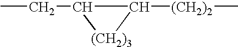

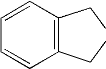

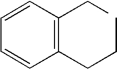

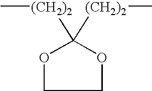

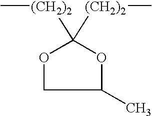

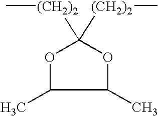

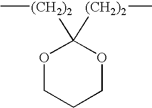

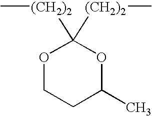

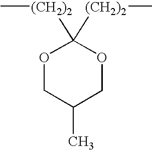

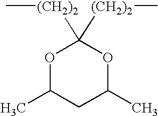

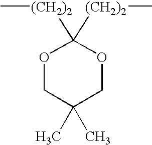

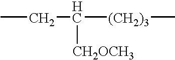

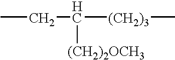

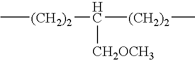

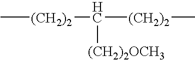

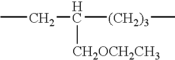

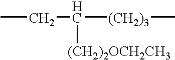

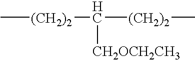

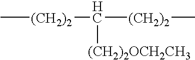

Compounds emphasized as active ingredients are, in particular, preferred compounds having the radical combinations specified in Table 1 for W, X and Y and the radical combinations specified in Table 3 for A and B, in which W, X and Y represent a phenyl ring substituted in position 2, disubstituted in positions 2, 4 or 2,6 or trisubstituted in positions 2,4,6.

Emphasis may be given to the following compounds:

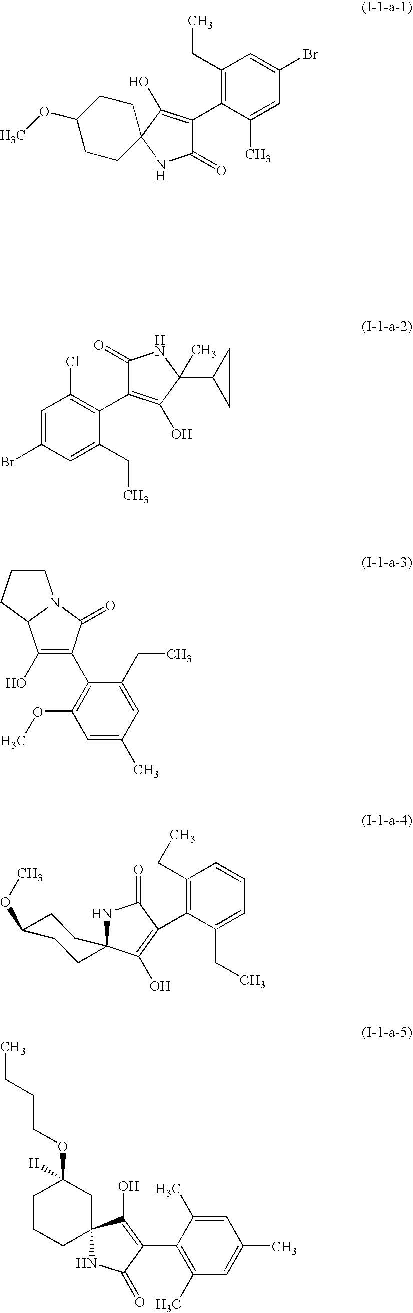

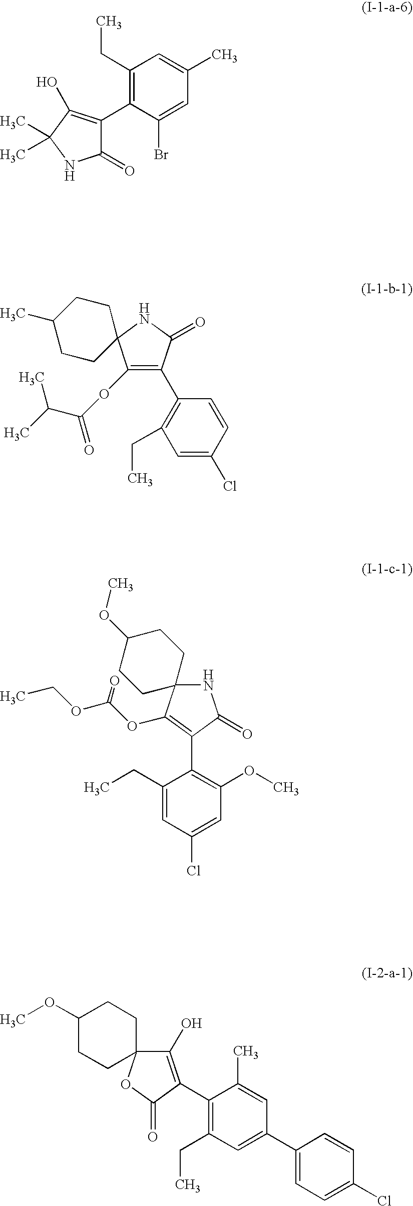

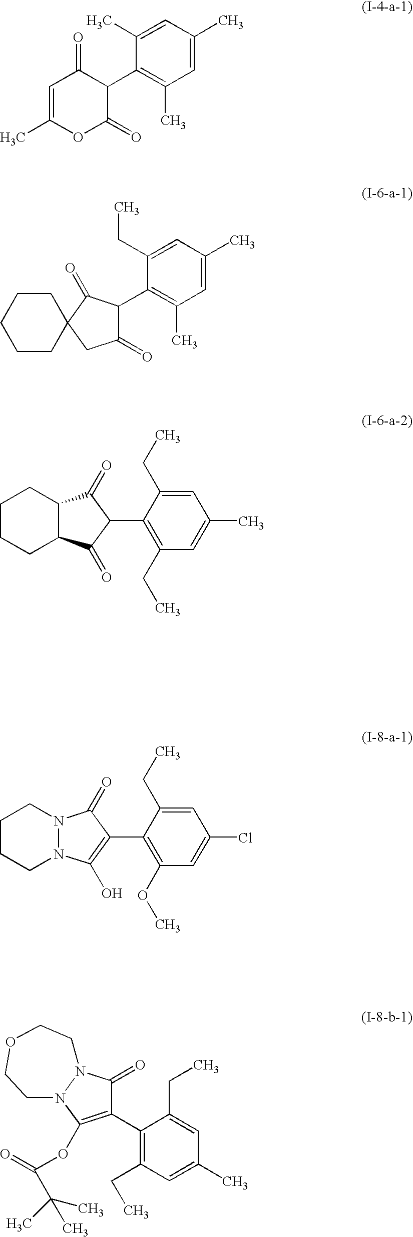

The compounds of the formula (I) possess a herbicidal activity, but individually the activity and/or tolerance leaves something to be desired.

The active ingredients can be used in the compositions of the invention in a broad concentration range. The concentration of the active ingredients in the formulation is typically 0.1%-50% by weight.

Ammonium salts and phosphonium salts which inventively boost the activity of crop protection materials comprising fatty acid biosynthesis inhibitors are defined by formula (II)

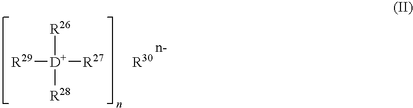

in which
D is nitrogen or phosphorus,
D is preferably nitrogen,
R²⁶, R²⁷, R²⁸ and R²⁹ independently of one another are hydrogen or in each case optionally substituted C₁-C₈-alkyl or singly or multiply unsaturated, optionally substituted C₁-C₈-alkylene, the substituents being selectable from halogen, nitro and cyano,
R²⁶, R²⁷, R²⁸ and R²⁹ are preferably independently of one another hydrogen or in each case optionally substituted C₁-C₄-alkyl, the substituents being selectable from halogen, nitro and cyano,
R²⁶, R²⁷, R²⁸ and R²⁹ are with particular preference independently of one another hydrogen, methyl, ethyl, n-propyl, isopropyl, n-butyl, isobutyl, sec-butyl or tert-butyl,
R²⁶, R²⁷, R²¹ and R²⁹ with very particular preference are hydrogen,
R²⁶, R²⁷, R²⁸ and R²⁹, additionally, with very particular preference simultaneously are methyl or simultaneously are ethyl,
n is 1, 2, 3 or 4,
n preferably is 1 or 2,
R³⁰ is an organic or inorganic anion,
R³⁰ preferably is hydrogencarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate,
R³⁰ additionally preferably is carbonate, pentaborate, sulphite, benzoate, hydrogenoxalate, hydrogencitrate, methylsulphate or tetrafluoroborate,
R³⁰ with particular preference is lactate, sulphate, nitrate, thiosulphate, thiocyanate, citrate, oxalate or formate,
R³⁰ moreover with particular preference is acetate, monohydrogenphosphate or dihydrogenphosphate, and
R³⁰ with very particular preference is sulphate, thiocyanate, dihydrogenphosphate or monohydrogenphosphate.

The ammonium salts and phosphonium salts of the formula (II) can be used in a broad concentration range to boost the activity of crop protection materials comprising ketoenols. In general the ammonium salts or phosphonium salts are used in the application-ready crop protection material in a concentration of 0.5 to 80 mmol/l, preferably 0.75 to 37.5 mmol/l, more preferably 1.5 to 25 mmol/l. In the case of the formulated product the ammonium salt and/or phosphonium salt concentration in the formulation is chosen such that it is within these stated general, preferred or particularly preferred ranges after the formulation has been diluted to the desired active-ingredient concentration. The concentration of the salt in the formulation is typically 1%-50% by weight.

In one preferred embodiment of the invention the activity is boosted by adding to the crop protection materials not only an ammonium salt and/or phosphonium salt but also, additionally, a penetrant. It is considered entirely surprising that even in these cases an even greater boost to activity is observed. The present invention therefore likewise provides for the use of a combination of penetrant and ammonium salts and/or phosphonium salts to boost the activity crop protection materials which comprise herbicidally active phenyl-substituted cyclic ketoenols as active ingredient. The invention likewise provides materials which comprise herbicidally active phenyl-substituted cyclic ketoenols, penetrants and ammonium salts and/or phosphonium salts, including specifically not only formulated active ingredients but also application-ready materials (spray liquors). The invention additionally provides, finally, for the use of these materials for controlling unwanted plant growth.

Suitable penetrants in the present context include all those substances which are typically used to enhance the penetration of active agrochemical ingredients into plants. Penetrants are defined in this context by their ability to penetrate from the aqueous spray liquor and/or from the spray coating into the cuticle of the plant and thereby to increase the mobility of active ingredients in the cuticle. The method described in the literature (Baur et al., 1997, Pesticide Science 51, 131-152) can be used in order to determine this property.

Examples of suitable penetrants include alkanol alkoxylates. Penetrants of the invention are alkanol alkoxylates of the formula

R—O-(-AO)ᵥ—R′ (III)

in which
R is linear or branched alkyl having 4 to 20 carbon atoms,
R′ is hydrogen, methyl, ethyl, n-propyl, isopropyl, n-butyl, isobutyl, tert-butyl, n-pentyl or n-hexyl,
AO is an ethylene oxide radical, a propylene oxide radical, a butylene oxide radical or is mixtures of ethylene oxide and propylene oxide radicals or butylene oxide radicals, and
v is a number from 2 to 30.

Alkanol alkoxylates of the kind in which R′ is hydrogen are referred to as “open” alkanol alkoxylates. One preferred group of penetrants are alkanol alkoxylates of the formula

R—O-(-EO—)ₙ—R′ (III-a)

in which
R is as defined above,
R′ is as defined above,
EO is —CH₂—CH₂—O—, and
n is a number from 2 to 20.

A further preferred group of penetrants are alkanol alkoxylates of the formula

R—O-(-EO—)ₚ—(—PO—)_{q}—R′ (III-b)

in which
R is as defined above,
R′ is as defined above,
EO is —CH₂—CH₂—O—,
PO is

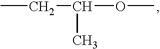

p is a number from 1 to 10, and
q is a number from 1 to 10.

A further preferred group of penetrants are alkanol alkoxylates of the formula

R—O—(—PO—)ᵣ-(EO—)ₛ—R′ (III-c)

in which
R is as defined above,
R′ is as defined above,
EO is —CH₂—CH₂—O—,
PO is

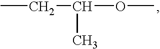

r is a number from 1 to 10, and
s is a number from 1 to 10.

A further preferred group of penetrants are alkanol alkoxylates of the formula

R—O-(-EO—)ₚ—(—BO—)_{q}—R′ (III-d)

in which
R and R′ are as defined above,
EO is CH₂—CH₂—O—,

BO is

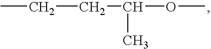

p is a number from 1 to 10 and
q is a number from 1 to 10.

A further preferred group of penetrants are alkanol alkoxylates of the formula

R—O—(—BO—)ᵣ-(-EO—)ₛ—R′ (III-e)

in which
R and R′ are as defined above,
BO is

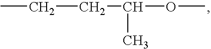

EO is CH₂—CH₂—O—,
r is a number from 1 to 10 and
s is a number from 1 to 10.

A further preferred group of penetrants are alkanol alkoxylates of the formula

CH₃—(CH₂)ₜ—CH₂—O—(—CH₂—CH₂—O—)ᵤ—R′ (III-f)

in which
R′ is as defined above,
t is a number from 8 to 13,
u is a number from 6 to 17.

In the formulae indicated above,
R is preferably butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl.

As an example of an alkanol alkoxylate of the formula (III-c) mention may be made of 2-ethylhexyl alkoxylate of the formula

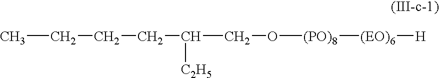

in which
EO is —CH₂—CH₂—O—,
PO is

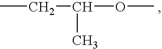

and
the numbers 8 and 6 represent average values.

As an example of an alkanol alkoxylate of the formula (III-d) mention may be made of the formula

CH₃—(CH₂)₁₀—O-(-EO—)₆—(—BO—)₂—CH₃ (III-d-1)

in which
EO is CH₂—CH₂—O—,
BO is

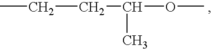

and
the numbers 10, 6 and 2 represent average values.

Particularly preferred alkanol alkoxylates of the formula (III-f) are compounds of this formula in which
t is a number from 9 to 12 and
u is a number from 7 to 9.

Mention may be made with very particular preference of alkanol alkoxylate of the formula (III-f-1)

CH₃—(CH₂)ₜ—CH₂—O—(—CH₂—CH₂—O—)ᵤ—H (III-f-1)

in which
t stands for the average value 10.5 and
u stands for the average value 8.4.

A general definition of the alkanol alkoxylates is given by the formulae above. These substances are mixtures of substances of the stated type with different chain lengths. The indices therefore have average values which may also deviate from whole numbers.

The alkanol alkoxylates of the formulae stated are known and in some cases are available commercially or can be prepared by known methods (cf. WO 98-35 553, WO 00-35 278 and EP-A 0 681 865).

Suitable penetrants also include, for example, substances which promote the availability of the compounds of the formula (I) in the spray coating. These include, for example, mineral or vegetable oils. Suitable oils are all mineral or vegetable oils—modified or otherwise—which can typically be used in agrochemical compositions. Mention may be made by way of example of sunflower oil, rapeseed oil, olive oil, castor oil, colza oil, maize seed oil, cotton seed oil and soybean oil, or the esters of said oils. Preference is given to rapeseed oil, sunflower oil and their methyl or ethyl esters.

The concentration of penetrant in the materials of the invention can be varied within a wide range. In the case of a formulated crop protection material it is in general 1% to 95%, preferably 1% to 55%, more preferably 15%-40% by weight. In the application-ready materials (spray liquors) the concentrations are generally between 0.1 and 10 g/l, preferably between 0.5 and 5 g/l.

Inventively emphasized combinations of active ingredient, salt and penetrant are listed in the table below. “as per test” means here that any compound that acts as a penetrant in the cuticle penetration test (Baur et al., 1997, Pesticide Science 51, 131-152) is suitable.

| | Active | | |
|---|---|---|---|
| # | ingredient | Salt | Penetrant |
| 1 | (I-1-a-1) | ammonium sulphate | as per test |
| 2 | (I-1-a-1) | ammonium lactate | as per test |
| 3 | (I-1-a-1) | ammonium nitrate | as per test |
| 4 | (I-1-a-1) | ammonium thiosulphate | as per test |
| 5 | (I-1-a-1) | ammonium thiocyanate | as per test |
| 6 | (I-1-a-1) | ammonium citrate | as per test |
| 7 | (I-1-a-1) | ammonium oxalate | as per test |
| 8 | (I-1-a-1) | ammonium formate | as per test |
| 9 | (I-1-a-1) | ammonium hydrogenphosphate | as per test |
| 10 | (I-1-a-1) | ammonium dihydrogenphosphate | as per test |
| 11 | (I-1-a-1) | ammonium carbonate | as per test |
| 12 | (I-1-a-1) | ammonium benzoate | as per test |
| 13 | (I-1-a-1) | ammonium sulphite | as per test |
| 14 | (I-1-a-1) | ammonium benzoate | as per test |
| 15 | (I-1-a-1) | ammonium hydrogenoxalate | as per test |
| 16 | (I-1-a-1) | ammonium hydrogencitrate | as per test |
| 17 | (I-1-a-1) | ammonium acetate | as per test |
| 18 | (I-1-a-1) | tetramethylammonium sulphate | as per test |
| 19 | (I-1-a-1) | tetramethylammonium lactate | as per test |
| 20 | (I-1-a-1) | tetramethylammonium nitrate | as per test |
| 21 | (I-1-a-1) | tetramethylammonium thiosulphate | as per test |
| 22 | (I-1-a-1) | tetramethylammonium thiocyanate | as per test |
| 23 | (I-1-a-1) | tetramethylammonium citrate | as per test |
| 24 | (I-1-a-1) | tetramethylammonium oxalate | as per test |
| 25 | (I-1-a-1) | tetramethylammonium formate | as per test |
| 26 | (I-1-a-1) | tetramethylammonium hydrogenphosphate | as per test |
| 27 | (I-1-a-1) | tetramethylammonium | as per test |
| | | dihydrogenphosphate | |
| 28 | (I-1-a-1) | tetraethylammonium sulphate | as per test |
| 29 | (I-1-a-1) | tetraethylammonium lactate | as per test |
| 30 | (I-1-a-1) | tetraethylammonium nitrate | as per test |
| 31 | (I-1-a-1) | tetraethylammonium thiosulphate | as per test |
| 32 | (I-1-a-1) | tetraethylammonium thiocyanate | as per test |
| 33 | (I-1-a-1) | tetraethylammonium citrate | as per test |
| 34 | (I-1-a-1) | tetraethylammonium oxalate | as per test |
| 35 | (I-1-a-1) | tetraethylammonium formate | as per test |
| 36 | (I-1-a-1) | tetraethylammonium hydrogenphosphate | as per test |
| 37 | (I-1-a-1) | tetraethylammonium dihydrogenphosphate | as per test |
| 38 | (I-1-a-2) | ammonium sulphate | as per test |
| 39 | (I-1-a-2) | ammonium lactate | as per test |
| 40 | (I-1-a-2) | ammonium nitrate | as per test |
| 41 | (I-1-a-2) | ammonium thiosulphate | as per test |
| 42 | (I-1-a-2) | ammonium thiocyanate | as per test |
| 43 | (I-1-a-2) | ammonium citrate | as per test |
| 44 | (I-1-a-2) | ammonium oxalate | as per test |
| 45 | (I-1-a-2) | ammonium formate | as per test |
| 46 | (I-1-a-2) | ammonium hydrogenphosphate | as per test |
| 47 | (I-1-a-2) | ammonium dihydrogenphosphate | as per test |
| 48 | (I-1-a-2) | ammonium carbonate | as per test |
| 49 | (I-1-a-2) | ammonium benzoate | as per test |
| 50 | (I-1-a-2) | ammonium sulphite | as per test |
| 51 | (I-1-a-2) | ammonium benzoate | as per test |
| 52 | (I-1-a-2) | ammonium hydrogenoxalate | as per test |
| 53 | (I-1-a-2) | ammonium hydrogencitrate | as per test |
| 54 | (I-1-a-2) | ammonium acetate | as per test |
| 55 | (I-1-a-2) | tetramethylammonium sulphate | as per test |
| 56 | (I-1-a-2) | tetramethylammonium lactate | as per test |
| 57 | (I-1-a-2) | tetramethylammonium nitrate | as per test |
| 58 | (I-1-a-2) | tetramethylammonium thiosulphate | as per test |
| 59 | (I-1-a-2) | tetramethylammonium thiocyanate | as per test |
| 60 | (I-1-a-2) | tetramethylammonium citrate | as per test |
| 61 | (I-1-a-2) | tetramethylammonium oxalate | as per test |
| 62 | (I-1-a-2) | tetramethylammonium formate | as per test |
| 63 | (I-1-a-2) | tetramethylammonium hydrogenphosphate | as per test |
| 64 | (I-1-a-2) | tetramethylammonium | as per test |
| | | dihydrogenphosphate | |
| 65 | (I-1-a-2) | tetraethylammonium sulphate | as per test |
| 66 | (I-1-a-2) | tetraethylammonium lactate | as per test |
| 67 | (I-1-a-2) | tetraethylammonium nitrate | as per test |
| 68 | (I-1-a-2) | tetraethylammonium thiosulphate | as per test |
| 69 | (I-1-a-2) | tetraethylammonium thiocyanate | as per test |
| 70 | (I-1-a-2) | tetraethylammonium citrate | as per test |
| 71 | (I-1-a-2) | tetraethylammonium oxalate | as per test |
| 72 | (I-1-a-2) | tetraethylammonium formate | as per test |
| 73 | (I-1-a-2) | tetraethylammonium hydrogenphosphate | as per test |
| 74 | (I-1-a-2) | tetraethylammonium dihydrogenphosphate | as per test |
| 75 | (I-1-a-3) | ammonium sulphate | as per test |
| 76 | (I-1-a-3) | ammonium lactate | as per test |
| 77 | (I-1-a-3) | ammonium nitrate | as per test |
| 78 | (I-1-a-3) | ammonium thiosulphate | as per test |
| 79 | (I-1-a-3) | ammonium thiocyanate | as per test |
| 80 | (I-1-a-3) | ammonium citrate | as per test |
| 81 | (I-1-a-3) | ammonium oxalate | as per test |
| 82 | (I-1-a-3) | ammonium formate | as per test |
| 83 | (I-1-a-3) | ammonium hydrogenphosphate | as per test |
| 84 | (I-1-a-3) | ammonium dihydrogenphosphate | as per test |
| 85 | (I-1-a-3) | ammonium carbonate | as per test |
| 86 | (I-1-a-3) | ammonium benzoate | as per test |
| 87 | (I-1-a-3) | ammonium sulphite | as per test |
| 88 | (I-1-a-3) | ammonium benzoate | as per test |
| 89 | (I-1-a-3) | ammonium hydrogenoxalate | as per test |
| 90 | (I-1-a-3) | ammonium hydrogencitrate | as per test |
| 91 | (I-1-a-3) | ammonium acetate | as per test |
| 92 | (I-1-a-3) | tetramethylammonium sulphate | as per test |
| 93 | (I-1-a-3) | tetramethylammonium lactate | as per test |
| 94 | (I-1-a-3) | tetramethylammonium nitrate | as per test |
| 95 | (I-1-a-3) | tetramethylammonium thiosulphate | as per test |
| 96 | (I-1-a-3) | tetramethylammonium thiocyanate | as per test |
| 97 | (I-1-a-3) | tetramethylammonium citrate | as per test |
| 98 | (I-1-a-3) | tetramethylammonium oxalate | as per test |
| 99 | (I-1-a-3) | tetramethylammonium formate | as per test |
| 100 | (I-1-a-3) | tetramethylammonium hydrogenphosphate | as per test |
| 101 | (I-1-a-3) | tetramethylammonium | as per test |
| | | dihydrogenphosphate | |
| 102 | (I-1-a-3) | tetraethylammonium sulphate | as per test |
| 103 | (I-1-a-3) | tetraethylammonium lactate | as per test |
| 104 | (I-1-a-3) | tetraethylammonium nitrate | as per test |
| 105 | (I-1-a-3) | tetraethylammonium thiosulphate | as per test |
| 106 | (I-1-a-3) | tetraethylammonium thiocyanate | as per test |
| 107 | (I-1-a-3) | tetraethylammonium citrate | as per test |
| 108 | (I-1-a-3) | tetraethylammonium oxalate | as per test |
| 109 | (I-1-a-3) | tetraethylammonium formate | as per test |
| 110 | (I-1-a-3) | tetraethylammonium hydrogenphosphate | as per test |
| 111 | (I-1-a-3) | tetraethylammonium dihydrogenphosphate | as per test |
| 112 | (I-1-a-4) | ammonium sulphate | as per test |
| 113 | (I-1-a-4) | ammonium lactate | as per test |
| 114 | (I-1-a-4) | ammonium nitrate | as per test |
| 115 | (I-1-a-4) | ammonium thiosulphate | as per test |
| 116 | (I-1-a-4) | ammonium thiocyanate | as per test |
| 117 | (I-1-a-4) | ammonium citrate | as per test |
| 118 | (I-1-a-4) | ammonium oxalate | as per test |
| 119 | (I-1-a-4) | ammonium formate | as per test |
| 120 | (I-1-a-4) | ammonium hydrogenphosphate | as per test |
| 121 | (I-1-a-4) | ammonium dihydrogenphosphate | as per test |
| 122 | (I-1-a-4) | ammonium carbonate | as per test |
| 123 | (I-1-a-4) | ammonium benzoate | as per test |
| 124 | (I-1-a-4) | ammonium sulphite | as per test |
| 125 | (I-1-a-4) | ammonium benzoate | as per test |
| 126 | (I-1-a-4) | ammonium hydrogenoxalate | as per test |
| 127 | (I-1-a-4) | ammonium hydrogencitrate | as per test |
| 128 | (I-1-a-4) | ammonium acetate | as per test |
| 129 | (I-1-a-4) | tetramethylammonium sulphate | as per test |
| 130 | (I-1-a-4) | tetramethylammonium lactate | as per test |
| 131 | (I-1-a-4) | tetramethylammonium nitrate | as per test |
| 132 | (I-1-a-4) | tetramethylammonium thiosulphate | as per test |
| 133 | (I-1-a-4) | tetramethylammonium thiocyanate | as per test |
| 134 | (I-1-a-4) | tetramethylammonium citrate | as per test |
| 135 | (I-1-a-4) | tetramethylammonium oxalate | as per test |
| 136 | (I-1-a-4) | tetramethylammonium formate | as per test |
| 137 | (I-1-a-4) | tetramethylammonium hydrogenphosphate | as per test |
| 138 | (I-1-a-4) | tetramethylammonium | as per test |
| | | dihydrogenphosphate | |
| 139 | (I-1-a-4) | tetraethylammonium sulphate | as per test |
| 140 | (I-1-a-4) | tetraethylammonium lactate | as per test |
| 141 | (I-1-a-4) | tetraethylammonium nitrate | as per test |
| 142 | (I-1-a-4) | tetraethylammonium thiosulphate | as per test |
| 143 | (I-1-a-4) | tetraethylammonium thiocyanate | as per test |
| 144 | (I-1-a-4) | tetraethylammonium citrate | as per test |
| 145 | (I-1-a-4) | tetraethylammonium oxalate | as per test |
| 146 | (I-1-a-4) | tetraethylammonium formate | as per test |
| 147 | (I-1-a-4) | tetraethylammonium hydrogenphosphate | as per test |
| 148 | (I-1-a-4) | tetraethylammonium dihydrogenphosphate | as per test |
| 149 | (I-1-a-5) | ammonium sulphate | as per test |
| 150 | (I-1-a-5) | ammonium lactate | as per test |
| 151 | (I-1-a-5) | ammonium nitrate | as per test |
| 152 | (I-1-a-5) | ammonium thiosulphate | as per test |
| 153 | (I-1-a-5) | ammonium thiocyanate | as per test |
| 154 | (I-1-a-5) | ammonium citrate | as per test |
| 155 | (I-1-a-5) | ammonium oxalate | as per test |
| 156 | (I-1-a-5) | ammonium formate | as per test |
| 157 | (I-1-a-5) | ammonium hydrogenphosphate | as per test |
| 158 | (I-1-a-5) | ammonium dihydrogenphosphate | as per test |
| 159 | (I-1-a-5) | ammonium carbonate | as per test |
| 160 | (I-1-a-5) | ammonium benzoate | as per test |
| 161 | (I-1-a-5) | ammonium sulphite | as per test |
| 162 | (I-1-a-5) | ammonium benzoate | as per test |
| 163 | (I-1-a-5) | ammonium hydrogenoxalate | as per test |
| 164 | (I-1-a-5) | ammonium hydrogencitrate | as per test |
| 165 | (I-1-a-5) | ammonium acetate | as per test |
| 166 | (I-1-a-5) | tetramethylammonium sulphate | as per test |
| 167 | (I-1-a-5) | tetramethylammonium lactate | as per test |
| 168 | (I-1-a-5) | tetramethylammonium nitrate | as per test |
| 169 | (I-1-a-5) | tetramethylammonium thiosulphate | as per test |
| 170 | (I-1-a-5) | tetramethylammonium thiocyanate | as per test |
| 171 | (I-1-a-5) | tetramethylammonium citrate | as per test |
| 172 | (I-1-a-5) | tetramethylammonium oxalate | as per test |
| 173 | (I-1-a-5) | tetramethylammonium formate | as per test |
| 174 | (I-1-a-5) | tetramethylammonium hydrogenphosphate | as per test |
| 175 | (I-1-a-5) | tetramethylammonium | as per test |
| | | dihydrogenphosphate | |
| 176 | (I-1-a-5) | tetraethylammonium sulphate | as per test |
| 177 | (I-1-a-5) | tetraethylammonium lactate | as per test |
| 178 | (I-1-a-5) | tetraethylammonium nitrate | as per test |
| 179 | (I-1-a-5) | tetraethylammonium thiosulphate | as per test |
| 180 | (I-1-a-5) | tetraethylammonium thiocyanate | as per test |
| 181 | (I-1-a-5) | tetraethylammonium citrate | as per test |
| 182 | (I-1-a-5) | tetraethylammonium oxalate | as per test |
| 183 | (I-1-a-5) | tetraethylammonium formate | as per test |
| 184 | (I-1-a-5) | tetraethylammonium hydrogenphosphate | as per test |
| 185 | (I-1-a-5) | tetraethylammonium dihydrogenphosphate | as per test |
| 186 | (I-1-a-6) | ammonium sulphate | as per test |
| 187 | (I-1-a-6) | ammonium lactate | as per test |
| 188 | (I-1-a-6) | ammonium nitrate | as per test |
| 189 | (I-1-a-6) | ammonium thiosulphate | as per test |
| 190 | (I-1-a-6) | ammonium thiocyanate | as per test |
| 191 | (I-1-a-6) | ammonium citrate | as per test |
| 192 | (I-1-a-6) | ammonium oxalate | as per test |
| 193 | (I-1-a-6) | ammonium formate | as per test |
| 194 | (I-1-a-6) | ammonium hydrogenphosphate | as per test |
| 195 | (I-1-a-6) | ammonium dihydrogenphosphate | as per test |
| 196 | (I-1-a-6) | ammonium carbonate | as per test |
| 197 | (I-1-a-6) | ammonium benzoate | as per test |
| 198 | (I-1-a-6) | ammonium sulphite | as per test |
| 199 | (I-1-a-6) | ammonium benzoate | as per test |
| 200 | (I-1-a-6) | ammonium hydrogenoxalate | as per test |
| 201 | (I-1-a-6) | ammonium hydrogencitrate | as per test |
| 202 | (I-1-a-6) | ammonium acetate | as per test |
| 203 | (I-1-a-6) | tetramethylammonium sulphate | as per test |
| 204 | (I-1-a-6) | tetramethylammonium lactate | as per test |
| 205 | (I-1-a-6) | tetramethylammonium nitrate | as per test |
| 206 | (I-1-a-6) | tetramethylammonium thiosulphate | as per test |
| 207 | (I-1-a-6) | tetramethylammonium thiocyanate | as per test |
| 208 | (I-1-a-6) | tetramethylammonium citrate | as per test |
| 209 | (I-1-a-6) | tetramethylammonium oxalate | as per test |
| 210 | (I-1-a-6) | tetramethylammonium formate | as per test |
| 211 | (I-1-a-6) | tetramethylammonium hydrogenphosphate | as per test |
| 212 | (I-1-a-6) | tetramethylammonium | as per test |
| | | dihydrogenphosphate | |
| 213 | (I-1-a-6) | tetraethylammonium sulphate | as per test |
| 214 | (I-1-a-6) | tetraethylammonium lactate | as per test |
| 215 | (I-1-a-6) | tetraethylammonium nitrate | as per test |
| 216 | (I-1-a-6) | tetraethylammonium thiosulphate | as per test |
| 217 | (I-1-a-6) | tetraethylammonium thiocyanate | as per test |
| 218 | (I-1-a-6) | tetraethylammonium citrate | as per test |
| 219 | (I-1-a-6) | tetraethylammonium oxalate | as per test |
| 220 | (I-1-a-6) | tetraethylammonium formate | as per test |
| 221 | (I-1-a-6) | tetraethylammonium hydrogenphosphate | as per test |
| 222 | (I-1-a-6) | tetraethylammonium dihydrogenphosphate | as per test |
| 223 | (I-1-b-1) | ammonium sulphate | as per test |
| 224 | (I-1-b-1) | ammonium lactate | as per test |
| 225 | (I-1-b-1) | ammonium nitrate | as per test |
| 226 | (I-1-b-1) | ammonium thiosulphate | as per test |
| 227 | (I-1-b-1) | ammonium thiocyanate | as per test |
| 228 | (I-1-b-1) | ammonium citrate | as per test |
| 229 | (I-1-b-1) | ammonium oxalate | as per test |
| 230 | (I-1-b-1) | ammonium formate | as per test |
| 231 | (I-1-b-1) | ammonium hydrogenphosphate | as per test |
| 232 | (I-1-b-1) | ammonium dihydrogenphosphate | as per test |
| 233 | (I-1-b-1) | ammonium carbonate | as per test |
| 234 | (I-1-b-1) | ammonium benzoate | as per test |
| 235 | (I-1-b-1) | ammonium sulphite | as per test |
| 236 | (I-1-b-1) | ammonium benzoate | as per test |
| 237 | (I-1-b-1) | ammonium hydrogenoxalate | as per test |
| 238 | (I-1-b-1) | ammonium hydrogencitrate | as per test |
| 239 | (I-1-b-1) | ammonium acetate | as per test |
| 240 | (I-1-b-1) | tetramethylammonium sulphate | as per test |
| 241 | (I-1-b-1) | tetramethylammonium lactate | as per test |
| 242 | (I-1-b-1) | tetramethylammonium nitrate | as per test |
| 243 | (I-1-b-1) | tetramethylammonium thiosulphate | as per test |
| 244 | (I-1-b-1) | tetramethylammonium thiocyanate | as per test |
| 245 | (I-1-b-1) | tetramethylammonium citrate | as per test |
| 246 | (I-1-b-1) | tetramethylammonium oxalate | as per test |
| 247 | (I-1-b-1) | tetramethylammonium formate | as per test |
| 248 | (I-1-b-1) | tetramethylammonium hydrogenphosphate | as per test |
| 249 | (I-1-b-1) | tetramethylammonium | as per test |
| | | dihydrogenphosphate | |
| 250 | (I-1-b-1) | tetraethylammonium sulphate | as per test |
| 251 | (I-1-b-1) | tetraethylammonium lactate | as per test |
| 252 | (I-1-b-1) | tetraethylammonium nitrate | as per test |
| 253 | (I-1-b-1) | tetraethylammonium thiosulphate | as per test |
| 254 | (I-1-b-1) | tetraethylammonium thiocyanate | as per test |
| 255 | (I-1-b-1) | tetraethylammonium citrate | as per test |
| 256 | (I-1-b-1) | tetraethylammonium oxalate | as per test |
| 257 | (I-1-b-1) | tetraethylammonium formate | as per test |
| 258 | (I-1-b-1) | tetraethylammonium hydrogenphosphate | as per test |
| 259 | (I-1-b-1) | tetraethylammonium dihydrogenphosphate | as per test |
| 260 | (I-1-c-1) | ammonium sulphate | as per test |
| 261 | (I-1-c-1) | ammonium lactate | as per test |
| 262 | (I-1-c-1) | ammonium nitrate | as per test |
| 263 | (I-1-c-1) | ammonium thiosulphate | as per test |
| 264 | (I-1-c-1) | ammonium thiocyanate | as per test |
| 265 | (I-1-c-1) | ammonium citrate | as per test |
| 266 | (I-1-c-1) | ammonium oxalate | as per test |
| 267 | (I-1-c-1) | ammonium formate | as per test |
| 268 | (I-1-c-1) | ammonium hydrogenphosphate | as per test |
| 269 | (I-1-c-1) | ammonium dihydrogenphosphate | as per test |
| 270 | (I-1-c-1) | ammonium carbonate | as per test |
| 271 | (I-1-c-1) | ammonium benzoate | as per test |
| 272 | (I-1-c-1) | ammonium sulphite | as per test |
| 273 | (I-1-c-1) | ammonium benzoate | as per test |
| 274 | (I-1-c-1) | ammonium hydrogenoxalate | as per test |
| 275 | (I-1-c-1) | ammonium hydrogencitrate | as per test |
| 276 | (I-1-c-1) | ammonium acetate | as per test |
| 277 | (I-1-c-1) | tetramethylammonium sulphate | as per test |
| 278 | (I-1-c-1) | tetramethylammonium lactate | as per test |
| 279 | (I-1-c-1) | tetramethylammonium nitrate | as per test |
| 280 | (I-1-c-1) | tetramethylammonium thiosulphate | as per test |
| 281 | (I-1-c-1) | tetramethylammonium thiocyanate | as per test |
| 282 | (I-1-c-1) | tetramethylammonium citrate | as per test |
| 283 | (I-1-c-1) | tetramethylammonium oxalate | as per test |
| 284 | (I-1-c-1) | tetramethylammonium formate | as per test |
| 285 | (I-1-c-1) | tetramethylammonium hydrogenphosphate | as per test |
| 286 | (I-1-c-1) | tetramethylammonium | as per test |
| | | dihydrogenphosphate | |
| 287 | (I-1-c-1) | tetraethylammonium sulphate | as per test |
| 288 | (I-1-c-1) | tetraethylammonium lactate | as per test |
| 289 | (I-1-c-1) | tetraethylammonium nitrate | as per test |
| 290 | (I-1-c-1) | tetraethylammonium thiosulphate | as per test |
| 291 | (I-1-c-1) | tetraethylammonium thiocyanate | as per test |
| 292 | (I-1-c-1) | tetraethylammonium citrate | as per test |
| 293 | (I-1-c-1) | tetraethylammonium oxalate | as per test |
| 294 | (I-1-c-1) | tetraethylammonium formate | as per test |
| 295 | (I-1-c-1) | tetraethylammonium hydrogenphosphate | as per test |
| 296 | (I-1-c-1) | tetraethylammonium dihydrogenphosphate | as per test |
| 297 | (I-2-a-1) | ammonium sulphate | as per test |
| 298 | (I-2-a-1) | ammonium lactate | as per test |
| 299 | (I-2-a-1) | ammonium nitrate | as per test |
| 300 | (I-2-a-1) | ammonium thiosulphate | as per test |
| 301 | (I-2-a-1) | ammonium thiocyanate | as per test |
| 302 | (I-2-a-1) | ammonium citrate | as per test |
| 303 | (I-2-a-1) | ammonium oxalate | as per test |
| 304 | (I-2-a-1) | ammonium formate | as per test |
| 305 | (I-2-a-1) | ammonium hydrogenphosphate | as per test |
| 306 | (I-2-a-1) | ammonium dihydrogenphosphate | as per test |
| 307 | (I-2-a-1) | ammonium carbonate | as per test |
| 308 | (I-2-a-1) | ammonium benzoate | as per test |
| 309 | (I-2-a-1) | ammonium sulphite | as per test |
| 310 | (I-2-a-1) | ammonium benzoate | as per test |
| 311 | (I-2-a-1) | ammonium hydrogenoxalate | as per test |
| 312 | (I-2-a-1) | ammonium hydrogencitrate | as per test |
| 313 | (I-2-a-1) | ammonium acetate | as per test |
| 314 | (I-2-a-1) | tetramethylammonium sulphate | as per test |
| 315 | (I-2-a-1) | tetramethylammonium lactate | as per test |
| 316 | (I-2-a-1) | tetramethylammonium nitrate | as per test |
| 317 | (I-2-a-1) | tetramethylammonium thiosulphate | as per test |
| 318 | (I-2-a-1) | tetramethylammonium thiocyanate | as per test |
| 319 | (I-2-a-1) | tetramethylammonium citrate | as per test |
| 320 | (I-2-a-1) | tetramethylammonium oxalate | as per test |
| 321 | (I-2-a-1) | tetramethylammonium formate | as per test |
| 322 | (I-2-a-1) | tetramethylammonium hydrogenphosphate | as per test |
| 323 | (I-2-a-1) | tetramethylammonium | as per test |
| | | dihydrogenphosphate | |
| 324 | (I-2-a-1) | tetraethylammonium sulphate | as per test |
| 325 | (I-2-a-1) | tetraethylammonium lactate | as per test |
| 326 | (I-2-a-1) | tetraethylammonium nitrate | as per test |
| 327 | (I-2-a-1) | tetraethylammonium thiosulphate | as per test |
| 328 | (I-2-a-1) | tetraethylammonium thiocyanate | as per test |
| 329 | (I-2-a-1) | tetraethylammonium citrate | as per test |
| 330 | (I-2-a-1) | tetraethylammonium oxalate | as per test |
| 331 | (I-2-a-1) | tetraethylammonium formate | as per test |
| 332 | (I-2-a-1) | tetraethylammonium hydrogenphosphate | as per test |
| 333 | (I-2-a-1) | tetraethylammonium dihydrogenphosphate | as per test |
| 334 | (I-4-a-1) | ammonium sulphate | as per test |
| 335 | (I-4-a-1) | ammonium lactate | as per test |
| 336 | (I-4-a-1) | ammonium nitrate | as per test |
| 337 | (I-4-a-1) | ammonium thiosulphate | as per test |
| 338 | (I-4-a-1) | ammonium thiocyanate | as per test |
| 339 | (I-4-a-1) | ammonium citrate | as per test |
| 340 | (I-4-a-1) | ammonium oxalate | as per test |
| 341 | (I-4-a-1) | ammonium formate | as per test |
| 342 | (I-4-a-1) | ammonium hydrogenphosphate | as per test |
| 343 | (I-4-a-1) | ammonium dihydrogenphosphate | as per test |
| 344 | (I-4-a-1) | ammonium carbonate | as per test |
| 345 | (I-4-a-1) | ammonium benzoate | as per test |
| 346 | (I-4-a-1) | ammonium sulphite | as per test |
| 347 | (I-4-a-1) | ammonium benzoate | as per test |
| 348 | (I-4-a-1) | ammonium hydrogenoxalate | as per test |
| 349 | (I-4-a-1) | ammonium hydrogencitrate | as per test |
| 350 | (I-4-a-1) | ammonium acetate | as per test |
| 351 | (I-4-a-1) | tetramethylammonium sulphate | as per test |
| 352 | (I-4-a-1) | tetramethylammonium lactate | as per test |
| 353 | (I-4-a-1) | tetramethylammonium nitrate | as per test |
| 354 | (I-4-a-1) | tetramethylammonium thiosulphate | as per test |
| 355 | (I-4-a-1) | tetramethylammonium thiocyanate | as per test |
| 356 | (I-4-a-1) | tetramethylammonium citrate | as per test |
| 357 | (I-4-a-1) | tetramethylammonium oxalate | as per test |
| 358 | (I-4-a-1) | tetramethylammonium formate | as per test |
| 359 | (I-4-a-1) | tetramethylammonium hydrogenphosphate | as per test |
| 360 | (I-4-a-1) | tetramethylammonium | as per test |
| | | dihydrogenphosphate | |
| 361 | (I-4-a-1) | tetraethylammonium sulphate | as per test |
| 362 | (I-4-a-1) | tetraethylammonium lactate | as per test |
| 363 | (I-4-a-1) | tetraethylammonium nitrate | as per test |
| 364 | (I-4-a-1) | tetraethylammonium thiosulphate | as per test |
| 365 | (I-4-a-1) | tetraethylammonium thiocyanate | as per test |
| 366 | (I-4-a-1) | tetraethylammonium citrate | as per test |
| 367 | (I-4-a-1) | tetraethylammonium oxalate | as per test |
| 368 | (I-4-a-1) | tetraethylammonium formate | as per test |
| 369 | (I-4-a-1) | tetraethylammonium hydrogenphosphate | as per test |
| 370 | (I-4-a-1) | tetraethylammonium dihydrogenphosphate | as per test |
| 371 | (I-6-a-1) | ammonium sulphate | as per test |
| 372 | (I-6-a-1) | ammonium lactate | as per test |
| 373 | (I-6-a-1) | ammonium nitrate | as per test |
| 374 | (I-6-a-1) | ammonium thiosulphate | as per test |
| 375 | (I-6-a-1) | ammonium thiocyanate | as per test |
| 376 | (I-6-a-1) | ammonium citrate | as per test |
| 377 | (I-6-a-1) | ammonium oxalate | as per test |
| 378 | (I-6-a-1) | ammonium formate | as per test |
| 379 | (I-6-a-1) | ammonium hydrogenphosphate | as per test |
| 380 | (I-6-a-1) | ammonium dihydrogenphosphate | as per test |
| 381 | (I-6-a-1) | ammonium carbonate | as per test |
| 382 | (I-6-a-1) | ammonium benzoate | as per test |
| 383 | (I-6-a-1) | ammonium sulphite | as per test |
| 384 | (I-6-a-1) | ammonium benzoate | as per test |
| 385 | (I-6-a-1) | ammonium hydrogenoxalate | as per test |
| 386 | (I-6-a-1) | ammonium hydrogencitrate | as per test |
| 387 | (I-6-a-1) | ammonium acetate | as per test |
| 388 | (I-6-a-1) | tetramethylammonium sulphate | as per test |
| 389 | (I-6-a-1) | tetramethylammonium lactate | as per test |
| 390 | (I-6-a-1) | tetramethylammonium nitrate | as per test |
| 391 | (I-6-a-1) | tetramethylammonium thiosulphate | as per test |
| 392 | (I-6-a-1) | tetramethylammonium thiocyanate | as per test |
| 393 | (I-6-a-1) | tetramethylammonium citrate | as per test |
| 394 | (I-6-a-1) | tetramethylammonium oxalate | as per test |
| 395 | (I-6-a-1) | tetramethylammonium formate | as per test |
| 396 | (I-6-a-1) | tetramethylammonium hydrogenphosphate | as per test |
| 397 | (I-6-a-1) | tetramethylammonium | as per test |
| | | dihydrogenphosphate | |
| 398 | (I-6-a-1) | tetraethylammonium sulphate | as per test |
| 399 | (I-6-a-1) | tetraethylammonium lactate | as per test |
| 400 | (I-6-a-1) | tetraethylammonium nitrate | as per test |
| 401 | (I-6-a-1) | tetraethylammonium thiosulphate | as per test |
| 402 | (I-6-a-1) | tetraethylammonium thiocyanate | as per test |
| 403 | (I-6-a-1) | tetraethylammonium citrate | as per test |
| 404 | (I-6-a-1) | tetraethylammonium oxalate | as per test |
| 405 | (I-6-a-1) | tetraethylammonium formate | as per test |
| 406 | (I-6-a-1) | tetraethylammonium hydrogenphosphate | as per test |
| 407 | (I-6-a-1) | tetraethylammonium dihydrogenphosphate | as per test |
| 408 | (I-6-a-2) | ammonium sulphate | as per test |
| 409 | (I-6-a-2) | ammonium lactate | as per test |
| 410 | (I-6-a-2) | ammonium nitrate | as per test |
| 411 | (I-6-a-2) | ammonium thiosulphate | as per test |
| 412 | (I-6-a-2) | ammonium thiocyanate | as per test |
| 413 | (I-6-a-2) | ammonium citrate | as per test |
| 414 | (I-6-a-2) | ammonium oxalate | as per test |
| 415 | (I-6-a-2) | ammonium formate | as per test |
| 416 | (I-6-a-2) | ammonium hydrogenphosphate | as per test |
| 417 | (I-6-a-2) | ammonium dihydrogenphosphate | as per test |
| 418 | (I-6-a-2) | ammonium carbonate | as per test |
| 419 | (I-6-a-2) | ammonium benzoate | as per test |
| 420 | (I-6-a-2) | ammonium sulphite | as per test |
| 421 | (I-6-a-2) | ammonium benzoate | as per test |
| 422 | (I-6-a-2) | ammonium hydrogenoxalate | as per test |
| 423 | (I-6-a-2) | ammonium hydrogencitrate | as per test |
| 424 | (I-6-a-2) | ammonium acetate | as per test |
| 425 | (I-6-a-2) | tetramethylammonium sulphate | as per test |
| 426 | (I-6-a-2) | tetramethylammonium lactate | as per test |
| 427 | (I-6-a-2) | tetramethylammonium nitrate | as per test |
| 428 | (I-6-a-2) | tetramethylammonium thiosulphate | as per test |
| 429 | (I-6-a-2) | tetramethylammonium thiocyanate | as per test |
| 430 | (I-6-a-2) | tetramethylammonium citrate | as per test |
| 431 | (I-6-a-2) | tetramethylammonium oxalate | as per test |
| 432 | (I-6-a-2) | tetramethylammonium formate | as per test |
| 433 | (I-6-a-2) | tetramethylammonium hydrogenphosphate | as per test |
| 434 | (I-6-a-2) | tetramethylammonium | as per test |
| | | dihydrogenphosphate | |
| 435 | (I-6-a-2) | tetraethylammonium sulphate | as per test |
| 436 | (I-6-a-2) | tetraethylammonium lactate | as per test |
| 437 | (I-6-a-2) | tetraethylammonium nitrate | as per test |
| 438 | (I-6-a-2) | tetraethylammonium thiosulphate | as per test |
| 439 | (I-6-a-2) | tetraethylammonium thiocyanate | as per test |
| 440 | (I-6-a-2) | tetraethylammonium citrate | as per test |
| 441 | (I-6-a-2) | tetraethylammonium oxalate | as per test |
| 442 | (I-6-a-2) | tetraethylammonium formate | as per test |
| 443 | (I-6-a-2) | tetraethylammonium hydrogenphosphate | as per test |
| 444 | (I-6-a-2) | tetraethylammonium dihydrogenphosphate | as per test |
| 445 | (I-8-a-1) | ammonium sulphate | as per test |
| 446 | (I-8-a-1) | ammonium lactate | as per test |
| 447 | (I-8-a-1) | ammonium nitrate | as per test |
| 448 | (I-8-a-1) | ammonium thiosulphate | as per test |
| 449 | (I-8-a-1) | ammonium thiocyanate | as per test |
| 450 | (I-8-a-1) | ammonium citrate | as per test |
| 451 | (I-8-a-1) | ammonium oxalate | as per test |
| 452 | (I-8-a-1) | ammonium formate | as per test |
| 453 | (I-8-a-1) | ammonium hydrogenphosphate | as per test |
| 454 | (I-8-a-1) | ammonium dihydrogenphosphate | as per test |
| 455 | (I-8-a-1) | ammonium carbonate | as per test |
| 456 | (I-8-a-1) | ammonium benzoate | as per test |
| 457 | (I-8-a-1) | ammonium sulphite | as per test |
| 458 | (I-8-a-1) | ammonium benzoate | as per test |
| 459 | (I-8-a-1) | ammonium hydrogenoxalate | as per test |
| 460 | (I-8-a-1) | ammonium hydrogencitrate | as per test |
| 461 | (I-8-a-1) | ammonium acetate | as per test |
| 462 | (I-8-a-1) | tetramethylammonium sulphate | as per test |
| 463 | (I-8-a-1) | tetramethylammonium lactate | as per test |
| 464 | (I-8-a-1) | tetramethylammonium nitrate | as per test |
| 465 | (I-8-a-1) | tetramethylammonium thiosulphate | as per test |
| 466 | (I-8-a-1) | tetramethylammonium thiocyanate | as per test |
| 467 | (I-8-a-1) | tetramethylammonium citrate | as per test |
| 468 | (I-8-a-1) | tetramethylammonium oxalate | as per test |
| 469 | (I-8-a-1) | tetramethylammonium formate | as per test |
| 470 | (I-8-a-1) | tetramethylammonium hydrogenphosphate | as per test |
| 471 | (I-8-a-1) | tetramethylammonium | as per test |
| | | dihydrogenphosphate | |
| 472 | (I-8-a-1) | tetraethylammonium sulphate | as per test |
| 473 | (I-8-a-1) | tetraethylammonium lactate | as per test |
| 474 | (I-8-a-1) | tetraethylammonium nitrate | as per test |
| 475 | (I-8-a-1) | tetraethylammonium thiosulphate | as per test |
| 476 | (I-8-a-1) | tetraethylammonium thiocyanate | as per test |
| 477 | (I-8-a-1) | tetraethylammonium citrate | as per test |
| 478 | (I-8-a-1) | tetraethylammonium oxalate | as per test |
| 479 | (I-8-a-1) | tetraethylammonium formate | as per test |
| 480 | (I-8-a-1) | tetraethylammonium hydrogenphosphate | as per test |
| 481 | (I-8-a-1) | tetraethylammonium dihydrogenphosphate | as per test |
| 482 | (I-8-b-1) | ammonium sulphate | as per test |
| 483 | (I-8-b-1) | ammonium lactate | as per test |
| 484 | (I-8-b-1) | ammonium nitrate | as per test |
| 485 | (I-8-b-1) | ammonium thiosulphate | as per test |
| 486 | (I-8-b-1) | ammonium thiocyanate | as per test |
| 487 | (I-8-b-1) | ammonium citrate | as per test |
| 488 | (I-8-b-1) | ammonium oxalate | as per test |
| 489 | (I-8-b-1) | ammonium formate | as per test |
| 490 | (I-8-b-1) | ammonium hydrogenphosphate | as per test |
| 491 | (I-8-b-1) | ammonium dihydrogenphosphate | as per test |
| 492 | (I-8-b-1) | ammonium carbonate | as per test |
| 493 | (I-8-b-1) | ammonium benzoate | as per test |
| 494 | (I-8-b-1) | ammonium sulphite | as per test |
| 495 | (I-8-b-1) | ammonium benzoate | as per test |
| 496 | (I-8-b-1) | ammonium hydrogenoxalate | as per test |
| 497 | (I-8-b-1) | ammonium hydrogencitrate | as per test |
| 498 | (I-8-b-1) | ammonium acetate | as per test |
| 499 | (I-8-b-1) | tetramethylammonium sulphate | as per test |
| 500 | (I-8-b-1) | tetramethylammonium lactate | as per test |
| 501 | (I-8-b-1) | tetramethylammonium nitrate | as per test |
| 502 | (I-8-b-1) | tetramethylammonium thiosulphate | as per test |
| 503 | (I-8-b-1) | tetramethylammonium thiocyanate | as per test |
| 504 | (I-8-b-1) | tetramethylammonium citrate | as per test |
| 505 | (I-8-b-1) | tetramethylammonium oxalate | as per test |
| 506 | (I-8-b-1) | tetramethylammonium formate | as per test |
| 507 | (I-8-b-1) | tetramethylammonium hydrogenphosphate | as per test |
| 508 | (I-8-b-1) | tetramethylammonium | as per test |
| | | dihydrogenphosphate | |
| 509 | (I-8-b-1) | tetraethylammonium sulphate | as per test |
| 510 | (I-8-b-1) | tetraethylammonium lactate | as per test |
| 511 | (I-8-b-1) | tetraethylammonium nitrate | as per test |
| 512 | (I-8-b-1) | tetraethylammonium thiosulphate | as per test |
| 513 | (I-8-b-1) | tetraethylammonium thiocyanate | as per test |
| 514 | (I-8-b-1) | tetraethylammonium citrate | as per test |
| 515 | (I-8-b-1) | tetraethylammonium oxalate | as per test |
| 516 | (I-8-b-1) | tetraethylammonium formate | as per test |
| 517 | (I-8-b-1) | tetraethylammonium hydrogenphosphate | as per test |
| 518 | (I-8-b-1) | tetraethylammonium dihydrogenphosphate | as per test |

Crop protection materials of the invention may also comprise further components, examples being surfactants and/or dispersing assistants or emulsifiers.

Suitable nonionic surfactants and/or dispersing assistants include all substances of this type that can typically be used in agrochemical compositions. Preferably mention may be made of polyethylene oxide-polypropylene oxide block copolymers, polyethylene glycol ethers of linear alcohols, reaction products of fatty acids with ethylene oxide and/or propylene oxide, and also polyvinyl alcohol, polyvinylpyrrolidone, copolymers of polyvinyl alcohol and polyvinylpyrrolidone, and copolymers of (meth)acrylic acid and (meth)acrylic esters, and additionally alkyl ethoxylates and alkylaryl ethoxylates, which optionally may be phosphated and optionally may be neutralized with bases, mention being made, by way of example, of sorbitol ethoxylates, and, as well, polyoxyalkylenamine derivatives.

Suitable anionic surfactants include all substances of this type that can typically be used in agrochemical compositions. Preference is given to alkali metal salts and alkaline earth metal salts of alkylsulphonic acids or alkylarylsulphonic acids.

A further preferred group of anionic surfactants and/or dispersing assistants are the following salts that are of low solubility in plant oil: salts of polystyrenesulphonic acids, salts of polyvinylsulphonic acids, salts of naphthalenesulphonic acid-formaldehyde condensation products, salts of condensation products of naphthalenesulphonic acid, phenolsulphonic acid and formaldehyde, and salts of ligninsulphonic acid.

Suitable additives which may be included in the formulations of the invention are emulsifiers, foam inhibitors, preservatives, antioxidants, colorants and inert filling materials.

Preferred emulsifiers are ethoxylated nonylphenols, reaction products of alkylphenols with ethylene oxide and/or propylene oxide, ethoxylated arylalkylphenols, and also ethoxylated and propoxylated arylalkylphenols, and also sulphated or phosphated arylalkyl ethoxylates and/or arylalkyl ethoxy-propoxylates, mention being made by way of example of sorbitan derivatives, such as polyethylene oxide-sorbitan fatty acid esters, and sorbitan fatty acid esters.

Compositions of the invention may further comprise, as well as at least one compound of the formula (I), at least one further active herbicidal ingredient, preferably from the group consisting of acetochlor, acifluorfen (-sodium), aclonifen, alachlor, alloxydim (-sodium), ametryne, ami-carbazone, amidochlor, amidosulfuron, aminopyralid, anilofos, asulam, atrazine, azafenidin, azimsulfuron, beflubutamid, benazolin (-ethyl), benfuresate, bensulfuron (-methyl), bentazon, bencarbazone, benzfendizone, benzobicyclon, benzofenap, benzoylprop (-ethyl), bialaphos, bifenox, bispyribac (-sodium), bromobutide, bromofenoxim, bromoxynil, butachlor, butafenacil (-allyl), butroxydim, butylate, cafenstrole, caloxydim, carbetamide, carfentrazone (-ethyl), chlomethoxyfen, chloramben, chloridazon, chlorimuron (-ethyl), chlornitrofen, chlorsulfuron, chlortoluron, cinidon (-ethyl), cinmethylin, cinosulfuron, clefoxydim, clethodim, clodinafop (-propargyl), clomazone, clomeprop, clopyralid, clopyrasulfuron (-methyl), cloransulam (-methyl), cumyluron, cyanazine, cybutryne, cycloate, cyclosulfamuron, cycloxydim, cyhalofop (-butyl), 2,4-D, 2,4-DB, desmedipham, diallate, dicamba, dichlorprop (—P), diclofop (-methyl), diclosulam, diethatyl (-ethyl), difenzoquat, diflufenican, diflufenzopyr, dimefuron, dimepiperate, dimethachlor, dimethametryn, dimethenamid, dimexyflam, dinitramine, diphenamid, diquat, dithiopyr, diuron, dymron, epropodan, EPTC, esprocarb, ethalfluralin, ethametsulfuron (-methyl), ethofumesate, ethoxyfen, ethoxysulfuron, etobenzanid, fenoxaprop (—P-ethyl), fentrazamide, flamprop (-isopropyl, -isopropyl-L, -methyl), flazasulfuron, florasulam, fluazifop (—P-butyl), fluazolate, flucarbazone (-sodium), flufenacet, flumetsulam, flumiclorac (-pentyl), flumioxazin, flumipropyn, flumetsulam, fluometuron, fluorochloridone, fluoroglycofen (-ethyl), flupoxam, flupropacil, flurpyrsulfuron (-methyl, -sodium), flurenol (-butyl), fluridone, fluoroxypyr (-butoxypropyl, -meptyl), flurprimidol, flurtamone, fluthiacet (-methyl), fluthiamide, fomesafen, foramsulfuron, glufosinate (-ammonium), glyphosate (-isopropylammonium), halosafen, haloxyfop (-ethoxyethyl, —P-methyl), hexazinone, HOK-201, imazamethabenz (-methyl), imazamethapyr, imazamox, imazapic, imazapyr, imazaquin, imazethapyr, imazosulfuron, iodosulfuron (-methyl, -sodium), ioxynil, isopropalin, isoproturon, isouron, isoxaben, isoxachlortole, isoxaflutole, isoxapyrifop, lactofen, lenacil, linuron, MCPA, mecoprop, mefenacet, mesosulfurone, mesotrione, metamifop, metamitron, metazachlor, methabenzthiazuron, metobenzuron, metobromuron, (alpha-) metolachlor, metosulam, metoxuron, metribuzin, metsulfuron (-methyl), molinate, monolinuron, naproanilide, napropamide, neburon, nicosulfuron, norflurazon, orbencarb, orthosulfamuron, oryzalin, oxadiargyl, oxadiazon, oxasulfuron, oxaziclomefone, oxyfluorfen, paraquat, pelargonic acid, pendimethalin, pendralin, penoxsulam, pentoxazone, phenmedipham, picolinafen, pinoxaden, piperophos, pretilachlor, primisulfuron (-methyl), profluazol, prometryn, propachlor, propanil, propaquizafop, propisochlor, propoxycarbazone (-sodium), propyzamide, prosulfocarb, prosulfuron, pyraflufen (-ethyl), pyrasulfotole, pyrazogyl, pyrazolate, pyrazosulfuron (-ethyl), pyrazoxyfen, pyribenzoxim, pyributicarb, pyridate, pyridatol, pyriftalid, pyriminobac (-methyl), pyrimisulfan, pyrithiobac (-sodium), pyroxasulfone, quinchlorac, quinmerac, quinoclamine, quizalofop (—P-ethyl, —P-tefuryl), rimsulfuron, sethoxydim, simazine, simetryn, sulcotrione, sulfentrazone, sulfometuron (-methyl), sulfosate, sulfosulfuron, tebutam, tebuthiuron, tembotrione, tepraloxydim, terbuthylazine, terbutryn, thenylchlor, thiafluamide, thiazopyr, thidiazimin, thifensulfuron (-methyl), thiobencarb, tiocarbazil, topramezone, tralkoxydim, triallate, triasulfuron, tribenuron (-methyl), triclopyr, tridiphane, trifluralin, trifloxysulfuron, triflusulfuron (-methyl), tritosulfuron and the following four compounds

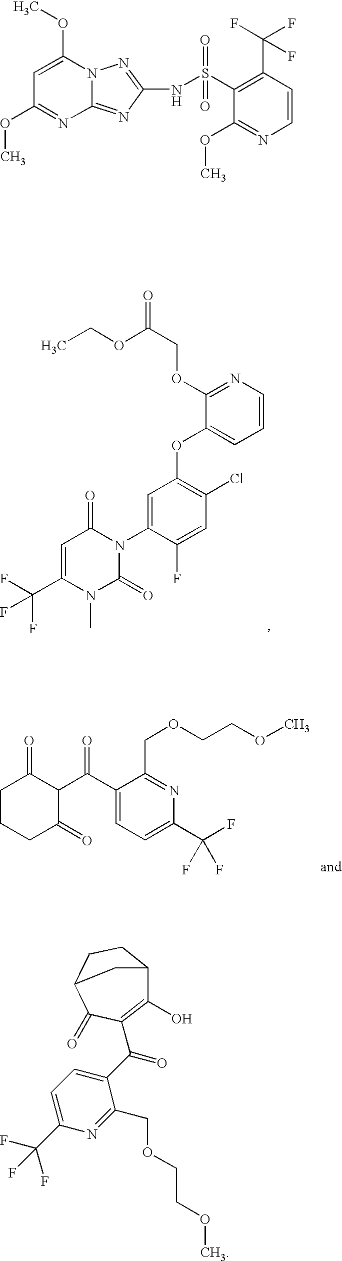

The examples which follow serve to illustrate the invention and should in no way be interpreted as being restrictive.

### Glasshouse Trials on Activity Boost Through Ammonium/Phosphonium Salts

Seeds of monocot and dicot weeds and crop plants are sown in sandy loam soil in wood fibre pots or in plastic pots, and are covered with soil and cultivated under good growth conditions in the glasshouse and also, during the vegetation period, outdoors outside the glasshouse. 2-3 weeks after sowing, the trial plants are treated at the one- to three-leaf stage. The test compounds, formulated as wettable powders (WP) or liquids (EC), are applied by spraying to the plants and the soil surface in various doses, with a water application rate of 300 l/ha (converted) and with the addition of penetrants (0.2% to 0.4%) and where appropriate an ammonium salt. After the trial plants had stood in the glasshouse for about 3 to 4 weeks under optimum growth conditions, the activity of the products was rated visually in comparison to untreated controls (activity in %, i.e. 0%=no activity or as control, 100%=all plants died).

For rapeseed oil methyl ester (RME) the following tables specify concentration in % a.i. by volume for ammonium sulphate (AMS) in g/l in the spray liquor.

### EXAMPLE 1

The following compounds showed an activity boost with ammonium sulphate in a trial in the stated application rates against Setaria viridis (SETVI):

TABLE 1

| Active | Application | | |
|---|---|---|---|
| ingredient | rate/g/ha | Addition | Activity/% |
| I-1-a-1 | 50 | RME (0.25%) | 40 |
| I-1-a-1 | 50 | RME (0.25%) | 50 |
| | | AMS (3.3 g/l) | |
| I-1-a-1 | 25 | RME (0.25%) | 30 |
| I-1-a-1 | 25 | RME (0.25%) | 50 |
| | | AMS (3.3 g/l) | |
| I-1-a-2 | 50 | RME (0.25%) | 50 |
| I-1-a-2 | 50 | RME (0.25%) | 93 |
| | | AMS (3.3 g/l) | |
| I-1-a-2 | 25 | RME (0.25%) | 20 |
| I-1-a-2 | 25 | RME (0.25%) | 90 |
| | | AMS (3.3 g/l) | |
| I-1-a-2 | 12.5 | RME (0.25%) | 5 |
| I-1-a-2 | 12.5 | RME (0.25%) | 60 |
| | | AMS (3.3 g/l) | |
| I-1-a-3 | 100 | RME (0.25%) | 93 |
| I-1-a-3 | 100 | RME (0.25%) | 99 |
| | | AMS (3.3 g/l) | |
| I-1-a-3 | 50 | RME (0.25%) | 93 |
| I-1-a-3 | 50 | RME (0.25%) | 95 |
| | | AMS (3.3 g/l) | |
| I-1-a-3 | 25 | RME (0.25%) | 15 |
| I-1-a-3 | 25 | RME (0.25%) | 70 |
| | | AMS (3.3 g/l) | |
| I-4-a-1 | 100 | RME (0.25%) | 0 |
| I-4-a-1 | 100 | RME (0.25%) | 90 |
| | | AMS (3.3 g/l) | |
| I-4-a-1 | 50 | RME (0.25%) | 0 |
| I-4-a-1 | 50 | RME (0.25%) | 90 |
| | | AMS (3.3 g/l) | |
| I-4-a-1 | 25 | RME (0.25%) | 0 |
| I-4-a-1 | 25 | RME (0.25%) | 20 |
| | | AMS (3.3 g/l) | |
| I-6-a-1 | 50 | RME (0.25%) | 25 |
| I-6-a-1 | 50 | RME (0.25%) | 90 |
| | | AMS (3.3 g/l) | |
| I-6-a-1 | 25 | RME (0.25%) | 15 |
| I-6-a-1 | 25 | RME (0.25%) | 90 |
| | | AMS (3.3 g/l) | |
| I-6-a-1 | 12.5 | RME (0.25%) | 0 |
| I-6-a-1 | 12.5 | RME (0.25%) | 25 |
| | | AMS (3.3 g/l) | |

### EXAMPLE 2

The following compounds exhibited an activity boost in a trial with ammonium sulphate (AMS) against

ALOMY=Alopecurus myosuroides
AVEFA=Avena fatua
LOLMU=Lolium multiflorum
LOLRI=Lolium rigidum

TABLE 2

| Active | Application | | Activity | |
|---|---|---|---|---|
| ingredient | rate/g/ha | Addition | against | Activity/% |
| I-8-a-1 | 25 | RME (0.25%) | ALOMY | 50 |
| I-8-a-1 | 25 | RME (0.25%) | ALOMY | 70 |
| | | AMS (3.3 g/l) | | |
| I-8-a-1 | 12.5 | RME (0.25%) | ALOMY | 5 |
| I-8-a-1 | 12.5 | RME (0.25%) | ALOMY | 50 |
| | | AMS (3.3 g/l) | | |
| I-8-a-1 | 25 | RME (0.25%) | AVEFA | 40 |
| I-8-a-1 | 25 | RME (0.25%) | AVEFA | 80 |
| | | AMS (3.3 g/l) | | |
| I-8-a-1 | 12.5 | RME (0.25%) | AVEFA | 30 |
| I-8-a-1 | 12.5 | RME (0.25%) | AVEFA | 70 |
| | | AMS (3.3 g/l) | | |
| I-8-a-1 | 25 | RME (0.25%) | LOLMU | 80 |
| I-8-a-1 | 25 | RME (0.25%) | LOLMU | 95 |
| | | AMS (3.3 g/l) | | |
| I-8-a-1 | 12.5 | RME (0.25%) | LOLMU | 10 |
| I-8-a-1 | 12.5 | RME (0.25%) | LOLMU | 70 |
| | | AMS (3.3 g/l) | | |
| I-1-a-4 | 50 | RME (0.25%) | ALOMY | 5 |
| I-1-a-4 | 50 | RME (0.25%) | ALOMY | 70 |
| | | AMS (3.3 g/l) | | |
| I-1-a-4 | 25 | RME (0.25%) | ALOMY | 3 |
| I-1-a-4 | 25 | RME (0.25%) | ALOMY | 50 |
| | | AMS (3.3 g/l) | | |
| I-1-a-4 | 50 | RME (0.25%) | AVEFA | 5 |
| I-1-a-4 | 50 | RME (0.25%) | AVEFA | 30 |
| | | AMS (3.3 g/l) | | |
| I-1-a-4 | 25 | RME (0.25%) | AVEFA | 3 |
| I-1-a-4 | 25 | RME (0.25%) | AVEFA | 10 |
| | | AMS (3.3 g/l) | | |
| I-1-a-4 | 50 | RME (0.25%) | LOLMU | 5 |
| I-1-a-4 | 50 | RME (0.25%) | LOLMU | 90 |
| | | AMS (3.3 g/l) | | |
| I-1-a-4 | 25 | RME (0.25%) | LOLMU | 2 |
| I-1-a-4 | 25 | RME (0.25%) | LOLMU | 75 |
| | | AMS (3.3 g/l) | | |
| I-1-b-1 | 50 | RME (0.25%) | ALOMY | 20 |
| I-1-b-1 | 50 | RME (0.25%) | ALOMY | 75 |
| | | AMS (3.3 g/l) | | |
| I-1-b-1 | 25 | RME (0.25%) | ALOMY | 5 |
| I-1-b-1 | 25 | RME (0.25%) | ALOMY | 25 |
| | | AMS (3.3 g/l) | | |
| I-1-b-1 | 50 | RME (0.25%) | AVEFA | 50 |
| I-1-b-1 | 50 | RME (0.25%) | AVEFA | 60 |
| | | AMS (3.3 g/l) | | |
| I-1-b-1 | 25 | RME (0.25%) | AVEFA | 15 |
| I-1-b-1 | 25 | RME (0.25%) | AVEFA | 60 |
| | | AMS (3.3 g/l) | | |
| I-1-b-1 | 50 | RME (0.25%) | LOLMU | 10 |
| I-1-b-1 | 50 | RME (0.25%) | LOLMU | 75 |
| | | AMS (3.3 g/l) | | |
| I-1-b-1 | 25 | RME (0.25%) | LOLMU | 10 |
| I-1-b-1 | 25 | RME (0.25%) | LOLMU | 25 |
| | | AMS (3.3 g/l) | | |
| I-6-a-2 | 25 | RME (0.25%) | ALOMY | 30 |
| I-6-a-2 | 25 | RME (0.25%) | ALOMY | 93 |
| | | AMS (3.3 g/l) | | |
| I-6-a-2 | 12.5 | RME (0.25%) | ALOMY | 10 |
| I-6-a-2 | 12.5 | RME (0.25%) | ALOMY | 75 |
| | | AMS (3.3 g/l) | | |
| I-6-a-2 | 25 | RME (0.25%) | AVEFA | 35 |
| I-6-a-2 | 25 | RME (0.25%) | AVEFA | 99 |
| | | AMS (3.3 g/l) | | |
| I-6-a-2 | 12.5 | RME (0.25%) | AVEFA | 10 |
| I-6-a-2 | 12.5 | RME (0.25%) | AVEFA | 93 |
| | | AMS (3.3 g/l) | | |
| I-6-a-2 | 25 | RME (0.25%) | LOLMU | 20 |
| I-6-a-2 | 25 | RME (0.25%) | LOLMU | 100 |
| | | AMS (3.3 g/l) | | |
| I-6-a-2 | 12.5 | RME (0.25%) | LOLMU | 5 |
| I-6-a-2 | 12.5 | RME (0.25%) | LOLMU | 97 |
| | | AMS (3.3 g/l) | | |
| I-8-b-1 | 50 | RME (0.25%) | ALOMY | 90 |
| I-8-b-1 | 50 | RME (0.25%) | ALOMY | 95 |
| | | AMS (3.3 g/l) | | |
| I-8-b-1 | 25 | RME (0.25%) | ALOMY | 20 |
| I-8-b-1 | 25 | RME (0.25%) | ALOMY | 80 |
| | | AMS (3.3 g/l) | | |
| I-8-b-1 | 50 | RME (0.25%) | AVEFA | 70 |
| I-8-b-1 | 50 | RME (0.25%) | AVEFA | 97 |
| | | AMS (3.3 g/l) | | |
| I-8-b-1 | 25 | RME (0.25%) | AVEFA | 30 |
| I-8-b-1 | 25 | RME (0.25%) | AVEFA | 80 |
| | | AMS (3.3 g/l) | | |
| I-8-b-1 | 50 | RME (0.25%) | LOLMU | 97 |
| I-8-b-1 | 50 | RME (0.25%) | LOLMU | 100 |
| | | AMS (3.3 g/l) | | |
| I-8-b-1 | 25 | RME (0.25%) | LOLMU | 60 |
| I-8-b-1 | 25 | RME (0.25%) | LOLMU | 93 |
| | | AMS (3.3 g/l) | | |
| I-2-a-1 | 100 | RME (0.25%) | ALOMY | 30 |
| I-2-a-1 | 100 | RME (0.25%) | ALOMY | 70 |
| | | AMS (6.6 g/l) | | |
| I-2-a-1 | 50 | RME (0.25%) | ALOMY | 30 |
| I-2-a-1 | 50 | RME (0.25%) | ALOMY | 70 |
| | | AMS (6.6 g/l) | | |
| I-2-a-1 | 50 | RME (0.25%) | LOLMU | 70 |
| I-2-a-1 | 50 | RME (0.25%) | LOLMU | 98 |
| | | AMS (6.6 g/l) | | |
| I-2-a-1 | 25 | RME (0.25%) | LOLMU | 30 |
| I-2-a-1 | 50 | RME (0.25%) | LOLMU | 80 |
| | | AMS (6.6 g/l) | | |
| I-2-a-1 | 50 | RME (0.25%) | LOLRI | 40 |
| I-2-a-1 | 50 | RME (0.25%) | LOLRI | 80 |
| | | AMS (6.6 g/l) | | |
| I-2-a-1 | 25 | RME (0.25%) | LOLRI | 20 |
| I-2-a-1 | 50 | RME (0.25%) | LOLRI | 40 |
| | | AMS (6.6 g/l) | | |

### EXAMPLE 3

The following compounds showed activity boosts in a trial with graduated concentrations of ammonium sulphate:

ALOMY=Alopecurus myosuroides
AVEFA=Avena fatua
LOLMU=Lolium multiflorum
SETVI=Setaria viridis

TABLE 3

| Active | Application | | Activity | |
|---|---|---|---|---|
| ingredient | rate/g/ha | Addition | against | Activity/% |
| I-8-b-1 | 50 | RME (0.25%) | AVEFA | 70 |
| I-8-b-1 | 50 | RME (0.25%) | AVEFA | 90 |
| | | AMS (0.33 g/l) | | |
| I-8-b-1 | 50 | RME (0.25%) | AVEFA | 95 |
| | | AMS (1 g/l) | | |
| I-8-b-1 | 50 | RME (0.25%) | AVEFA | 97 |
| | | AMS (3.3 g/l) | | |
| I-8-b-1 | 25 | RME (0.25%) | ALOMY | 20 |
| I-8-b-1 | 25 | RME (0.25%) | ALOMY | 70 |
| | | AMS (0.33 g/l) | | |
| I-8-b-1 | 25 | RME (0.25%) | ALOMY | 50 |
| | | AMS (1 g/l) | | |
| I-8-b-1 | 25 | RME (0.25%) | ALOMY | 80 |
| | | AMS (3.3 g/l) | | |
| I-1-a-5 | 50 | RME (0.25%) | LOLMU | 5 |
| I-1-a-5 | 50 | RME (0.25%) | LOLMU | 60 |
| | | AMS (0.33 g/l) | | |
| I-1-a-5 | 50 | RME (0.25%) | LOLMU | 93 |
| | | AMS (1 g/l) | | |
| I-1-a-5 | 50 | RME (0.25%) | LOLMU | 95 |
| | | AMS (3.3 g/l) | | |
| I-1-a-5 | 25 | RME (0.25%) | ALOMY | 25 |
| I-1-a-5 | 25 | RME (0.25%) | ALOMY | 50 |
| | | AMS (0.33 g/l) | | |
| I-1-a-5 | 25 | RME (0.25%) | ALOMY | 50 |
| | | AMS (1 g/l) | | |
| I-1-a-5 | 25 | RME (0.25%) | ALOMY | 60 |
| | | AMS (3.3 g/l) | | |
| I-1-a-6 | 12.5 | RME (0.25%) | SETVI | 50 |
| I-1-a-6 | 12.5 | RME (0.25%) | SETVI | 65 |
| | | AMS (0.33 g/l) | | |
| I-1-a-6 | 12.5 | RME (0.25%) | SETVI | 75 |
| | | AMS (1 g/l) | | |
| I-1-a-6 | 12.5 | RME (0.25%) | SETVI | 90 |
| | | AMS (3.3 g/l) | | |
| I-1-a-6 | 50 | RME (0.25%) | LOLMU | 5 |
| I-1-a-6 | 50 | RME (0.25%) | LOLMU | 20 |
| | | AMS (0.33 g/l) | | |
| I-1-a-6 | 50 | RME (0.25%) | LOLMU | 50 |
| | | AMS (1 g/l) | | |
| I-1-a-6 | 50 | RME (0.25%) | LOLMU | 65 |
| | | AMS (3.3 g/l) | | |

### EXAMPLE 4

The compound (I-1-c-1) showed an activity boost in a trial with ammonium sulphate against

ALOMY=Alopecurus myosuroides
AVEFA=Avena fatua
LOLMU=Lolium multiflorum
SETVI=Setaria viridis
BROER=Bromus erectus

TABLE 4

| Active | Application | | Activity | |
|---|---|---|---|---|
| ingredient | rate/g/ha | Addition | against | Activity/% |
| I-1-c-1 | 5 | Genapol LRO | ALOMY | 73 |
| | | (0.33%) | | |
| I-1-c-1 | 5 | Genapol LRO | ALOMY | 99 |
| | | (0.33%) | | |
| | | AMS (3.3 g/l) | | |
| I-1-c-1 | 5 | Genapol LRO | APESV | 93 |
| | | (0.33%) | | |
| I-1-c-1 | 5 | Genapol LRO | APESV | 97 |
| | | (0.33%) | | |
| | | AMS (3.3 g/l) | | |
| I-1-c-1 | 5 | Genapol LRO | AVEFA | 75 |
| | | (0.33%) | | |
| I-1-c-1 | 5 | Genapol LRO | AVEFA | 100 |
| | | (0.33%) | | |
| | | AMS (3.3 g/l) | | |
| I-1-c-1 | 5 | Genapol LRO | BROER | 73 |
| | | (0.33%) | | |
| I-1-c-1 | 5 | Genapol LRO | BROER | 97 |
| | | (0.33%) | | |
| | | AMS (3.3 g/l) | | |
| I-1-c-1 | 5 | Genapol LRO | LOLME | 86 |
| | | (0.33%) | | |
| I-1-c-1 | 5 | Genapol LRO | LOLME | 97 |
| | | (0.33%) | | |
| | | AMS (3.3 g/l) | | |

### EXAMPLE 5

In plots measuring approximately 10 m², in 9 trials, post-emergence treatments were carried out in 2-3 repetitions with compound (I-1-c-1). The weed population was the natural population and/or a sown population specifically geared to the objective. The active ingredient (I-1-c-1) was delivered as an EC formulation at the stated application rates with a penetrant of the formula (III-c-1) at a concentration of 0.3 g/l in 300 l of water, as a tank mix. In the elements of the trial with ammonium sulphate (AMS) the salt was added at 1 g/l to the spray liquor. Evaluation was made on the day of maximum activity. The activities reported in Table 5 are those obtained over the sum of all the trials.

AGRRE=Agropyron repens
ALOMY=Alopecurus myosuroides
AVEFA=Avena fatua

TABLE 5

| Active | Application | | Activity | |
|---|---|---|---|---|
| ingredient | rate/g/ha | Addition | against | Activity/% |
| I-1-c-1 | 5 | (III-c-1) (0.3 g/l) | AGRRE | 80 |
| I-1-c-1 | 5 | (III-c-1) (0.3 g/l) | AGRRE | 90 |
| | | AMS (1 g/l) | | |
| I-1-c-1 | 5 | (III-c-1) (0.3 g/l) | ALOMY | 67 |
| I-1-c-1 | 5 | (III-c-1) (0.3 g/l) | ALOMY | 72 |
| | | AMS (1 g/l) | | |
| I-1-c-1 | 5 | (III-c-1) (0.3 g/l) | AVEFA | 80 |
| I-1-c-1 | 5 | (III-c-1) (0.3 g/l) | AVEFA | 90 |
| | | AMS (1 g/l) | | |

1. Composition comprising
at least one active herbicidal ingredient from the class of the phenyl-substituted cyclic ketoenols of formula (I) 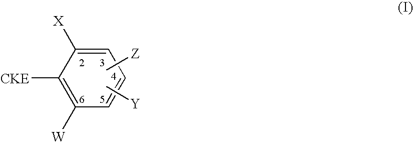
in which
W is hydrogen, alkyl, alkenyl, alkynyl, halogen, alkoxy, haloalkyl, haloalkoxy or cyano,
X is halogen, alkyl, alkenyl, alkynyl, alkoxy, alkoxy-alkoxy, haloalkyl, haloalkoxy or cyano,
Y is hydrogen, halogen, alkyl, alkenyl, alkynyl, alkoxy, cyano, haloalkyl, haloalkoxy or in each case optionally substituted phenyl or hetaryl,
Z is hydrogen, halogen, alkyl, haloalkyl, cyano, alkoxy or haloalkoxy,
CKE is one of the groups 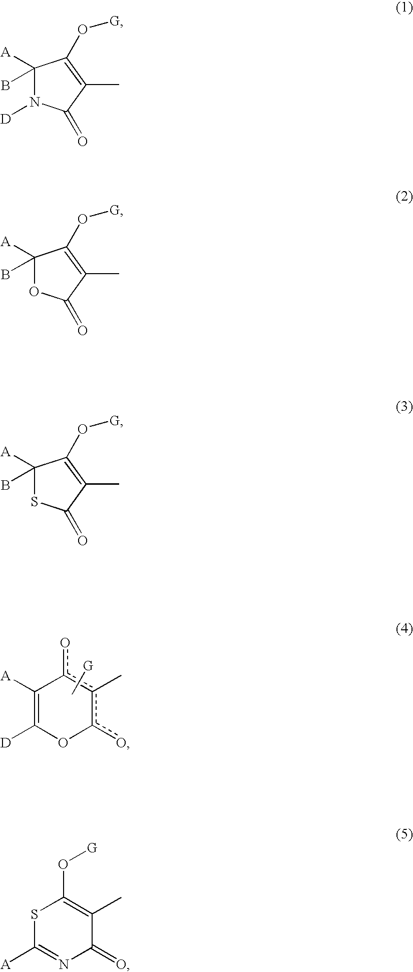 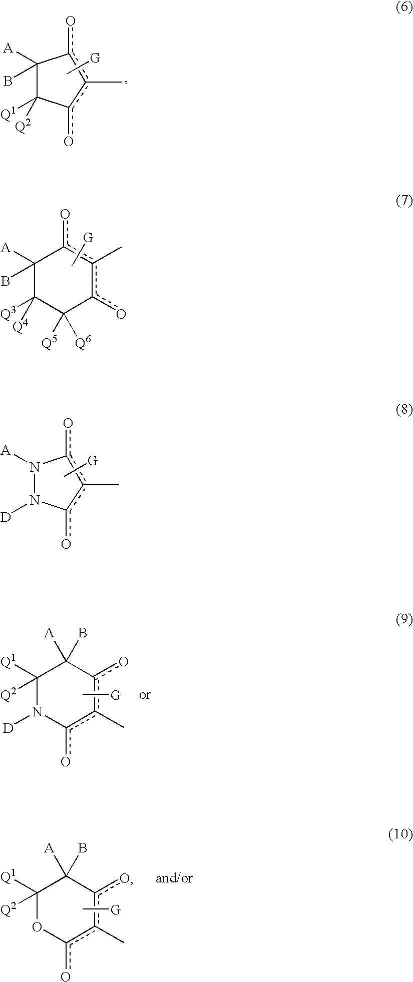
in which
A is hydrogen, in each case optionally halogen-substituted alkyl, alkenyl, alkoxyalkyl, alkylthioalkyl, saturated or unsaturated, optionally substituted cycloalkyl in which optionally at least one ring atom is replaced by a heteroatom, or in each case optionally halogen-, alkyl-, haloalkyl-, alkoxy-, haloalkoxy-, cyano- or nitro-substituted aryl, arylalkyl or hetaryl,
B is hydrogen, alkyl or alkoxyalkyl, or
A and B, together with the carbon atom to which they are attached, are a saturated or unsaturated, unsubstituted or substituted ring optionally containing at least one heteroatom,
D is hydrogen or an optionally substituted radical from the series alkyl, alkenyl, alkynyl, alkoxyalkyl, saturated or unsaturated cycloalkyl in which optionally one or more ring members are replaced by heteroatoms, or is arylalkyl, aryl, hetarylalkyl or hetaryl, or
A and D, together with the atoms to which they are attached, are a saturated or unsaturated ring which optionally contains at least one, in the case of CKE=8 one further, heteroatom and is substituted or unsubstituted in the A,D moiety, or
A and Q¹ together are alkenediyl or alkanediyl optionally substituted by hydroxyl or by in each case optionally substituted alkyl, alkoxy, alkylthio, cycloalkyl, benzyloxy or aryl, or
D and Q¹, together with the atoms to which they are attached, are a saturated or unsaturated ring which optionally contains at least one heteroatom and is substituted or unsubstituted in the D, Q¹ moiety,
Q¹ is hydrogen, alkyl, alkoxyalkyl, optionally substituted cycloalkyl, in which optionally one methylene group is replaced by oxygen or sulphur, or optionally substituted phenyl.
Q², Q⁴, Q⁵ and Q⁶ independently of one another are hydrogen or alkyl,
Q³ is hydrogen, is optionally substituted alkyl, alkoxyalkyl, alkylthioalkyl, optionally substituted cycloalkyl, in which optionally one methylene group is replaced by oxygen or sulphur, or optionally substituted phenyl, or
Q¹ and Q², together with the carbon atom to which they are attached, are a substituted or unsubstituted ring optionally containing a heteroatom, or
Q³ and Q⁴, together with the carbon atom to which they are attached, are a saturated or unsaturated, unsubstituted or substituted ring optionally containing a heteroatom,
G is hydrogen (a) or is one of the groups 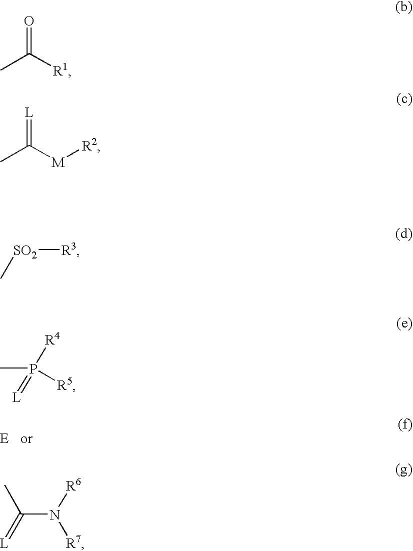
in which
E is one metal ion equivalent or an ammonium ion,
L is oxygen or sulphur,
M is oxygen or sulphur,
R¹ is in each case optionally halogen-substituted alkyl, alkenyl, alkoxyalkyl, alkylthioalkyl, polyalkoxyalkyl or optionally halogen-, alkyl- or alkoxy-substituted cycloalkyl, which may be interrupted by at least one heteroatom, or is in each case optionally substituted phenyl, phenylalkyl, hetaryl, phenoxyalkyl or hetaryloxyalkyl,
R² is in each case optionally halogen-substituted alkyl, alkenyl, alkoxyalkyl, polyalkoxyalkyl or is in each case optionally substituted cycloalkyl, phenyl or benzyl,
R³, R⁴ and R⁵ independently of one another are in each case optionally halogen-substituted alkyl, alkoxy, alkylamino, dialkylamino, alkylthio, alkenylthio, cycloalkylthio or are in each case optionally substituted phenyl, benzyl, phenoxy or phenylthio,
R⁶ and R⁷ independently of one another are hydrogen, in each case optionally halogen-substituted alkyl, cycloalkyl, alkenyl, alkoxy, alkoxyalkyl, are optionally substituted phenyl, are optionally substituted benzyl, or, together with the N atom to which they are attached, are a ring which is optionally interrupted by oxygen or sulphur,
and at least one salt of formula (II) 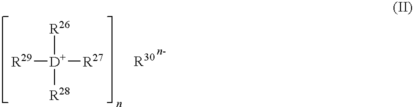
in which
D is nitrogen or phosphorus.
R²⁶, R²⁷, R²⁸ and R²⁹ independently of one another are hydrogen or in each case optionally substituted C₁-C₈-alkyl or singly or multiply unsaturated, optionally substituted C₁-C₈-alkylene, which can be substituted with halogen, nitro and/or cyano,
n is 1, 2, 3 or 4,
R³⁰ is an organic or inorganic anion.

2. Composition according to claim 1, wherein, in formula (I):
W is hydrogen, C₁-C₆-alkyl, C₂-C₆-alkenyl, C₂-C₆-alkynyl, halogen, C₁-C₆-alkoxy, C₁-C₄-haloalkyl, C₁-C₄-haloalkoxy or cyano,
X is halogen, C₁-C₆-alkyl, C₂-C₆-alkenyl, C₂-C₆-alkynyl, C₁-C₆-alkoxy, C₁-C₆-alkoxy-C₁-C₄-alkoxy, C₁-C₄-haloalkyl, C₁-C₄-haloalkoxy or cyano,
Y is hydrogen, halogen, C₁-C₆-alkyl, C₂-C₆-alkenyl, C₂-C₆-alkynyl, C₁-C₆-alkoxy, cyano, C₁-C₄-haloalkyl, haloalkoxy, or is V¹- and V²-substituted phenyl or pyridyl,
V¹ is halogen, C₁-C₁₂-alkyl, C₁-C₆-alkoxy, C₁-C₄-haloalkyl, C₁-C₄-haloalkoxy, cyano or nitro,
V² is hydrogen, halogen, C₁-C₆-alkyl, C₁-C₆-alkoxy or C₁-C₄-haloalkyl,
V¹ and V² are together C₃-C₄-alkanediyl which optionally can be substituted by halogen and/or C₁-C₂-alkyl and which optionally can be interrupted by one or two oxygen atoms,
Z is hydrogen, halogen, C₁-C₆-alkyl, C₁-C₄-haloalkyl, cyano, C₁-C₆-alkoxy or C₁-C₄-haloalkoxy,
CKE is one of the groups 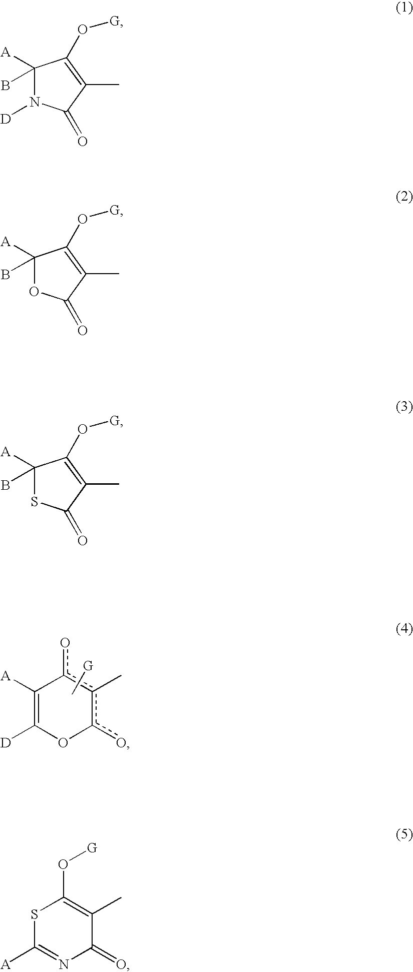 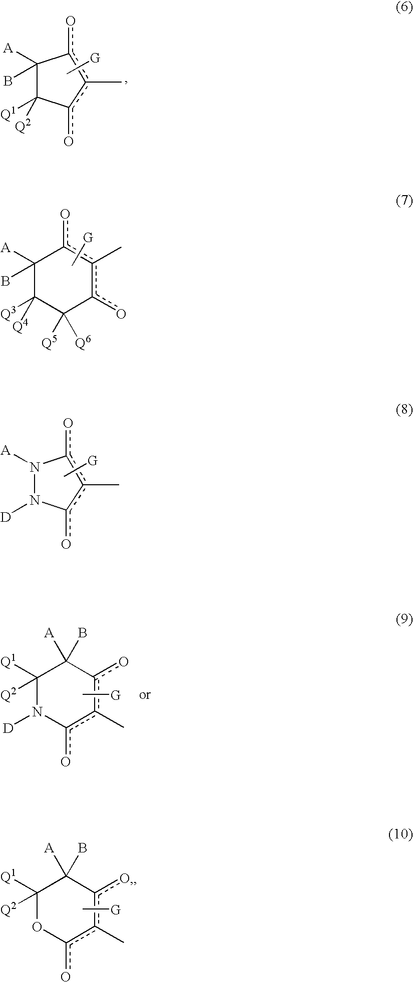
A is hydrogen or in each case optionally halogen-substituted C₁-C₁₂-alkyl, C₃-C₈-alkenyl, C₁-C₁₀-alkoxy-C₁-C₈-alkyl, C₁-C₁₀-alkylthio-C₁-C₆-alkyl, optionally halogen-, C₁-C₆-alkyl- or C₁-C₆-alkoxy-substituted C₃-C₈-cycloalkyl in which optionally one or two ring members not directly adjacent are replaced by oxygen and/or sulphur, or is in each case optionally halogen-, C₁-C₆-alkyl-, C₁-C₆-haloalkyl-, C₁-C₆-alkoxy-, C₁-C₆-haloalkoxy-, cyano- or nitro-substituted phenyl, naphthyl, hetaryl having 5 to 6 ring atoms (for example furanyl, pyridyl, imidazolyl, triazolyl, pyrazolyl, pyrimidyl, thiazolyl or thienyl), phenyl-C₁-C₆-alkyl or naphthyl-C₁-C₆-alkyl,
B is hydrogen, C₁-C₁₂-alkyl or C₁-C₈-alkoxy-C₁-C₆-alkyl or
A, B and the carbon atom to which they are attached are saturated C₃-C₁₀cycloalkyl or unsaturated C₅-C₁₀-cycloalkyl, in which optionally one ring member is replaced by oxygen or sulphur and which optionally are singly or doubly substituted by C₁-C₈-alkyl, C₁-C₆-alkoxy-C₁-C₆-alkyl, C₃-C₆-cycloalkyl-C₁-C₂-alkoxy, C₃-C₁₀-cycloalkyl, C₁-C₈-haloalkyl, C₁-C₈-alkoxy, C₁-C₆-alkoxy-C₁-C₄-alkoxy, C₁-C₈-alkylthio, halogen or phenyl, or
A, B and the carbon atom to which they are attached are C₃-C₆-cycloalkyl which is substituted by an alkylenediyl group which is optionally substituted by C₁-C₄-alkyl and optionally contains one or two oxygen and/or sulphur atoms not directly adjacent, or by an alkylenedioxyl group or by an alkylenedithioyl group, which with the carbon atom to which it is attached forms a further five- to eight-membered ring, or
A, B and the carbon atom to which they are attached are C₃-C₈-cycloalkyl or C₅-C₈-cycloalkenyl in which two substituents, together with the carbon atoms to which they are attached, are in each case optionally C₁-C₆-alkyl-, C₁-C₆-alkoxy- or halogen-substituted C₂-C₆-alkanediyl, C₂-C₆-alkenediyl or C₄-C₆-alkanedienediyl, in which optionally one methylene group is replaced by oxygen or sulphur,
D is hydrogen, in each case optionally halogen-substituted C₁-C₁₂-alkyl, C₃-C₈-alkenyl, C₃-C₈-alkynyl, C₁-C₁₀-alkoxy-C₂-C₈-alkyl, optionally halogen-, C₁-C₄-alkyl-, C₁-C₄-alkoxy- or C₁-C₄-haloalkyl-substituted C₃-C₈-cycloalkyl in which optionally one ring member is replaced by oxygen or sulphur, or is in each case optionally halogen-, C₁-C₆-alkyl-, C₁-C₆-haloalkyl-, C₁-C₆-alkoxy-, C₁-C₆-haloalkoxy-, cyano- or nitro-substituted phenyl, hetaryl having 5 or 6 ring atoms, phenyl-C₁-C₆-alkyl or hetaryl-C₁-C₆-alkyl having 5 or 6 ring atoms or
A and D are together in each case optionally substituted C₃-C₆-alkanediyl or C₃-C₆-alkenediyl, in which optionally one methylene group is replaced by a carbonyl group, oxygen or sulphur, and wherein optional substituents can be halogen, hydroxyl, mercapto or in each case optionally halogen-substituted C₁-C₁₀-alkyl, C₁-C₆-alkoxy, C₁-C₆-alkylthio, C₃-C₇-cycloalkyl, phenyl or benzyloxy, or a further C₃-C₆-alkanediyl moiety, C₃-C₆-alkenediyl moiety or a butadienyl moiety, which is optionally substituted by C₁-C₆-alkyl or in which optionally two adjacent substituents, with the carbon atoms to which they are attached, form a further saturated or unsaturated ring having 5 or 6 ring atoms, which can contain oxygen or sulphur, or in which optionally one of the following groups 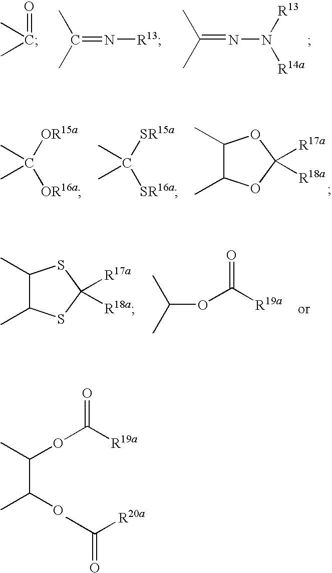
is present, or
A and Q¹ are together C₄-C₆-alkenediyl or C₃-C₆-alkanediyl which are in each case optionally substituted one or two times by identical or different substituents selected from halogen, hydroxyl, C₃-C₇-cycloalkyl, C₁-C₆-alkylthio, C₁-C₆-alkoxy or C₁-C₁₀-alkyl in each case optionally substituted one to three times by identical or different halogen substituents, and phenyl or benzyloxy in each case optionally substituted one to three times by identical or different halogen, C₁-C₆-alkyl or C₁-C₆-alkoxy substituents, and which, moreover, optionally contains one of the following groups 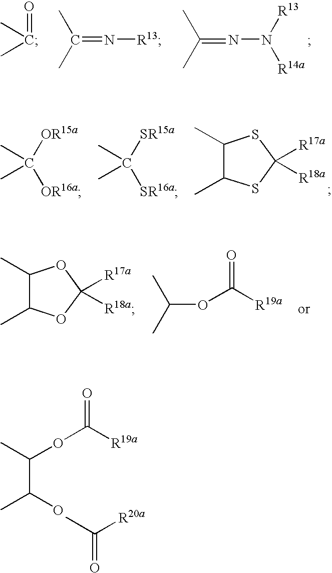
or is bridged by a C₁-C₂-alkanediyl group or by an oxygen atom, or
D and Q¹ are together C₃-C₆-alkanediyl which is in each case optionally substituted one or two times by identical or different substituents selected from C₁-C₄-alkyl and C₁-C₄-alkoxy,
Q¹ is hydrogen, C₁-C₆-alkyl, C₁-C₆-alkoxy-C₁-C₂-alkyl, optionally fluorine-, chlorine-, C₁-C₄-alkyl-, C₁-C₂-haloalkyl- or C₁-C₄-alkoxy-substituted C₃-C₈-cycloalkyl, in which optionally one methylene group is replaced by oxygen or sulphur, or is optionally halogen-, C₁-C₄-alkyl-, C₁-C₄-alkoxy-, C₁-C₂-haloalkyl-, C₁-C₂-haloalkoxy-, cyano- or nitro-substituted phenyl, or
Q², Q⁴, Q⁵ and Q⁶ independently of one another are hydrogen or C₁-C₄-alkyl,
Q³ is hydrogen, C₁-C₆-alkyl, C₁-C₆-alkoxy-C₁-C₂-alkyl, C₁-C₆-alkylthio-C₁-C₂-alkyl, optionally C₁-C₄-alkyl- or C₁-C₄-alkoxy-substituted C₃-C₈-cycloalkyl, in which optionally one methylene group is replaced by oxygen or sulphur, or is optionally halogen-, C₁-C₄-alkyl-, C₁-C₄-alkoxy-, C₁-C₂-haloalkyl-, C₁-C₂-haloalkoxy-, cyano- or nitro-substituted phenyl,
Q1 and Q2, with the carbon atom to which they are attached, are optionally C₁-C₆-alkyl-, C₁-C₆-alkoxy- or C₁-C₂-haloalkyl-substituted C₃-C₇ ring in which optionally one ring member is replaced by oxygen or sulphur,
Q³ and Q⁴, together with the carbon atom to which they are attached, are an optionally C₁-C₄-alkyl-, C₁-C₄-alkoxy- or C₁-C₂-haloalkyl-substituted C₃-C₇ ring in which optionally one ring member is replaced by oxygen or sulphur,
G is hydrogen (a) or is one of the groups 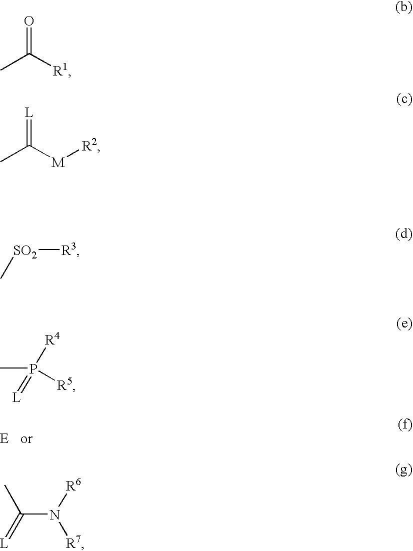
in which
E is one metal ion equivalent or ammonium ion,
L is oxygen or sulphur and
M is oxygen or sulphur,
R¹ is in each case optionally halogen-substituted C₁-C₂₀-alkyl, C₂-C₂₀-alkenyl, C₁-C₈-alkoxy-C₁-C₈-alkyl, C₁-C₈-alkylthio-C₁-C₈-alkyl, poly-C₁-C₈-alkoxy-C₁-C₈-alkyl or optionally halogen-, C₁-C₆-alkyl- or C₁-C₆-alkoxy-substituted C₃-C₈-cycloalkyl in which optionally one or two ring members not directly adjacent are replaced by oxygen and/or sulphur,
is optionally halogen-, cyano-, nitro-, C₁-C₆-alkyl-, C₁-C₆-alkoxy-, C₁-C₆-haloalkyl-, C₁-C₆-haloalkoxy-, C₁-C₆-alkylthio- or C₁-C₆-alkylsulphonyl-substituted phenyl,
is optionally halogen-, nitro-, cyano-, C₁-C₆-alkyl-, C₁-C₆-alkoxy-, C₁-C₆-haloalkyl- or C₁-C₆-haloalkoxy-substituted phenyl-C₁-C₆-alkyl,
is optionally halogen- or C₁-C₆-alkyl-substituted 5- or 6-membered hetaryl,
is optionally halogen- or C₁-C₆-alkyl-substituted phenoxy-C₁-C₆-alkyl or
is optionally halogen-, amino- or C₁-C₆-alkyl-substituted 5- or 6-membered hetaryloxy-C₁-C₆-alkyl,
R² is in each case optionally halogen-substituted C₁-C₂₀-alkyl, C₂-C₂₀-alkenyl, C₁-C₈-alkoxy-C₂-C₈-alkyl, poly-C₁-C₈-alkoxy-C₂-C₈-alkyl,
is optionally halogen-, C₁-C₆-alkyl- or C₁-C₆-alkoxy-substituted C₃-C₈-cycloalkyl or
is in each case optionally halogen-, cyano-, nitro-, C₁-C₆-alkyl-, C₁-C₆-alkoxy-, C₁-C₆-haloalkyl- or C₁-C₆-haloalkoxy-substituted phenyl or benzyl,
R³ is optionally halogen-substituted C₁-C₈-alkyl or is in each case optionally halogen-, C₁-C₆-alkyl-, C₁-C₆-alkoxy-, C₁-C₄-haloalkyl-, C₁-C₄-haloalkoxy-, cyano- or nitro-substituted phenyl or benzyl,
R⁴ and R⁵ independently of one another are in each case optionally halogen-substituted C₁-C₈-alkyl, C₁-C₈-alkoxy, C₁-C₈-alkylamino, di-(C₁-C₈-alkyl)amino, C₁-C₈-alkylthio, C₂-C₈-alkenylthio, C₃-C₇-cycloalkylthio or are in each case optionally halogen-, nitro-, cyano-, C₁-C₄-alkoxy-, C₁-C₄-haloalkoxy-, C₁-C₄-alkylthio-, C₁-C₄-haloalkylthio-, C₁-C₄-alkyl- or C₁-C₄-haloalkyl-substituted phenyl, phenoxy or phenylthio,
R⁶ and R⁷ are independently of one another hydrogen, are in each case optionally halogen-substituted C₁-C₈-alkyl, C₃-C₈-cycloalkyl, C₁-C₈-alkoxy, C₃-C₈-alkenyl, C₁-C₈-alkoxy-C₁-C₈-alkyl, are optionally halogen-, C₁-C₈-haloalkyl-, C₁-C₈-alkyl- or C₁-C₈-alkoxy-substituted phenyl, optionally halogen-, C₁-C₈-alkyl-, C₁-C₈-haloalkyl- or C₁-C₈-alkoxy-substituted benzyl or together are an optionally C₁-C₄-alkyl-substituted C₃-C₆-alkylene radical in which optionally one carbon atom is replaced by oxygen or sulphur,
R¹³ is hydrogen, is in each case optionally halogen-substituted C₁-C₈-alkyl or C₁-C₈-alkoxy, is optionally halogen-, C₁-C₄-alkyl- or C₁-C₄-alkoxy-substituted C₃-C₈-cycloalkyl in which optionally one methylene group is replaced by oxygen or sulphur, or is in each case optionally halogen-, C₁-C₆-alkyl-, C₁-C₆-alkoxy-, C₁-C₄-haloalkyl-, C₁-C₄-haloalkoxy-, nitro- or cyano-substituted phenyl, phenyl-C₁-C₄-alkyl or phenyl-C₁-C₄-alkoxy,
R^{14a} is hydrogen or C₁-C₈-alkyl or
R¹³ and R^{14a} are together C₄-C₆-alkanediyl,
R^{15a} and R^{16a} are alike or different and are C₁-C₆-alkyl or
R^{15a} and R^{16a} are together a C₂-C₄-alkanediyl radical which is optionally substituted by C₁-C₆-alkyl, C₁-C₆-haloalkyl or by optionally halogen-, C₁-C₆-alkyl-, C₁-C₄-haloalkyl-, C₁-C₆-alkoxy-, C₁-C₄-haloalkoxy-, nitro- or cyano-substituted phenyl,
R^{17a} and R^{18a} are independently of one another hydrogen, are optionally halogen-substituted C₁-C₈-alkyl or are optionally halogen-, C₁-C₆-alkyl-, C₁-C₆-alkoxy-, C₁-C₄-haloalkyl-, C₁-C₄-haloalkoxy-, nitro- or cyano-substituted phenyl or
R^{17a} and R^{18a}, together with the carbon atom to which they are attached, are a carbonyl group or are optionally halogen-, C₁-C₄-alkyl- or C₁-C₄-alkoxy-substituted C₅-C₇-cycloalkyl in which optionally one methylene group is replaced by oxygen or sulphur,
R^{19a} and R^{20a} are independently of one another C₁-C₁₀-alkyl, C₂-C₁₀-alkenyl, C₁-C₁₀-alkoxy, C₁-C₁₀alkylamino, C₃-C₁₁-alkenylamino, di-(C₁-C₁₀-alkyl)amino or di-(C₃-C₁₀-alkenyl)amino.

3. Composition according to claim 2, wherein in formula (I)
W is hydrogen, fluorine, chlorine, bromine, C₁-C₄-alkyl, C₂-C₄-alkenyl, C₂-C₄-alkynyl, C₁-C₄-alkoxy, C₁-C₂-haloalkyl or C₁-C₂-haloalkoxy,
X is chlorine, bromine, iodine, C₁-C₄-alkyl, C₂-C₄-alkenyl, C₂-C₄-alkynyl, C₁-C₄-alkoxy, C₁-C₄-alkoxy-C₁-C₃-alkoxy, C₁-C₂-haloalkyl, C₁-C₂-haloalkoxy or cyano,
Y is in position 4 hydrogen, fluorine, chlorine, bromine, iodine, methoxy, ethoxy, cyano, trifluoromethyl, difluoromethoxy or trifluoromethoxy,
Z is hydrogen;
W is also hydrogen, fluorine, chlorine, bromine or C₁-C₄-alkyl,
X is also chlorine, bromine, C₁-C₄-alkyl, C₁-C₄-alkoxy, C₁-C₂-haloalkyl, C₁-C₂-haloalkoxy or cyano,
Y is also in position 4 C₂-C₄-alkenyl, C₂-C₄-alkynyl or the radical 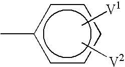
Z is also hydrogen,
V¹ is also fluorine, chlorine, C₁-C₄-alkyl, C₁-C₄-alkoxy, C₁-C₂-haloalkyl or C₁-C₂-haloalkoxy, cyano or nitro,
V² is also hydrogen, fluorine, chlorine, C₁-C₄-alkyl, C₁-C₄-alkoxy or C₁-C₂-haloalkyl,
V¹ and V² together are also —O—CH₂—O— and —O—CF₂—O—;
W is likewise hydrogen, fluorine, chlorine, bromine or C₁-C₄-alkyl,
X is likewise chlorine, bromine, C₁-C₄-alkyl, C₁-C₄-alkoxy, C₁-C₂-haloalkyl, C₁-C₂-haloalkoxy or cyano,
Y is likewise in position 5 C₂-C₄-alkenyl, C₂-C₄-alkynyl or the radical 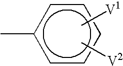
Z is likewise in position 4 hydrogen, C₁-C₄-alkyl or chlorine,
V¹ is likewise fluorine, chlorine, C₁-C₄-alkyl, C₁-C₄-alkoxy, C₁-C₂-haloalkyl or C₁-C₂-haloalkoxy, cyano or nitro,
V² is likewise hydrogen, fluorine, chlorine, C₁-C₄-alkyl, C₁-C₄-alkoxy or C₁-C₂-haloalkyl,
V¹ and V² together are likewise —O—CH₂—O— and —O—CF₂—O—;
W moreover is hydrogen, C₁-C₄-alkyl, C₂-C₄-alkenyl, C₂-C₄-alkynyl, C₁-C₄-alkoxy, fluorine, chlorine, bromine or trifluoromethyl,
X moreover is fluorine, chlorine, bromine, iodine, C₁-C₄-alkyl, C₂-C₄-alkenyl, C₂-C₄-alkynyl, C₁-C₄-alkoxy, C₁-C₄-alkoxy-C₁-C₃-alkoxy, C₁-C₂-haloalkyl, C₁-C₂-haloalkoxy or cyano,
Y moreover in position 4 is C₁-C₄-alkyl,
Z moreover is hydrogen;
W additionally is hydrogen, fluorine, chlorine, bromine, C₁-C₄-alkyl or C₁-C₄-alkoxy,
X additionally is chlorine, bromine, iodine, C₁-C₄-alkyl, C₁-C₄-alkoxy, C₁-C₂-haloalkyl, C₁-C₂-haloalkoxy or cyano,
Y additionally in position 4 is hydrogen, chlorine, bromine, iodine, C₁-C₄-alkyl, C₁-C₂-haloalkyl or C₁-C₂-haloalkoxy,
Z additionally in position 3 or 5 is fluorine, chlorine, bromine, iodine, C₁-C₄-alkyl, C₁-C₂-haloalkyl, C₁-C₄-alkoxy or C₁-C₂-haloalkoxy;
CKE stands for one of the groups 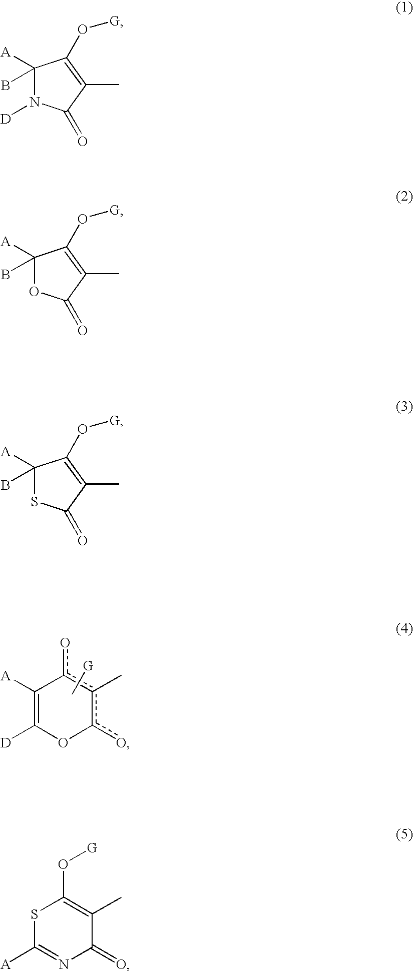 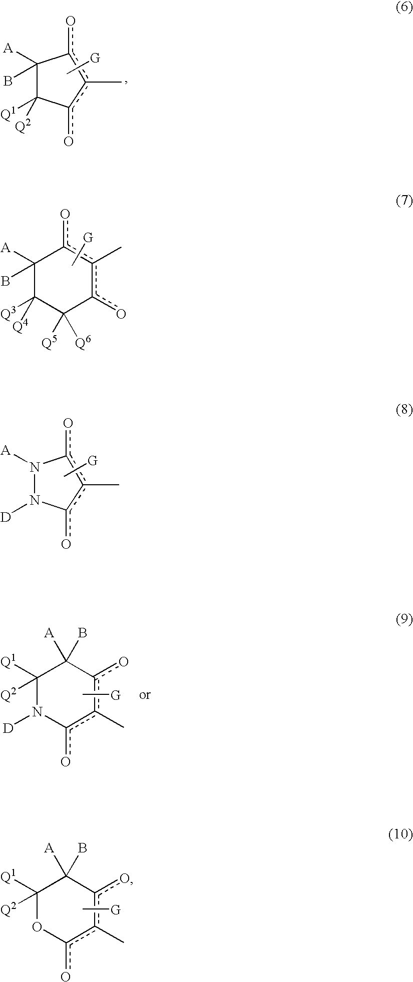
A is hydrogen, in each case optionally mono- to tri-fluorine- or -chlorine-substituted C₁-C₆-alkyl, C₁-C₄-alkoxy-C₁-C₂-alkyl, optionally singly to doubly C₁-C₂-alkyl- or C₁-C₂-alkoxy-substituted C₃-C₆-cycloalkyl or in each case optionally singly to doubly fluorine-, chlorine-, bromine-, C₁-C₄-alkyl-, C₁-C₂-haloalkyl-, C₁-C₄-alkoxy-, C₁-C₂-haloalkoxy-, cyano- or nitro-substituted phenyl or benzyl,
B is hydrogen, C₁-C₄-alkyl or C₁-C₂-alkoxy-C₁-C₂-alkyl, or
A, B and the carbon atom to which they are attached are saturated or unsaturated C₃-C₇-cycloalkyl in which optionally one ring member is replaced by oxygen or sulphur and which is optionally singly to doubly substituted by C₁-C₆-alkyl, C₁-C₄-alkoxy-C₁-C₂-alkyl, trifluoromethyl, C₁-C₆-alkoxy, C₁-C₃-alkoxy-C₁-C₃-alkoxy or C₃-C₆-cycloalkylmethoxy, with the proviso that in that case Q³ is hydrogen or methyl, or
A, B and the carbon atom to which they are attached are C₅-C₆-cycloalkyl which is substituted by an alkylenedithiol group or by an alkylenedioxyl group or by an alkylenediyl group which is optionally substituted by methyl or ethyl and optionally contains one or two oxygen or sulphur atoms not directly adjacent, and which, with the carbon atom to which it is attached, forms a further five- or six-membered ring, with the proviso that in that case Q³ is hydrogen or methyl, or
A, B and the carbon atom to which they are attached are C₃-C₆-cycloalkyl or C₅-C₆-cycloalkenyl in which two substituents, together with the carbon atoms to which they are attached, are in each case optionally C₁-C₂-alkyl- or C₁-C₂-alkoxy-substituted C₂-C₄-alkanediyl, C₂-C₄-alkenediyl or butadienediyl, with the proviso that in that case Q³ is hydrogen or methyl,
D is hydrogen, is in each case optionally mono- to tri-fluoro-substituted C₁-C₆-alkyl, C₃-C₆-alkenyl, C₁-C₄-alkoxy-C₂-C₃-alkyl, is optionally C₃-C₆-cycloalkyl which is singly to doubly substituted by C₁-C₄-alkyl, C₁-C₄-alkoxy or C₁-C₂-haloalkyl and in which optionally one methylene group is replaced by oxygen, or is pyridyl or phenyl in each case optionally substituted singly to doubly by fluorine, chlorine, bromine, C₁-C₄-alkyl, C₁-C₄-haloalkyl, C₁-C₄-alkoxy or C₁-C₄-haloalkoxy, or
A and D together are optionally singly to doubly substituted C₃-C₅-alkanediyl in which one methylene group can be replaced by a carbonyl group, oxygen or sulphur, suitable substituents being C₁-C₂-alkyl or C₁-C₂-alkoxy, or
A and D, together with the atoms to which they are attached, are one of the groups AD-1 to AD-10: 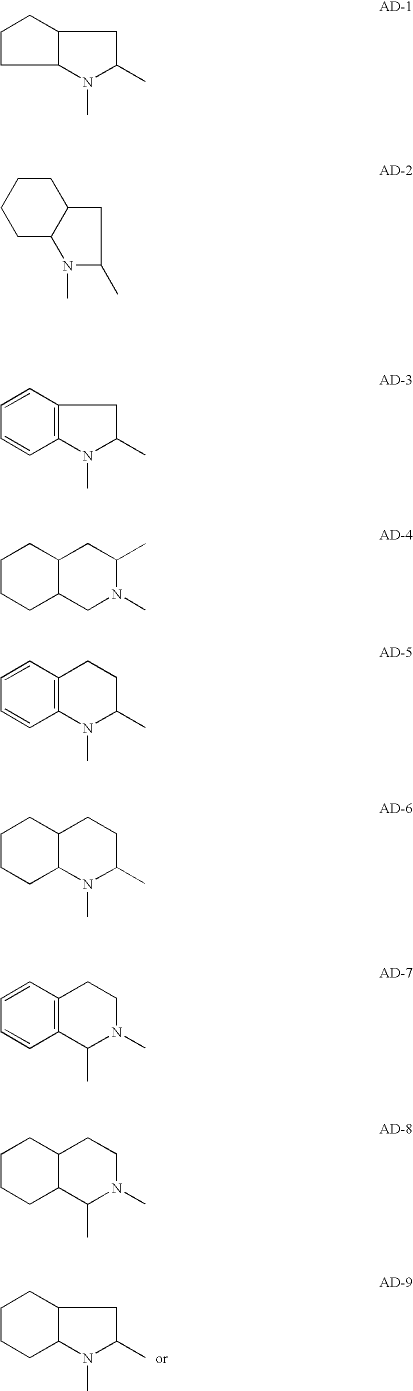 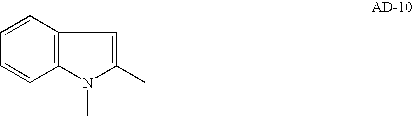
A and Q1 together are C₃-C₄-alkanediyl in each case optionally substituted singly or doubly by identical or different substituents selected from C₁-C₂-alkyl or C₁-C₂-alkoxy, or
D and Q¹ together are C₃-C₄-alkanediyl, or
Q¹ is hydrogen, C₁-C₄-alkyl, C₁-C₄-alkoxy-C₁-C₂-alkyl, or optionally methyl- or methoxy-substituted C₃-C₆-cycloalkyl in which optionally one methylene group is replaced by oxygen,
Q² is hydrogen, methyl or ethyl,
Q⁴, Q⁵ and Q⁶ independently of one another are hydrogen or C₁-C₃-alkyl,
Q³ is hydrogen, C₁-C₄-alkyl, or optionally singly to doubly methyl- or methoxy-substituted C₃-C₆-cycloalkyl, or
Q¹ and Q² are hydrogen, C₁-C₄-alkyl, C₁-C₄-alkoxy-C₁-C₂-alkyl, or optionally methyl- or methoxy-substituted C₃-C₆-cycloalkyl in which optionally one methylene group is replaced by oxygen, or
Q3 and Q⁴, together with the carbon to which they are attached, are an optionally C₁-C₂-alkyl- or C₁-C₂-alkoxy-substituted saturated C₅-C₆ ring in which optionally one ring member is replaced by oxygen or sulphur, with the proviso that in that case A is hydrogen or methyl,
G is hydrogen (a) or is one of the groups 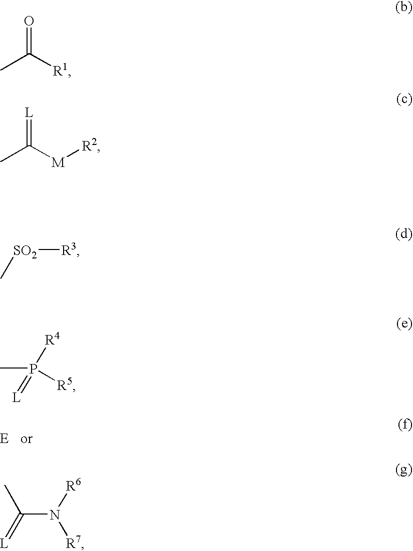
in which
E is one metal ion equivalent or an ammonium ion,
L is oxygen or sulphur and
M is oxygen or sulphur,
R¹ is in each case optionally mono- to tri-fluorine- or -chlorine-substituted C₁-C₈-alkyl, C₂-C₁₈-alkenyl, C₁-C₄-alkoxy-C₁-C₂-alkyl, C₁-C₄-alkylthio-C₁-C₂-alkyl or optionally singly to doubly fluorine-, chlorine-, C₁-C₂-alkyl- or C₁-C₂-alkoxy-substituted C₃-C₆-cycloalkyl in which optionally one or two ring members not directly adjacent are replaced by oxygen,
is phenyl optionally substituted singly to doubly by fluorine, chlorine, bromine, cyano, nitro, C₁-C₄-alkyl, C₁-C₄-alkoxy, C₁-C₂-haloalkyl or C₁-C₂-haloalkoxy,
R² is in each case optionally mono- to tri-fluorine-substituted C₁-C₈-alkyl, C₂-C₈-alkenyl or C₁-C₄-alkoxy-C₂-C₄-alkyl,
is optionally mono-C₁-C₂-alkyl- or —C₁-C₂-alkoxy-substituted C₃-C₆-cycloalkyl or is benzyl or phenyl in each case optionally substituted singly to doubly by fluorine, chlorine, bromine, cyano, nitro, C₁-C₄-alkyl, C₁-C₃-alkoxy, trifluoromethyl or trifluoromethoxy,
R³ is C₁-C₆-alkyl optionally substituted one to three times by fluorine or is phenyl optionally substituted once by fluorine, chlorine, bromine, C₁-C₄-alkyl, C₁-C₄-alkoxy, trifluoromethyl, trifluoromethoxy, cyano or nitro,
R⁴ is C₁-C₆-alkyl, C₁-C₆-alkoxy, C₁-C₆-alkylamino, di-(C₁-C₆-alkyl)amino, C₁-C₆-alkylthio, C₃-C₄-alkenylthio, C₃-C₆-cycloalkylthio or is phenylthio, phenoxy or phenyl in each case optionally substituted once by fluorine, chlorine, bromine, nitro, cyano, C₁-C₃-alkoxy, C₁-C₃-haloalkoxy, C₁-C₃-alkylthio, C₁-C₃-haloalkylthio, C₁-C₃-alkyl or trifluoromethyl,
R⁵ is C₁-C₆-alkoxy or C₁-C₆-alkylthio,
R⁶ is hydrogen, C₁-C₆-alkyl, C₃-C₆-cycloalkyl, C₁-C₆-alkoxy, C₃-C₆-alkenyl, C₁-C₆-alkoxy-C₁-C₄-alkyl, is phenyl optionally substituted once by fluorine, chlorine, bromine, trifluoromethyl, C₁-C₄-alkyl or C₁-C₄-alkoxy, or is benzyl optionally substituted once by fluorine, chlorine, bromine, C₁-C₄-alkyl, trifluoromethyl or C₁-C₄-alkoxy,
R⁷ is C₁-C₆-alkyl, C₃-C₆-alkenyl or C₁-C₆-alkoxy-C₁-C₄-alkyl, R⁶ and R⁷ together are an optionally methyl- or ethyl-substituted C₄-C₅-alkylene radical in which optionally one methylene group is replaced by oxygen or sulphur.

4. Composition according to claim 1, wherein the active ingredient content is from 0.5% to 50% by weight.

5. Composition according to claim 1, wherein in formula (II), D is nitrogen.

6. Composition according to claim 1, wherein the salt of formula II comprises an ammonium salt or phosphonium salt and is present in an amount from 0.5 to 80 mmol/l.

7. Composition according to claim 1, wherein in formula (II), R³⁰ is hydrogencarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

8. Composition according to claim 7, wherein in formula (II), R³⁰ is carbonate, pentaborate, sulphite, benzoate, hydrogenoxalate, hydrogencitrate, methylsulphate or tetrafluoroborate.

9. Composition according to claim 7, wherein in formula (II), R³⁰ is lactate, sulphate, nitrate, thiosulphate, thiocyanate, citrate, oxalate, formate, acetate, monohydrogenphosphate or dihydrogenphosphate.

10. Composition according to claim 7, wherein R³⁰ is sulphate, thiocyanate, dihydrogenphosphate or monohydrogenphosphate.

11. Composition according to claim 1, further comprising at least one penetrant.

12. Composition according to claim 10, wherein the penetrant is i) a fatty alcohol alkoxylate of the formula (III)
R—O-(-AO)ᵥ—R′ (III)
in which
R is linear or branched alkyl having 4 to 20 carbon atoms,
R′ is hydrogen, methyl, ethyl, n-propyl, isopropyl, n-butyl, isobutyl, tert-butyl, n-pentyl or n-hexyl,
AO is an ethylene oxide radical, a propylene oxide radical, a butylene oxide radical or is mixtures of ethylene oxide and propylene oxide radicals or butylene oxide radicals, and
v is a number from 2 to 30,
and/or ii) a mineral or vegetable oil and/or iii) an ester of a mineral or vegetable oil.

13. Composition according to claim 10, wherein the penetrant is an ester of a vegetable oil.

14. Composition according to claim 10, wherein the penetrant is rapeseed oil methyl ester.

15. Composition according to claim 10, wherein the penetrant is an open alkanol alkoxylate.

16. Composition according to claim 10, wherein the penetrant is a compound of the formula (III-c),
R—O—(—PO—)ᵣ-(EO—)ₛ—R′ (III-c)
in which
EO is —CH₂—CH₂-O—,
PO is 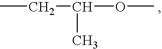
r is a number from 1 to 10, and
s is a number from 1 to 10.

16. Composition according to claim 10, wherein the penetrant is a compound of the formula (III-c-1), 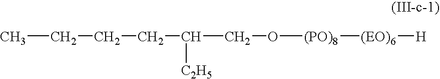
in which
EO is —CH₂—CH₂-O—,
PO is and 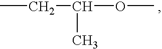
the numbers 8 and 6 represent average values.

17. Composition according to claim 10, wherein the amount of penetrant is 1% to 95% by weight.

18. Method of controlling unwanted plant growth, comprising applying a composition according to claim 1, undiluted or diluted to a plant, plant parts, plant seed and/or area on which a plant is growing.

19. Method of boosting the activity of herbicidal crop protection materials comprising preparing a composition of claim 1, to form an application-ready spray liquor using a salt of the formula (II).

20. Method according to claim 19, wherein the spray liquor is prepared using a penetrant.

21. Method according to claim 19, wherein the salt of the formula (II) is present in a concentration of 0.5 to 80 mmol/l.

22. Method according to claim 20, wherein the penetrant is present in a concentration of 0.1 to 10 g/l.

23. Method according to claim 20, wherein the penetrant is present in concentration of 0.1 to 10 g/l and the salt of the formula (II) in concentration of 0.5 to 80 mmol/l.

24. A composition according to claim 1 capable of boosting the activity of a herbicidal crop protection material wherein said composition is in preparing an application-ready crop protection material spray liquor.

25. A composition according to claim 24, wherein in the application-ready crop protection material, the salt of formula (II) is present in a concentration of 0.5 to 80 mmol/l.

26. A composition according to claim 24, further comprising a penetrant.
